(19) United States
(12) Patent Application Publication
(10) Pub. No.: US 2022/0343186 A1
(43) Pub. Date: Oct. 27, 2022

(54) INFORMATION PROCESSING DEVICE AND INFORMATION PROCESSING METHOD

(71) Applicant: Sony Group Corporation, Tokyo (JP)

(72) Inventors: Suguru AOKI, Tokyo (JP); Kazuhito IWASA, Tokyo (JP); Itaru SHIMIZU, Tokyo (JP)

(73) Assignee: Sony Group Corporation, Tokyo (JP)

(21) Appl. No.: 17/761,072

(22) PCT Filed: Oct. 5, 2020
(86) PCT No.: PCT/JP2020/037692

§ 371 Date: Mar. 16, 2022

(30) Foreign Application Priority Data
Oct. 15, 2019 (JP) 2019-188399

(51) Int. Cl. G06N 5/02

(52) U.S. Cl. CPC G06N 5/022

(57) ABSTRACT

The present technology relates to an information processing device and an information processing method capable of diverting a database.

For an algorithm that changes on the basis of accumulation of first learning data, re-learning is caused to be performed on the basis of the first learning data and specific learning data out of second learning data forming another algorithm that changes on the basis of accumulation of learning data. The first learning data includes data regarding output information from the algorithm based on input information to the algorithm. The present technology can be applied to, for example, artificial intelligence.

### TECHNICAL FIELD

The present technology relates to an information processing device and an information processing method, and for example, an information processing device and an information processing method suitable for application when a database is diverted.

### BACKGROUND ART

Conventionally, an AI agent system that automatically responds by voice or the like to input from a user by voice or the like has been proposed. For example, Patent Document 1 describes a technique in which an AI agent responds to utterance text data from a user by utterance.

### CITATION LIST

### Patent Document

### Patent Document 1: WO 2017/191696

### SUMMARY OF THE INVENTION

### Problems to be Solved by the Invention

On the other hand, the response by the above AI agent or the like may be output on the basis of an algorithm based on accumulation of learning data. In the future, it is presumed that the more the technology related to the algorithm based on accumulation of such learning data exists closer to the user, the more times the user wants to correct the accumulated learning data.

There are also cases where another user desires to use an algorithm used by a predetermined user, and it is speculated that it may be desired to make it possible to divert such another algorithm (a database referred to to generate the algorithm).

The present technology has been made in view of such a situation, and makes it possible to divert a database.

### Solutions to Problems

An information processing device of one aspect of the present technology includes causing, for an algorithm that changes on the basis of accumulation of first learning data, re-learning to be performed on the basis of the first learning data and specific learning data out of second learning data forming another algorithm that changes on the basis of accumulation of learning data.

An information processing method of one aspect of the present technology includes, by an information processing device, causing, for an algorithm that changes on the basis of accumulation of first learning data, re-learning to be performed on the basis of the first learning data and specific learning data out of second learning data forming another algorithm that changes on the basis of accumulation of learning data.

The information processing device and information processing method of one aspect of the present technology causes, for an algorithm that changes on the basis of accumulation of first learning data, re-learning to be performed based on the first learning data and specific learning data out of second learning data forming another algorithm that changes on the basis of accumulation of learning data.

Note that the information processing device may be an independent device or an internal block constituting one device.

### BRIEF DESCRIPTION OF DRAWINGS

FIG. 1 is a diagram illustrating an information processing system and a user terminal according to a first embodiment.

FIG. 2 is an example of a schematic configuration of learning history data stored in an information processing device.

FIG. 3 is a functional block diagram illustrating a configuration of the information processing device.

FIG. 4 is a functional block diagram illustrating an example of the configuration of a storage unit.

FIG. 5 is a functional block diagram illustrating a configuration of a processing unit.

FIG. 6 is a functional block diagram illustrating a configuration of the generation unit.

FIG. 7 is a functional block diagram illustrating a configuration of the user terminal.

FIG. 8 is a flowchart illustrating an example of transmission and reception of information between the information processing device and the user terminal.

FIG. 9 is a flowchart illustrating an example of transmission and reception of information between the information processing device and the user terminal.

FIG. 10 is a flowchart illustrating an example of transmission and reception of information between the information processing device and the user terminal.

FIG. 11 is a diagram illustrating an example of information recorded in an interaction DB, an update history of a knowledge DB, and an update history of a recommendation DB.

FIG. 12 is a diagram for describing a method of diverting a DB of another user.

FIG. 13 is a diagram for describing a first method of diverting a DB of another user.

FIG. 14 is a diagram for describing a second method of diverting a DB of another user.

FIG. 15 is a diagram for describing a third method of diverting the DB of another user.

FIG. 16 is a diagram for describing a fourth method of diverting the DB of another user.

FIG. 17 is a diagram for describing a fifth method of diverting the DB of another user.

FIG. 18 is a diagram for describing a method of integrating DBs.

FIG. 19 is a diagram for describing a sixth method of diverting the DB of another user.

FIG. 20 is a diagram for describing a method of integrating DBs.

FIG. 21 is a functional block diagram illustrating a configuration of an information processing device according to a second embodiment.

FIG. 22 is a functional block diagram illustrating a configuration of a storage unit according to the second embodiment.

FIG. 23 is a diagram illustrating an example of information recorded in an interaction DB, an update history of a knowledge DB, and an update history of a recommendation DB according to the second embodiment.

FIG. 24 is a functional block diagram illustrating a configuration of a processing unit according to the second embodiment.

FIG. 25 is a functional block diagram illustrating a configuration of the generation unit according to the second embodiment.

FIG. 26 is a flowchart illustrating an example of parameter update processing according to the second embodiment.

FIG. 27 is a diagram for describing a method of diverting a DB of another user.

FIG. 28 is a diagram for describing a seventh method of diverting a DB of another user.

FIG. 29 is a diagram for describing an eighth method of diverting a DB of another user.

FIG. 30 is a diagram for describing a ninth method of diverting a DB of another user.

FIG. 31 is a diagram for describing a tenth method of diverting a DB of another user.

FIG. 32 is a diagram for describing an eleventh method of diverting a DB of another user.

FIG. 33 is a diagram for describing a twelfth method of diverting the DB of another user.

FIG. 34 is a diagram for describing a thirteenth method of diverting the DB of another user.

FIG. 35 is a diagram for describing extraction of information from the DB.

FIG. 36 is a diagram illustrating output information generated before and after deletion of information regarding interaction, and processing contents based on changes in the output information before and after the deletion.

FIG. 37 is a diagram illustrating output information generated before and after deletion of information regarding interaction, and processing contents based on changes in the output information before and after the deletion.

FIG. 38 is a flowchart illustrating an update process of an interaction DB by an information processing device according to an embodiment of the present disclosure.

FIG. 39 is a diagram for describing a method of integrating DBs.

FIG. 40 is a diagram for describing a method of integrating DBs.

FIG. 41 is a diagram for describing a method of integrating DBs.

FIG. 42 is a diagram for describing a method of providing an interaction DB.

FIG. 43 is a diagram for describing a method of integrating DBs in different formats.

FIG. 44 is a functional block diagram illustrating a configuration of the information processing device.

FIG. 45 is a functional block diagram illustrating a configuration example of a hardware configuration of a user terminal or an information processing device constituting an information processing system according to an embodiment of the present disclosure.

### MODE FOR CARRYING OUT THE INVENTION

Hereinafter, modes for carrying out the present technology (hereinafter referred to as embodiments) will be described. Note that in the description and the drawings, components having substantially the same function and configuration are denoted by the same reference numerals, and redundant descriptions are omitted.

### Configuration of Information Processing System in First Embodiment

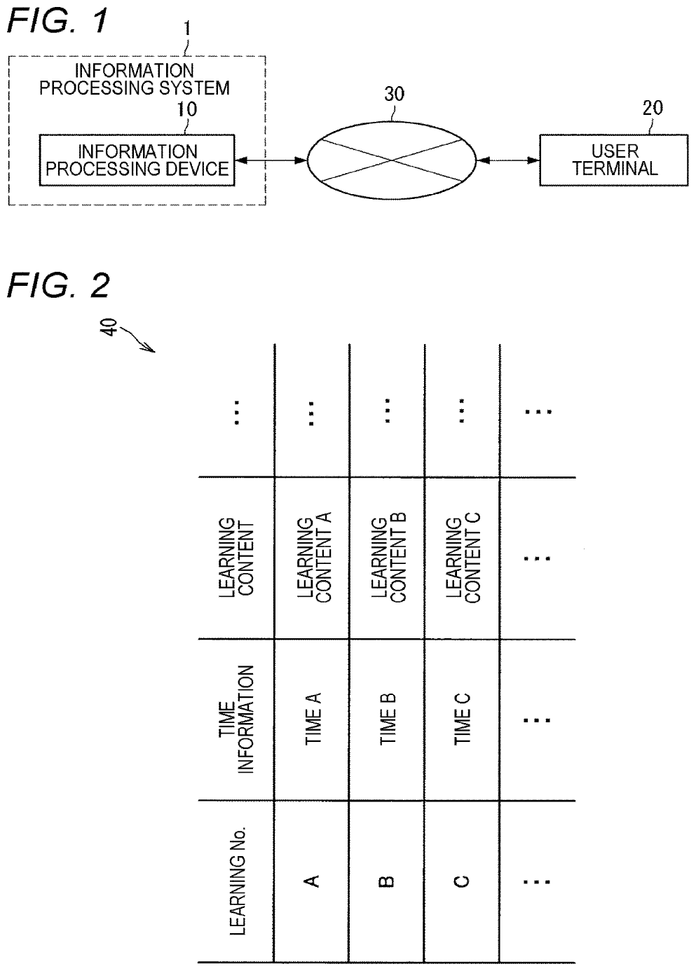

FIG. 1 is a diagram illustrating a configuration example of an information processing system 1 according to a first embodiment. As illustrated in FIG. 1, the information processing system 1 according to the first embodiment includes an information processing device 10. Hereinafter, in the first embodiment, it is assumed that the information processing system 1 and the information processing device 10 are the same. As illustrated in FIG. 1, the information processing system 1 includes an information processing device 10, a user terminal 20, and a network 30. In the information processing system 1, the information processing device 10 and the user terminal 20 are connected so that data can be exchanged via the network 30.

The information processing device 10 has a function of generating output information by using an algorithm generated on the basis of the accumulation of learning data in response to input information from the user. Furthermore, the information processing device 10 causes re-learning to be performed for the algorithm described above as needed.

The user terminal 20 has a function of transmitting input information from the user to the information processing device 10 via the network 30, and performing various outputs (for example, output of image or sound) to the user according to a response from the information processing device 10. In the present embodiment, the user terminal 20 achieves the output by an AI agent. Here, the AI agent is a character that serves as a motif of voice or an image output on the basis of the algorithm. The character may be a fictitious character or a real character.

Note that the network 30 may include a public line network such as a telephone line network, the Internet, and a satellite communication network, a local area network (LAN), a wide area network (WAN), and the like. Furthermore, the network 30 may include a dedicated line network such as Internet Protocol-Virtual Private Network (IP-VPN).

The algorithm described above is based on learning data accumulated in the information processing device 10. That is, the algorithm described above is a learning result based on the learning data. The information processing device 10 according to the present embodiment stores the learning history of the algorithm described above.

Here, an example of the learning history data 40 stored in the information processing device 10 according to the first embodiment will be described with reference to FIG. 2. FIG. 2 is an example of a schematic configuration of the learning history data 40 stored in the information processing device 10 according to the first embodiment. The learning history data 40 illustrated in FIG. 2 is data configured by arranging learning contents of the algorithm in chronological order. In FIG. 2, the learning contents for three times of learning with learning numbers of A to C are arranged in chronological order.

For example, in the learning of No. A, the content of the learning content A is learned at a time A. Furthermore, in the learning of No. B, the content of the learning content B is learned at a time B. Moreover, in the learning of No. C, the content of the learning content C is learned at the time C. Note that at each time, the algorithm is learned on the basis of the learning data corresponding to each learning. In the present embodiment, learning of the algorithm is performed on the basis of learning data accumulated in this manner.

Note that the learning history data 40 illustrated in FIG. 2 has a structure in which the learning data and the learning contents are arranged in chronological order, but the structure of the learning history data is not limited to this. Furthermore, although FIG. 2 illustrates learning histories of three times of learning Nos. A to C, the learning history data may have learning histories of two times or less, or learning histories of four times or more. Furthermore, a plurality of pieces of learning data may be used or a plurality of learnings may be performed in one learning.

Furthermore, the learning data is not particularly limited, but may be on the basis of, for example, data accumulated under an environment in which the algorithm is used. Accordingly, the algorithm based on accumulation of learning data can be an algorithm according to the environment in which the algorithm is used by the user. Thus, the information processing system 1 can more appropriately achieve the state of the algorithm desired by the user.

Furthermore, the learning data may include data regarding output information from the algorithm based on input information of the user to the algorithm.

Accordingly, the algorithm is learned according to the input information from the user on a daily basis and the output information based on the input information. The input information and output information described above may include information unique to the user. Thus, the information processing system 1 can more appropriately achieve the state of the algorithm desired by the user on the basis of the learning data described above.

<Configuration of Information Processing Device>

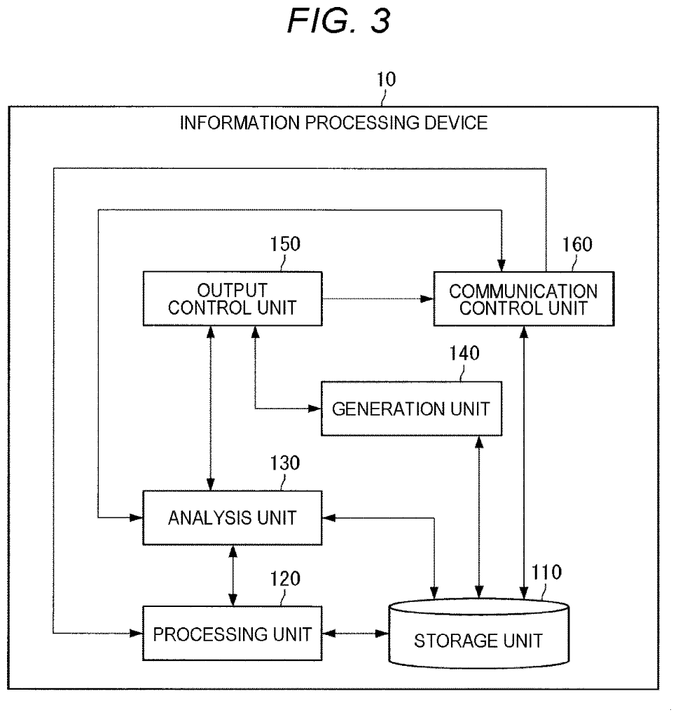

A configuration of the information processing device 10 will be described. FIG. 3 is a functional block diagram illustrating the configuration of the information processing device 10 according to the first embodiment.

The information processing device 10 has a function of adjusting the degree of influence of the accumulated learning data derived from specific learning data, and causing, for an algorithm that changes on the basis of accumulation of the learning data, re-learning to be performed on the basis of new learning data obtained after the adjustment. The functions of the information processing device 10 are achieved by cooperation of a storage unit 110, a processing unit 120, an analysis unit 130, a generation unit 140, an output control unit 150, and a communication control unit 160 included in the information processing device 10. Hereinafter, each functional unit included in the information processing device 10 will be described.

The storage unit 110 has a function of storing various information. Various information stored in the storage unit 110 is referred to by the processing unit 120, the analysis unit 130, the generation unit 140, or the communication control unit 160, if necessary.

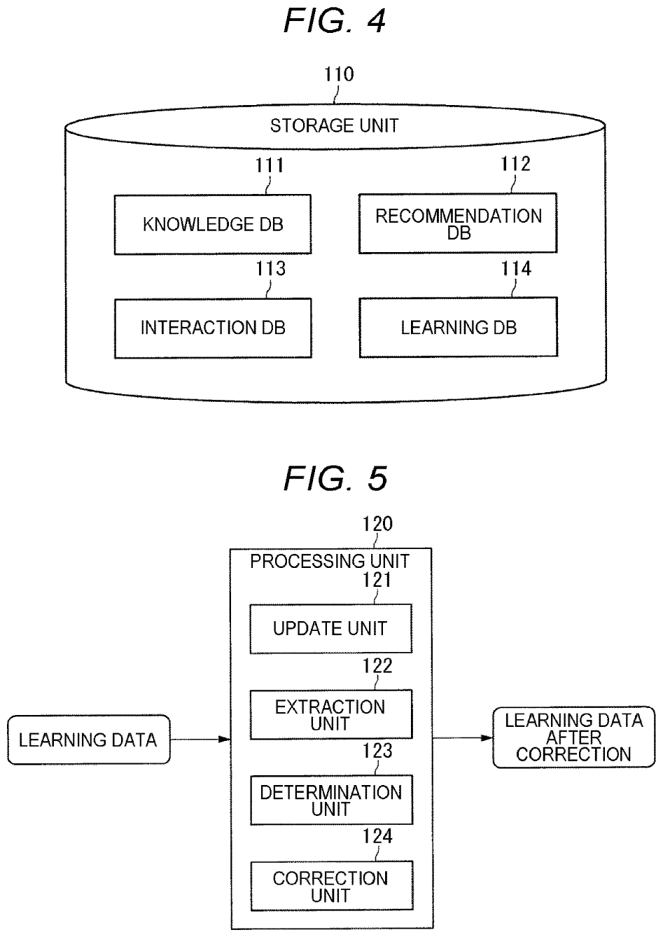

Here, the storage unit 110 according to the present embodiment will be described in more detail with reference to FIG. 4. FIG. 4 is a functional block diagram illustrating an example of a configuration of the storage unit 110 according to the first embodiment. As illustrated in FIG. 4, the storage unit 110 has a knowledge database (DB) 111, a recommendation DB 112, an interaction DB 113, and a learning DB 114.

The knowledge DB 111 records various information used, for example, by the analysis unit 130 to analyze the input information from the user. For example, the knowledge DB 111 records information regarding meanings and contents of various words. Furthermore, for example, the knowledge DB 111 records dictionary meanings and contents of various words.

Furthermore, for example, the knowledge DB 111 records meanings and contents of words peculiar to the user. For example, the word “Gunma” generally means the Gunma prefecture. However, for some users, the word “Gunma” may mean the name of a person (for example, the name of a person “Iwasa”). In this case, the knowledge DB 111 remembers that the word “Gunma” may refer to the name of the person “Iwasa”. In the knowledge DB 111, meanings of various words may be defined stochastically. For example, the knowledge DB 111 may record that the word “Gunma” means a personal name “Iwasa” with a probability of 70%.

Furthermore, the knowledge DB 111 may store user data that is data regarding the user. Note that the user data may be included in the learning data for causing learning of the algorithm. Accordingly, it is possible for the user to correct information regarding the user himself or herself contained in the learning data. Consequently, the information processing device 10 can cause re-learning of the algorithm to be performed more appropriately, and can more appropriately achieve the state of the algorithm desired by the user.

Furthermore, information regarding weather or news may be recorded in the knowledge DB 111. Furthermore, for example, information such as a memo or a reminder input by the user may be recorded in the knowledge DB 111. Moreover, the knowledge DB 111 may record information for Web extraction or product extraction.

The recommendation DB 112 records various data used by the recommendation information generation unit 142, which will be described later, to generate output information. For example, the recommendation DB 112 may record data regarding tastes of the user. For example, it is assumed that the user listens to songs of a person named “Gunma” on a daily basis, and information regarding this fact is input to the storage unit 110. In this case, a playlist of the songs of “Gunma” may be recorded in the recommendation DB 112. Furthermore, the recommendation DB 112 may record, for example, a score list on which recommendation scores are given for various songs, such as a recommendation score for a song A of 0.2 and a recommendation score for a song B of 0.8. Furthermore, the recommendation DB 112 may record information regarding music, purchases, and the like recommended to the user.

The information recorded in the above recommendation DB 112 described above is transmitted to the generation unit 140 and is used by the generation unit 140 to generate the output information.

The interaction DB 113 accumulates data regarding input information from the user and output information based on the algorithm for the input information. For example, it is assumed that one day, a user inputs input information requesting that a song of “Gunma” be played to the information processing system 1. Consequently, it is assumed that the information processing system 1 generates output information for playing the song of “Gunma” on the basis of the algorithm and outputs the output information to the user terminal 20, for example. At this time, the contents of the input information and the output information, the time when these pieces of information are input or output, and the like are recorded in the interaction DB 113.

In the present embodiment, information recorded in the interaction DB 113 (for example, information related to the input information and the output information) is used as label information for extracting the learning data recorded in the learning DB 114 described later. In the first embodiment, the information recorded in the interaction DB 113 is also used to update the information recorded in the knowledge DB 111 or the recommendation DB 112.

Upon acquiring the input information, the information processing device 10 according to the present embodiment generates output information on the basis of the information recorded in the knowledge DB 111 and the recommendation DB 112. Therefore, in the algorithm for generating output information executed by the information processing device 10, information recorded in the knowledge DB 111 and the recommendation DB 112 is used. Thus, if the information recorded in the knowledge DB 111 or the recommendation DB 112 is updated on the basis of accumulation of the learning data recorded in the interaction DB 113, the algorithm described above changes.

Note that the information recorded in the knowledge DB 111 or the recommendation DB 112 may be updated every time the input information and the output information are input or output. In this case, the algorithm for generating the output information by the information processing device 10 changes every time the input information and the output information are input or output.

The learning DB 114 records learning data. Recording of the learning data may be performed on the basis of an instruction by the user, or may be automatically performed in the background by the information processing system 1. The learning data may include, for example, various information necessary for output, such as content of an instruction from the user, a situation of the user, and an environment around the user. Furthermore, the learning data may include an index for estimating how appropriate a result is (for example, an analysis result by the analysis unit 130 or a recommendation result by a recommendation information generation unit 145, which will be described later). The index may be, for example, a feedback (FB) from the user for analysis or recommendation. A learning history of the algorithm for the information processing device 10 to generate the output information is recorded. For example, as illustrated in FIG. 2, the learning DB 114 may record a learning history in a format in which the learning contents are arranged in chronological order. Note that the learning data itself does not have to be recorded in the information recorded in the learning DB 114. In this case, the learning DB 114 may record information that associates the learning history with learning data corresponding to the learning history.

(Processing Unit)

The processing unit 120 has a function of executing various processes on the information stored in the storage unit 110. The processing unit 120 has a function of adjusting the degree of influence derived from specific learning data in the accumulated learning data. Furthermore, the processing unit 120 has a function of causing re-learning of the algorithm to be performed on the basis of new learning data obtained after adjustment. A result of processing by the processing unit 120 is transmitted to at least one of the analysis unit 130 or the storage unit 110, if necessary. Note that the adjustment of the degree of influence and the learning for the algorithm will be described later with reference to FIG. 5.

In the present embodiment, the degree of influence is adjusted by the processing unit 120, and then the re-learning of the algorithm is performed. Note that the degree of influence may be, for example, the degree of influence on the output information based on the algorithm. Thus, the output information is corrected by adjusting the degree of influence. Therefore, the information processing device 10 can generate more appropriate output information for the user by adjusting the degree of influence.

Furthermore, the specific learning data described above may be specified by the user. By specifying the specific learning data by the user, the degree of influence derived from the learning data desired by the user is adjusted. Consequently, the information processing device 10 can more appropriately achieve the state of the algorithm desired by the user.

Furthermore, the specific learning data described above may include user data that is data regarding the user. By adjusting the degree of influence derived from the user data, the state of the algorithm desired by the user is more appropriately achieved. Consequently, the information processing device 10 can generate output information more in line with the data regarding the user.

Furthermore, the user data described above may include position information regarding the position of the user. Thus, the information processing device 10 can generate the output information having contents that are more in line with the position of the user. Furthermore, the user data described above may include information regarding tastes of the user. Accordingly, the information processing device 10 can generate output information having contents that are more in line with the tastes of the user.

Furthermore, the processing unit 120 may perform re-learning for the algorithm according to a change of the user data. Accordingly, in a case where there is a change in the user data, the information processing device 10 can achieve the state of the algorithm according to the change and generate more appropriate output information.

The processing unit 120 will be described in more detail with reference to FIG. 5. FIG. 5 is a functional block diagram illustrating a configuration of the processing unit 120 according to the first embodiment. As illustrated in FIG. 5, the processing unit 120 can acquire learning data and perform correction or the like of the learning data, to thereby output learning data after correction. Furthermore, as illustrated in FIG. 5, the processing unit 120 includes an update unit 121, an extraction unit 122, a determination unit 123, and a correction unit 124. Information generated among these functional units may be appropriately transmitted between these functional units.

The update unit 121 has a function of updating various information recorded in at least one of the knowledge DB 111 or the recommendation DB 112 of the storage unit 110. For example, the update unit 121 updates various information according to the input information from the user. Furthermore, the update unit 121 updates various information according to changes in the learning data recorded in the learning DB 114. For example, the update unit 121 may update a recommendation score or the like recorded in the recommendation DB 112 when deletion, correction, or the like of the learning data recorded in the learning DB 114 is performed.

The information processing device 10 according to the present embodiment executes an algorithm of “acquiring input information and generating output information on the basis of various information recorded in the knowledge DB ill or the recommendation DB 112”. In the present embodiment, updating various information recorded in the knowledge DB 111 or the recommendation DB 112 corresponds to re-learning of the algorithm.

The extraction unit 122 has a function of extracting various information recorded in the storage unit 110. More specifically, the extraction unit 122 extracts a specific learning history that meets a predetermined condition from the learning history of the algorithm on the basis of a database recording data regarding the input information. The specific learning history that meets the predetermined condition may be, for example, a learning history that the user wants to delete. The specific learning history that meets the predetermined condition is used for re-learning of the algorithm. For example, when a specific learning history is deleted, re-learning of the algorithm is performed assuming that the learning history does not exist.

Furthermore, the learning data may be associated with the learning history. The information processing device 10 according to the present embodiment may adjust the degree of influence derived from the learning data. By adjusting the degree of influence, re-learning of the algorithm is performed. Accordingly, the information processing device 10 can generate more appropriate output information for the user.

The extraction unit 122 according to the first embodiment extracts the specific learning history that meets the predetermined condition from the learning DB 114 on the basis of the interaction DB 113 recording the data regarding the input information. The specific learning history that meets the predetermined condition described above may be, for example, a history related to learning of the algorithm based on learning data including a keyword specified by the user. Therefore, the extraction unit 122 extracts the learning history based on the learning data including the keyword specified by the user.

For example, the extraction unit 122 acquires input information requesting extraction of the keyword “Gunma” from the user. At this time, the extraction unit 122 may extract information including the keyword “Gunma” from at least one of the knowledge DB 111, the recommendation DB 112, or the interaction DB 113 of the storage unit 110. Moreover, the extraction unit 122 according to the present embodiment may extract the learning history indicating that the learning has been performed on the basis of the learning data including the above keywords from the learning DB 114.

The determination unit 123 has a function of performing various determinations. For example, the determination unit 123 may determine the magnitude of a change between the output information recorded in the interaction DB 113 and the output information generated by the generation unit 140. A result determined by the determination unit 123 is transmitted to the correction unit 124. Note that as will be described later, the correction unit 124 performs deletion, correction, or the like of the learning data on the basis of the determination result.

The correction unit 124 has a function of adjusting the degree of influence derived from the learning data. More specifically, the correction unit 124 according to the first embodiment has a function of adjusting the degree of influence derived from the learning data by deleting or correcting the learning data recorded in the learning DB 114. The correction unit 124 may delete or correct, for example, information representing output information that is recorded in the learning DB 114 and output.

As described above, the interaction information and the like recorded in the interaction DB 113 affect the algorithm. The correction unit 124 can adjust the degree of influence derived from the learning data by deleting or correcting the learning data recorded in the learning DB 114. More specifically, the correction unit 124 can eliminate the degree of influence on the algorithm derived from learning data by deleting the learning data. Furthermore, the correction unit 124 can increase or decrease the degree of influence on the algorithm derived from learning data by correcting the learning data. In this manner, the correction unit 124 can adjust the degree of influence derived from the learning data by deleting or correcting the learning data recorded in the learning DB 114.

Furthermore, the information recorded in the knowledge DB 111 or the recommendation DB 112 is information based on the learning data recorded in the learning DB 114. Thus, the learning data recorded in the learning DB 114 (for example, information related to the input information and the output information) is deleted or corrected by the correction unit 124, and thus the information recorded in the knowledge DB 111 or the recommendation DB 112 is re-learned. In this manner, the information processing device 10 according to the present embodiment adjusts the degree of influence derived from the learning data and causes re-learning to be performed for the algorithm.

(Generation Unit)

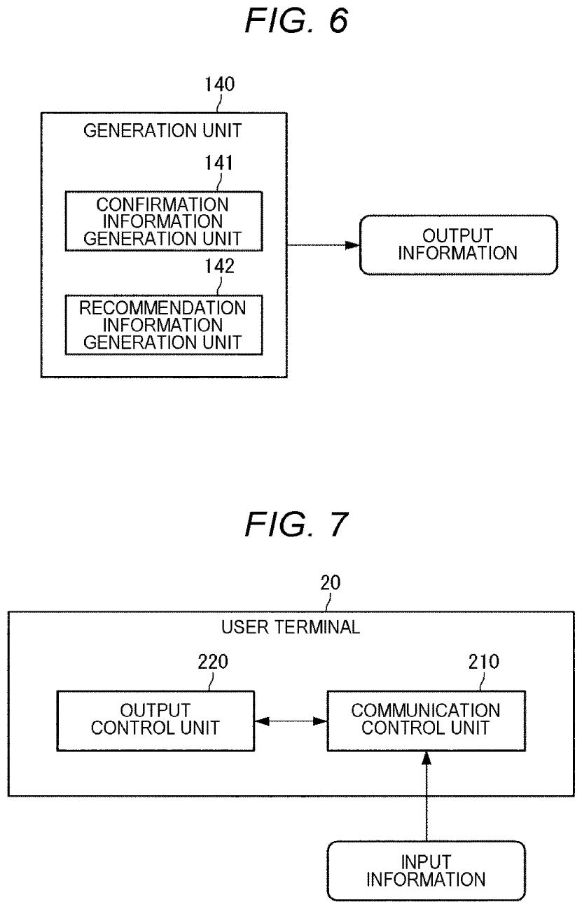

The generation unit 140 has a function of generating various output information on the basis of the information stored in the storage unit 110. Generated output information is transmitted to the output control unit 150. The function of the generation unit 140 will be described in more detail with reference to FIG. 6. FIG. 6 is a functional block diagram illustrating a configuration of the generation unit 140 according to the first embodiment. As illustrated in FIG. 6, the generation unit 140 includes a confirmation information generation unit 141 and a recommendation information generation unit 142.

The confirmation information generation unit 141 has a function of generating output information for performing a confirmation of each place by the user. For example, in a case where the learning data recorded in the learning DB 114 is deleted by the correction unit 124, the confirmation information generation unit 141 may generate output information for confirming to the user whether the learning data may be deleted.

The recommendation information generation unit 142 generates output information for making various recommendations to the user. For example, the recommendation information generation unit 142 may generate output information for playing music desired by the user. At this time, the recommendation information generation unit 142 may determine content to be recommended to the user on the basis of the recommendation score or the like recorded in the recommendation DB 112, and generate output information.

(Output Control Unit)

The output control unit 150 has a function of controlling output of output information. For example, the output control unit 150 may convert output information acquired from the generation unit 140 into information to be output by another terminal. For example, in a case where the output information includes text information, the output control unit 150 may convert content of the text information into voice information to be output as voice. The output control unit 150 transmits various acquired or generated information to the communication control unit 160. Note that the output control unit 150 may transmit the output information transmitted from the generation unit 140 to the communication control unit 160 as it is.

(Communication Control Unit)

The communication control unit 160 has a function of controlling transmission and reception of various information between the information processing device 10 and the various devices. For example, the communication control unit 160 controls transmission of information transmitted from the output control unit 150 from the information processing device 10 to the user terminal 20 via the network 30. Furthermore, the communication control unit 160 controls the information processing device 10 to receive various information from an external device (for example, the user terminal 20). The received various information is transmitted to the storage unit 110, the processing unit 120, or the analysis unit 130 via the communication control unit 160.

<User Terminal>

Next, a configuration of the user terminal 20 according to the first embodiment will be described with reference to FIG. 7. FIG. 7 is a functional block diagram illustrating the configuration of the user terminal 20 according to the first embodiment. As illustrated in FIG. 7, the user terminal 20 includes a communication control unit 210 and an output control unit 220.

(Communication Control Unit)

The communication control unit 210 has a function of controlling transmission and reception of various information between the user terminal 20 and various devices (for example, the information processing device 10). The communication control unit 160 acquires input information and controls transmission of the input information to the information processing device 10. Note that the input information may be input to the user terminal 20 on the basis of an operation by the user, or may be automatically input from various devices. Furthermore, the communication control unit 210 controls reception of information related to output information transmitted from the information processing device 10. Information related to received output information is transmitted to the output control unit 220.

(Output Control Unit)

The output control unit 220 controls various outputs by the user terminal 20. For example, the output control unit 220 transmits information related to the output information transmitted from the information processing device 10 to an output device included in the user terminal 20, thereby causing the output device to perform various outputs. For example, the output control unit 220 may control the output device so as to play music.

<Transmission and Reception of Information Between Information Processing System and User Terminal>

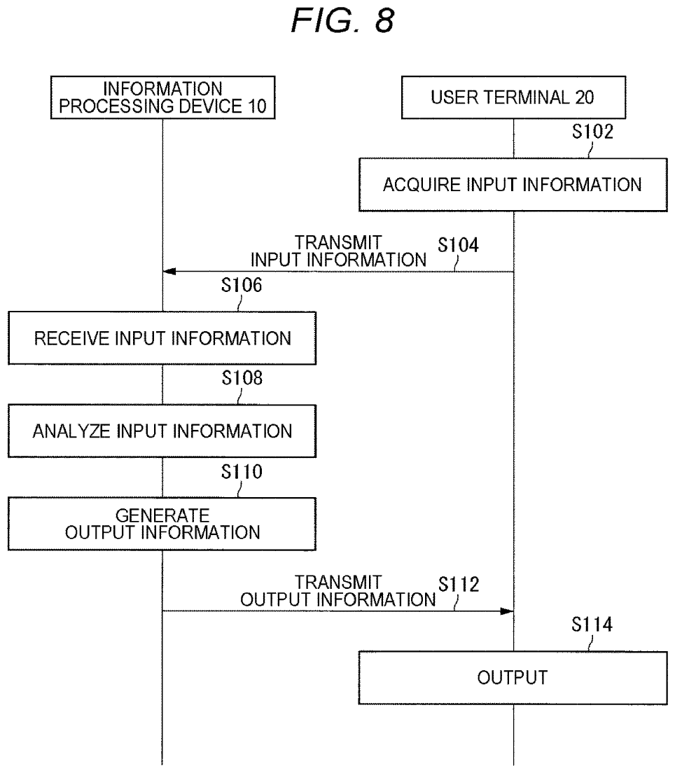

Next, transmission and reception of information between the information processing device 10 and the user terminal 20 according to the first embodiment will be described with reference to FIGS. 8 to 10. FIGS. 8 to 10 are flowcharts illustrating an example of transmission and reception of information between the information processing device 10 and the user terminal 20 according to the first embodiment. First, referring to FIG. 8, an example of transmission and reception of information (input information and output information) between the information processing device 10 and the user terminal 20 (hereinafter, also referred to as “interaction between the information processing device 10 and the user terminal 20”) according to the first embodiment will be described.

In the example illustrated in FIG. 8, the information processing device 10 generates output information according to the input information transmitted from the user terminal 20. The user terminal 20 receives the generated output information and outputs various information to the user according to the output information. Hereinafter, transmission and reception of information between the information processing device 10 and the user terminal 20 will be described in more detail with reference to FIG. 8.

First, the user terminal 20 acquires input information (step S102). More specifically, the communication control unit 210 included in the user terminal 20 acquires input information from the user. For example, the communication control unit 210 acquires voice information, “Gunma's favorite song is XX”, as input information. Next, the user terminal 20 transmits the input information to the information processing device 10 (step S104).

Next, the information processing device 10 receives the input information (step S106). The received input information is transmitted to the analysis unit 130 via the communication control unit 160.

Next, the analysis unit 130 analyzes the input information (step S108). More specifically, the analysis unit 130 analyzes meaning and content of the input information on the basis of the various information stored in the knowledge DB ill, or the like. For example, it is assumed that the knowledge DB 111 records that the word “Gunma” has only the meaning of “Gunma prefecture”. In this case, the analysis unit 130 cannot understand the meaning and content of the input information, and outputs an analysis result that the input information “Gunma's favorite song is XX” is inconsistent to the storage unit 110. At this time, the storage unit 110 records the result of analysis by the analysis unit 130 in the interaction DB 113. More specifically, the storage unit 110 stores the input information, “Gunma's favorite song is XX”, and the time when the input information is transmitted in the interaction DB 113 in association with each other.

Next, the generation unit 140 generates output information (step S110). More specifically, the generation unit 140 outputs output information on the basis of a result of analysis by the analysis unit 130 and the information stored in the storage unit 110. For example, the generation unit 140 generates voice information, “what is Gunma?”, as output information, and transmits the output information to the output control unit 150. At this time, the storage unit 110 records output information “what is Gunma?” in the learning DB 114 in association with the information recorded in step S108. At this time, the storage unit 110 records in the interaction DB 113 that there has been an interaction. More specifically, the storage unit 110 records the time of the interaction and content of the interaction in the interaction DB 113.

Next, the information processing device 10 transmits the output information to the user terminal 20 (step S112).

Next, the user terminal 20 outputs the output information (step S114). More specifically, the communication control unit 210 acquires the output information transmitted to the user terminal 20 and transmits the output information to the output control unit 220. The output control unit 220 causes the output device included in the user terminal 20 to output the output information on the basis of the output information. Here, the output device outputs voice information, “what is Gunma?”, as output information.

The example of transmission and reception of information between the information processing device 10 and the user terminal 20 has been described above. As described above, the input information and the output information are recorded in the learning DB 114 and used as the learning data.

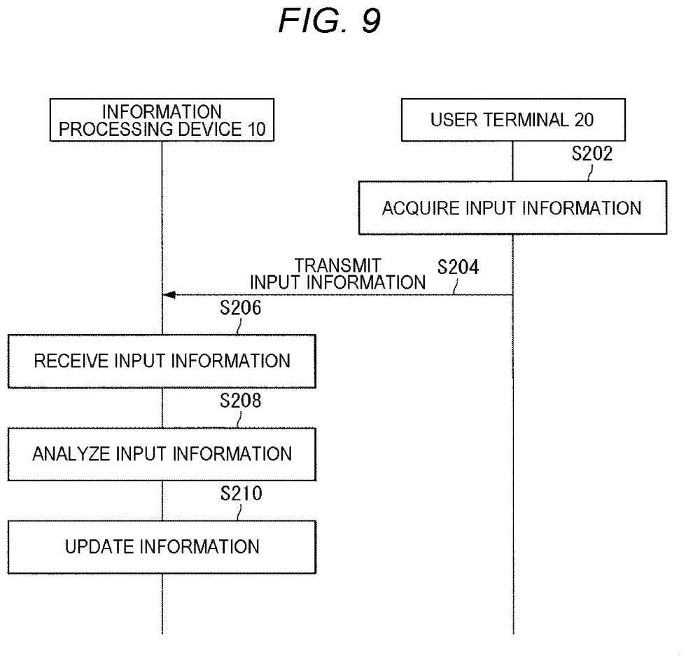

Next, with reference to FIG. 9, a second example relating to an interaction between the information processing device 10 and the user terminal 20 according to the first embodiment will be described. The interaction illustrated in FIG. 9 differs from the example of the interaction illustrated in FIG. 8 in that the information processing device 10 updates the information recorded in the knowledge DB 111 and the recommendation DB 112 on the basis of the input information.

First, the user terminal 20 acquires the input information (step S202). More specifically, the communication control unit 210 acquires input information from the user. For example, the communication control unit 210 acquires voice information, “Gunma is the nickname of my friend Iwasa”, as input information.

Next, processing of steps S204 and S206 is carried out, but since the processing of steps S204 and S206 is substantially the same as the processing of steps S104 and S106, the description thereof will be omitted here.

Upon completing the processing of step S206, the information processing device 10 analyzes the input information (step S208). More specifically, the analysis unit 130 analyzes meaning and content of the input information on the basis of the information recorded in the knowledge DB 111. The analysis unit 130 transmits an analysis result to the processing unit 120.

Next, the update unit 121 updates the information recorded in the knowledge DB 111 (step S210). More specifically, the update unit 121 records in the knowledge DB 111 that “Gunma” is a friend of the user. Furthermore, here, it is assumed that information that “Gunma's favorite song is XX” is recorded in the knowledge DB 111. At this time, the update unit 121 records in the knowledge DB 111 that “Gunma” likes the song XX on the basis of the analysis result in step S208. Furthermore, the update unit 121 creates a playlist of Gunma's favorite songs in the recommendation DB 112. Moreover, the update unit 121 adds the Gunma's favorite song XX to the playlist.

As described above, an example of the interaction between the information processing device 10 and the user terminal 20 has been described with reference to FIG. 9. In the example illustrated in FIG. 9, the information processing device 10 updates the information stored in the storage unit 110 in response to the input information from the user terminal 20. Accordingly, it is possible for the information processing device 10 to generate output information that is more in line with wishes of the user. For example, in a case where the input information, “please play Gunma's favorite song”, is input to the information processing device 10, it is possible to generate output information for outputting XX that is Gunma's favorite song to the user terminal 20.

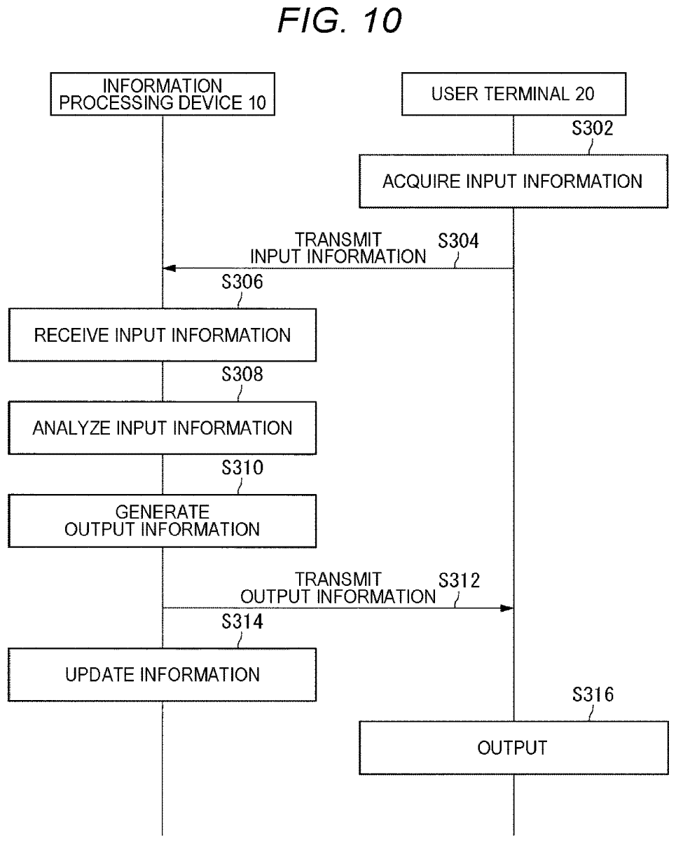

Next, with reference to FIG. 10, a third example relating to the interaction between the information processing device 10 and the user terminal 20 according to the present embodiment will be described. In the third example, in addition to the processing according to the second example, processing in which the information processing device 10 transmits output information to the user terminal 20 and the user terminal 20 outputs the output information is added. Hereinafter, the third example will be described with reference to FIG. 10.

First, the user terminal 20 acquires input information (step S302). More specifically, the communication control unit 210 acquires input information from the user. For example, the communication control unit 210 acquires voice information, “play Gunma's song”, as input information.

Next, processing of steps S304 to S308 is carried out, but since the processing of steps S304 to S306 is substantially the same as the processing of steps S204 to S208, the description thereof will be omitted here.

Upon completing the processing of step S308, the information processing device 10 generates output information (step S310). More specifically, the recommendation information generation unit 142 generates output information on the basis of an analysis result by the analysis unit 130 and the information recorded in the recommendation DB 112. For example, the recommendation information generation unit 142 generates output information for playing a song included in the favorite playlist of Gunma, which is stored in the recommendation DB 112. The song to be played may be the song with the highest recommendation score, or may be a song with a recommendation score that is randomly selected from, for example, the top 5%. The recommendation information generation unit 142 transmits the output information to the output control unit 150.

Next, the information processing device 10 transmits the output information to the user terminal 20 (step S312).

Next, the information processing device 10 updates the information stored in the storage unit 110 (step S314). For example, the update unit 121 raises the recommendation score for the song selected by the recommendation information generation unit 142. Furthermore, the update unit 121 records the input information that is input and the output information that is output in the learning DB 114. Furthermore, the time of the interaction and the content of the interaction are recorded in the interaction DB 113.

Next, the user terminal 20 outputs the output information (step S316). More specifically, the communication control unit 210 acquires the output information transmitted to the user terminal 20, and transmits the acquired output information to the output control unit 220. The output control unit 220 causes the output device to output the output information. Accordingly, the output device plays, for example, a song included in the favorite playlist of Gunma.

As described above, the third example of the interaction between the information processing device 10 and the user terminal 20 according to the present embodiment has been described with reference to FIG. 10. According to the third example, the information processing device 10 generates output information according to the input information from the user terminal 20, and transmits the generated output information to the user terminal 20. Furthermore, the information processing device 10 updates the information stored in the storage unit 110 according to the input information and the output information.

In the description using FIGS. 8 to 10 described above, the output information regarding “Gunma” is generated on the basis of the input information including the noun “Gunma”. Not limited to this, the output information regarding “Gunma” may be generated on the basis of the input information that does not include the noun “Gunma”. That is, the user can also implicitly instruct the information processing device 10 to generate output information regarding “Gunma” without saying the word “Gunma”.

For example, in step S302, it is assumed that the user inputs voice information, “play a song having a similar taste to the song heard yesterday”, as input information. The voice information does not include the word “Gunma”, but it is assumed that “the song heard yesterday” means a “Gunma's song”. Then, in step S308, the analysis unit 130 can analyze that the “song heard yesterday” included in the input information of the user means the “Gunma's song” on the basis of the information recorded in the knowledge DB 111. Consequently, in step S310, the recommendation information generation unit 142 generates output information for causing the user terminal 20 to play a song having a similar taste to the “Gunma's song”. Correspondingly, in step S314, the update unit 121 raises the recommendation score for a song having a similar taste to the “Gunma's song” stored in the recommendation DB 112. Moreover, the user terminal 20 plays a song having a similar taste to the “Gunma's song” in step S316.

Here, the example in which the user inputs voice information, “play a song having a similar taste to the song heard yesterday”, in step S302 has been described, but voice information, “play a song completely different from the song heard yesterday”, may be input to the user terminal 20. In this case, the recommendation information generation unit 142 generates output information for causing the user terminal 20 to play a song having a completely different taste from the “Gunma's song”. Accordingly, the user terminal 20 can play a song having a completely different taste from the “Gunma's song”. Moreover, the update unit 121 may raise the recommendation score for a song having a completely different taste from the “Gunma's song” recorded in the recommendation DB 112.

As described above, with the information processing device 10 and the user terminal 20 according to the present embodiment, the user can cause the user terminal 20 to output the output information regarding “Gunma” without directly speaking the noun “Gunma”. Moreover, the update unit 121 can also update various information regarding the “Gunma” stored in the storage unit 110.

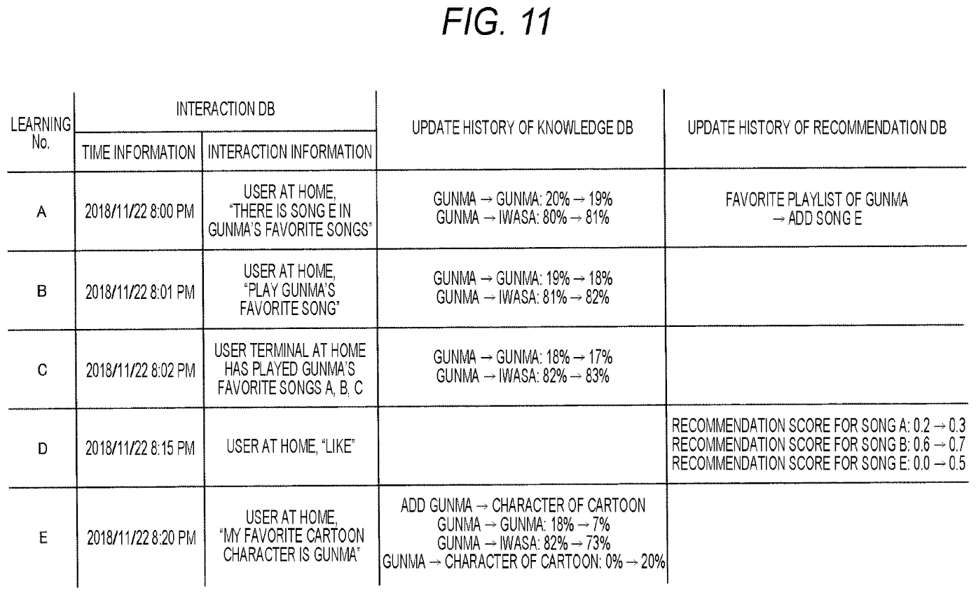

The interaction between the information processing device 10 and the user terminal 20 according to the present embodiment has been described above. Next, with reference to FIG. 11, the interaction DB 113, an update history of the knowledge DB 111, and an update history of the recommendation DB 112 constructed on the basis of the above interaction will be described. FIG. 11 is a diagram illustrating an example of the information recorded in the interaction DB 113, the update history of the knowledge DB 111, and the update history of the recommendation DB 112 according to the first embodiment.

FIG. 11 illustrates five pieces of information (Nos. A to E) for the interaction DB 113, the update history of the knowledge DB 111, and the update history of the recommendation DB 112. For example, in No. A of the interaction DB 113, there are recorded “2018/11/22 8:00 PM” as time information and that input information, “there is song E in Gunma's favorite songs”, has been input by the user at home as interaction information.

The analysis unit 130 analyzes that the word “Gunma” in the input information means the name of a person named “Iwasa”. Then, the update unit 121 raises the probability that the word “Gunma” means “Iwasa”. More specifically, the update unit 121 raises the probability that the word “Gunma” recorded in the knowledge DB 111 means “Iwasa” from 80% to 81%. Accordingly, the analysis unit 130 will analyze that the word “Gunma” means the personal name (nickname) “Iwasa” with a probability of 81%. On the other hand, the update unit 121 reduces the probability that the word “Gunma” stored in the knowledge DB 111 means the prefecture name “Gunma” from 20% to 19%. Accordingly, the analysis unit 130 will analyze the word “Gunma” as meaning the prefecture name “Gunma” with a probability of 19%. Furthermore, the update unit 121 adds and records the song E in the favorite playlist of “Gunma” in the recommendation DB 112.

Hereinafter, the records of the knowledge DB 111 and the recommendation DB 112 are updated according to the interaction information related to Nos. B to E, similarly to No. A. Specifically, in No. B of the interaction DB 113, there are recorded “2018/11/28 8:01 PM” as time information and that there has been input information, “play Gunma's favorite song”, from the user at home as interaction information. Correspondingly, in the knowledge DB 111, the probability that “Gunma” means “Gunma” has been updated from 19% to 18%, and the probability that “Gunma” means “Iwasa” has been updated from 81% to 82%.

Furthermore, in No. C of the interaction DB 113, there are recorded “2018/11/28 8:02 PM” as time information, and that songs A, B, and E are played from the favorite playlist of Gunma by the user at home as interaction information. Correspondingly, in the knowledge DB 111, the probability that “Gunma” means “Gunma” has been updated from 18% to 17%, and the probability that “Gunma” means “Iwasa” has been updated from 82% to 83%.

Furthermore, in No. D of the interaction DB 113, there are recorded “2018/11/28 8:15 PM” as time information, and that input information, “like”, has been input by the user at home as interaction information. The input information, “like”, is presumed to be a response to that the songs A, B, and E in No. C are played. Thus, in the recommendation DB 112, the recommendation score for the song A is updated from 0.2 to 0.3, the recommendation score for the song B is updated from 0.6 to 0.7, and the recommendation score for the song E is updated from 0.0 to 0.5.

Moreover, in No. E of the interaction DB 113, there are recorded “2018/11/28 8:20 PM” as time information, and that input information, “my favorite comic character is Gunma”, has been input by the user at home as interaction information. Correspondingly, in the knowledge DB 111, the probability that “Gunma” means “Gunma” is updated from 17% to 7%, and the probability that “Gunma” means “Iwasa” is updated from 82% to 73%. Moreover, the knowledge DB 111 adds that “Gunma” may be a comic character, and the probability that “Gunma” means a comic character has been updated from 0% to 20%.

As described above, various information stored in the information processing device 10 is updated by the interaction between the information processing device 10 and the user terminal 20 according to the present embodiment. More specifically, the information stored in the interaction DB 113 is used as learning data, and the information stored in the knowledge DB 111 and the recommendation DB 112 is updated as the learning data is accumulated. The generation unit 140 generates output information on the basis of the information stored in the knowledge DB 111 and the recommendation DB 112. Thus, as the learning data is accumulated, the algorithm for the information processing device 10 to output the output information changes.

As described above, the information recorded in the learning DB 114, which is the learning data, affects the information recorded in the knowledge DB 111 or the recommendation DB 112. The learning data is generated by, for example, interacting with the user, and is accumulated in the learning DB 114. Thus, the knowledge DB 111 and the recommendation DB 112 that accumulate the data generated on the basis of the learning data generated by the interaction with the user become a database suitable for the user. The database suitable for the user is, for example, a database that reflects tastes and lifestyle of the user.

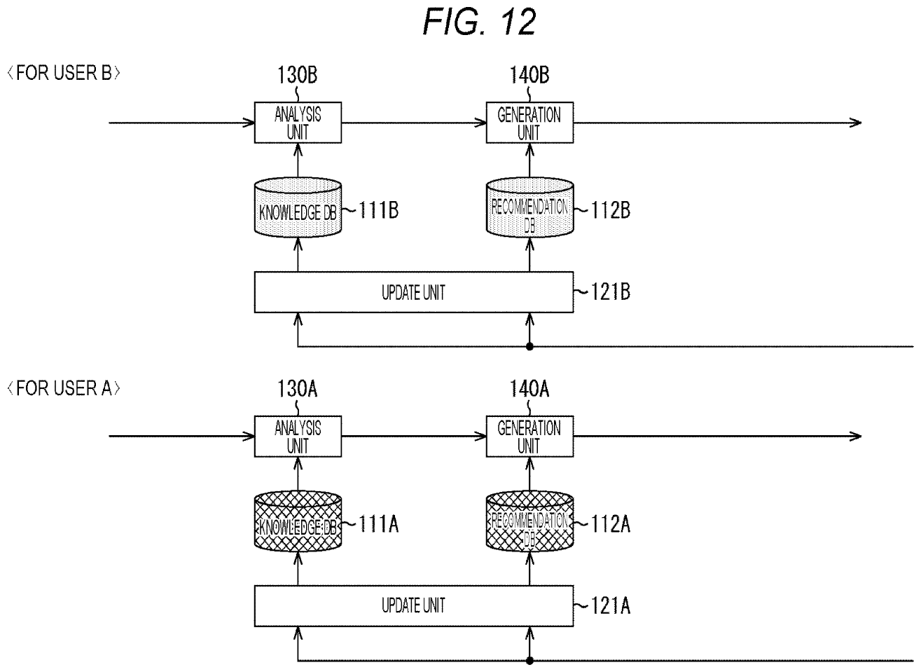

For example, the situation illustrated in FIG. 12 is assumed. By performing the processing as described above, the knowledge DB 111A and the recommendation DB 112A are constructed for the user A. Furthermore, by performing the processing as described above, the knowledge DB 111B and the recommendation DB 112B are constructed for the user B.

The knowledge DB 111A and the recommendation DB 112A of the user A are constructed by being updated by the update unit 121A on the basis of the feedback from the user A. Information input from the user A by, for example, voice input, is analyzed by the analysis unit 130A with reference to the knowledge DB 111A, and the feedback is information given by the user A, such as a reaction of the user A and a response from the user A to information generated by the generation unit 140A by referring to the recommendation DB 112A.

The knowledge DB 111A and the recommendation DB 112A of the user A constructed in this manner are databases that reflect the tastes and lifestyle of the user A. Furthermore, information recommended by using such a database can be information suitable for the user A.

Similarly, the knowledge DB 111B and the recommendation DB 112B of the user B are constructed by being updated by the update unit 121B on the basis of the feedback from the user B. Furthermore, information input from the user B by, for example, voice input, is analyzed by the analysis unit 130B with reference to the knowledge DB 111B, and the feedback is a reaction of the user B to information generated by the generation unit 140B by referring to the recommendation DB 112B.

The knowledge DB 111B and the recommendation DB 112B of the user B constructed in this manner are databases that reflect the tastes and lifestyle of the user B. Furthermore, information recommended by using such databases can be information suitable for the user B.

Here, it is assumed that the user B is a person whom the user A longs for or a target person. For example, the user B is a celebrity such as an entertainer or an athlete, and the user A may desire to obtain various information such as what such a celebrity is interested in and when and what the celebrity does.

Here, it is assumed that a case where the user A lives by using the knowledge DB 111B and the recommendation DB 112B of the user B. In a case where the user A lives using the knowledge DB 111B and the recommendation DB 112B of the user B, it is considered that the user A can experience the life of the user B in a simulated manner. For example, information recommended to the user B, such as listening to a song A, purchasing an item B, ordering a menu C, going to a place D, and using a service E if it is the user B when in a situation A can be recommended to the user A.

The user A wants to be like the user B, and can experience the life of the user B in a simulated manner by using the knowledge DB 111B and the recommendation DB 112B of the user B. In a case where the user B is an athlete, when the user A wants to be an athlete like the user B, for example, a song that the user B listens to during training, a meal menu, or the like can be recommend to the user A by using the knowledge DB 111B and the recommendation DB 112B of the user B.

Also, the user B does not have to be a specific person such as a celebrity. For example, it may be the knowledge DB 111B or the recommendation DB 112B of the user B who has passed the university A. For example, when the user A studies to take an examination of a university A that the user B has passed, by using the knowledge DB 111B and the recommendation DB 112B of the user B, it is possible to recommend to the user A what time zone and what subject the user B has studied, and what kind of the song he or she was listening to during a break.

As will be described later, a plurality of knowledge DBs 111 can be integrated into one knowledge DB 111, and a plurality of recommendation DBs 112 can be integrated into one recommendation DB 112. By using this integration method, it is possible to create the knowledge DB 111 and the recommendation DB 112 of a plurality of users who have passed the university A. For example, this database can be sold and distributed as a database for passing the university A, and the user A can use such a database to receive various recommendations for approaching passing.

As an example, it is assumed that it is desired to use the knowledge DB 111 and the recommendation DB 112 learned by another user in this manner. Accordingly, a case where the knowledge DB 111 and the recommendation DB 112 learned by the another user can be used as the knowledge DB 111 and the recommendation DB 112 of oneself will be described below.

In the following description, a case where the knowledge DB 111A and the recommendation DB 112A are constructed as the database for the user A and the knowledge DB 111B and the recommendation DB 112B are constructed as the database for the user B as described with reference to FIG. 12, and the user A uses the database for the user B (the database for the user B is diverted as the database for the user A) will be described as an example.

<First Method of Diverting Database of Another User>

As a first method of diverting a database of another user, a case of diverting a database of another user as a database of oneself by replacing the recommendation DB 112 of oneself with the recommendation DB 112 of another user will be described.

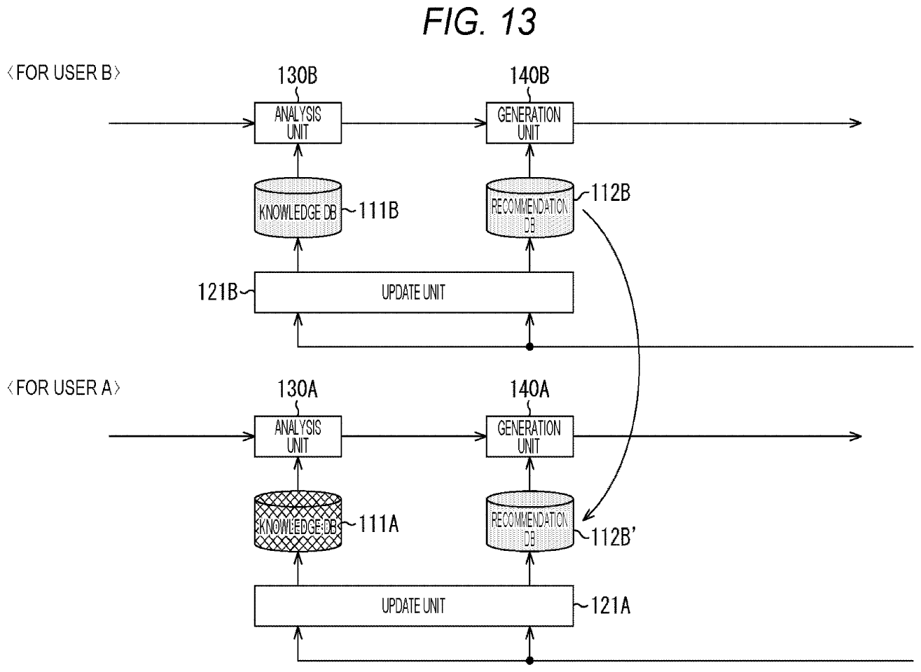

FIG. 13 is a diagram for describing the first diverting method. The recommendation DB 112A of the user A is replaced with the recommendation DB 112B for the user B. By the replacement, the user A can receive a recommendation referring to a recommendation DB 112B′ for the user B. Here, the replaced recommendation DB 112B is described with a prime to indicate that it has been replaced.

By performing such replacement, information input by the user A by voice input or the like is analyzed by the analysis unit 130A by referring to the knowledge DB 111A constructed for the user A, and the recommendation DB 112B′ constructed for the user B is referred to by the generation unit 140A, to thereby generate information recommended to the user A.

In this manner, the recommendation referring to the recommendation DB 112B′ constructed for the user B is made to the user A. Thus, a recommendation according to the tastes and lifestyle of the user B is made to the user A.

In this manner, after the recommendation DB 112A constructed for the user A is replaced with the recommendation DB 112B′ constructed for the user B, in a case where the user A says, for example, “play music”, the analysis unit 130A analyzes that an instruction to play music is issued, and the generation unit 140A (recommendation information generation unit 142 thereof) refers to the recommendation DB 112B′ and selects, for example, a song with a high recommendation score to generate output information to play the song.

In this case, since the recommendation score is information generated on the basis of the taste of the user B, the song that matches the tastes of the user B is presented to the user A.

Furthermore, for example, in a case where the user A says “play Gunma's song”, the analysis unit 130A refers to the knowledge DB 111A, analyzes that “Gunma” is a friend of the user A, and analyzes the instruction, “play Gunma's song”, as an instruction to play a favorite song of a friend of the user A. On the basis of this analysis result, the generation unit 140A (recommendation information generation unit 142 thereof) refers to the recommendation DB 112B′ and reads out the playlist of Gunma's favorite songs.

However, since the recommendation DB 112B′ is a database constructed for the user B, the playlist of Gunma's favorite songs, which is the information of the user A, is not stored therein. Thus, the generation unit 140A generates, for example, a message such as “there is no Gunma's song” or a message such as “please tell me Gunma's favorite song”. Alternatively, after the database is replaced, in order to make the user A aware of the replacement, a message such as “may I play a favorite song of the user B?” or a message such as “there is no Gunma's song, so I'll play an alternative song” may be generated.

Furthermore, for example, in a case where the user A says “play a song of the user B”, the analysis unit 130A analyzes that the user B is a person and it is an instruction to play a favorite song of the person. If the analysis unit 130A cannot analyze that the user B is a person, a message such as “what is user B?” may be generated by processing of the generation unit 140A in the subsequent stage. The processing in this case is performed similarly to the processing described with reference to the flowchart of FIG. 8, and as a result, the knowledge DB 111A is updated and information such as user B=person is written.

The generation unit 140A (recommendation information generation unit 142 thereof) refers to the recommendation DB 112B′, refers to the playlist of the favorite song of the user B, selects the song with the high recommendation score, and generates output information for playing the song. In this manner, a favorite song of the user B can be recommended to the user A.

Note that as described above, due to the processing of the update unit 121A, there is a possibility that the recommendation DB 112B′ also becomes a database suitable for the tastes of the user A with passage of time (as the learning proceeds). In other words, there is a possibility that the recommendation DB 112B′ returns to a state close to the recommendation DB 112A before replacement. It may not be preferable for the user A to return to the recommendation DB 112A for the user A even though his or her recommendation DB 112A is replaced with the recommendation DB 112B′ of the user B by the intention of the user A.

Accordingly, in a case where such a database replacement is performed, some restrictions may be set on the update of the update unit 121, so that the data accumulated in the database after replacement is not updated frequently. For example, there may be a restriction such that update is performed only when instructed (permitted) by the user, or update will not be performed for a predetermined period after replacement, for example, one week.

By replacing the recommendation DB 112 with the recommendation DB 112 of a user desired by the user in this manner, it becomes possible to receive a recommendation using the recommendation DB 112 after replacement.

<Second Method of Diverting Database of Another User>

As a second method of diverting a database of another user, a case of replacing the knowledge DB ill of oneself with the knowledge DB 111 of another user will be described.

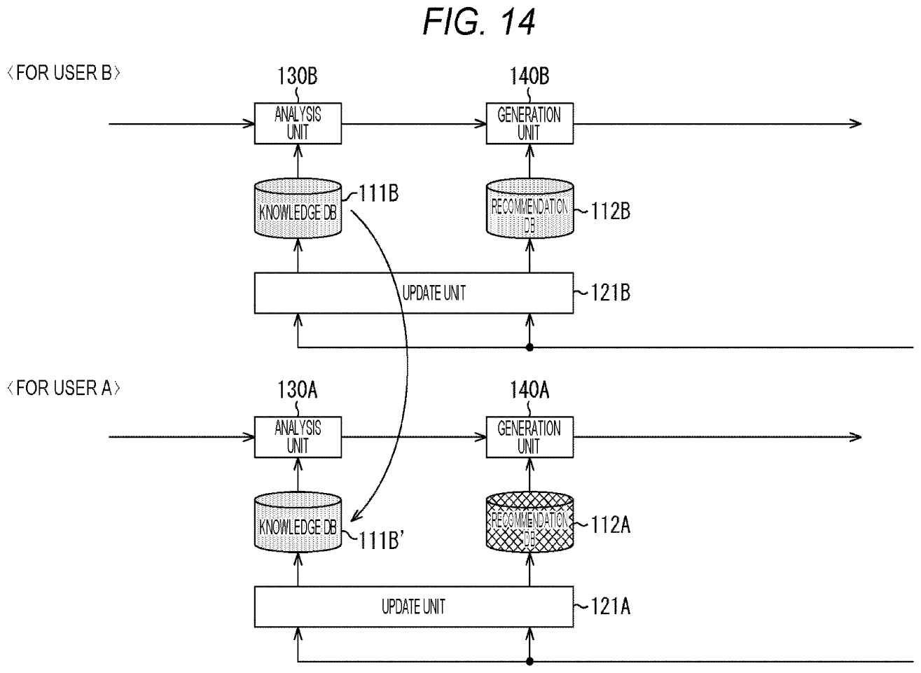

FIG. 14 is a diagram for describing the second diverting method. The knowledge DB 111A of the user A is replaced with the knowledge DB 111B for the user B. By the replacement, the user A can refer to the knowledge DB 111B′ for the user B and receive a recommendation using a result of semantic analysis. Here, the replaced knowledge DB 111B is described with a prime to indicate that it has been replaced.

By performing such replacement, information input by the user A by voice input or the like is analyzed by the analysis unit 130A by referring to the knowledge DB 111B constructed for the user B, and the recommendation DB 112A constructed for the user A is referred to by the generation unit 140A, to thereby generate information recommended to the user A.

In this manner, a semantic analysis referring to the knowledge DB 111B′ constructed for the user B will be performed for the user A. Thus, the semantic analysis is performed for the user A using knowledge obtained from life and friendship of the user B, and the recommendation is made using a result of the semantic analysis.

In this manner, after the knowledge DB 111A constructed for the user A is replaced with the knowledge DB 111A′ constructed for the user B, in a case where the user A says, for example, “play music”, the analysis unit 130A analyzes that an instruction to play music is given, and the generation unit 140A (recommendation information generation unit 142 thereof) refers to the recommendation DB 112A, selects a song with a high recommendation score, and generates output information to play the song.

Furthermore, for example, in a case where the user A says “play Gunma's song”, the analysis unit 130A performs a semantic analysis with reference to the knowledge DB 111B′. Since information that “Gunma” is a friend of the user A is recorded in the knowledge DB 111A before the replacement, it is analyzed as an instruction to play a favorite song of a friend of the user A called “Gunma”, but such information is not recorded in the knowledge DB 111B′ after replacement, and thus a result that the analysis cannot be performed (a result that the instruction content is inconsistent) is output to the generation unit 140A.

The generation unit 140A generates, for example, a message such as “what is Gunma?”. A process of generating such a message can be performed similarly to the process described with reference to FIG. 8. If such processing is performed and there is a response (feedback) from the user A, the knowledge DB 111B′ is updated on the basis of content thereof. Although it may be updated in this manner, if such an update is performed, there is a possibility that the knowledge DB 111B′ after replacement returns to a state close to the knowledge DB 111A before replacement.

It may not be preferable for the user A to return to the knowledge DB 111A for the user A even though his or her knowledge DB 111A is replaced with the knowledge DB 111B′ of the user B by the intention of the user A. Accordingly, in a case where such a database replacement is performed, some restrictions may be set on the update of the update unit 121A, so that the data accumulated in the database after replacement is not updated frequently. For example, there may be a restriction such that update is performed only when instructed (permitted) by the user, or update will not be performed for a predetermined period after replacement, for example, one week.

Furthermore, after the knowledge DB 111 is replaced, the generation unit 140A may generate a message for the user A to recognize that the knowledge DB 111 has been replaced. For example, a message such as “there is no information of Gunma, but there is information of user B” or a message such as “can I play a favorite song of the user B?” may be generated.

As yet another example, in a case where the user A says “play the song of the user B”, the analysis unit 130A analyzes that it is an instruction to refer to the knowledge DB 111B′, read out information regarding the favorite song of the user B, and play the song. Information that “a favorite song of the user B is YY” is recorded in the knowledge DB 111B′. For example, since the processing described with reference to FIGS. 8 and 9 is also executed in the information processing device 10 on the user B side, in the database constructed as the knowledge DB 111B for the user B, the information that “a favorite song of the user B is YY” is also accumulated.

Furthermore, by being replaced with the knowledge DB 111B′, the update unit 121A can update the recommendation DB 112A on the basis of the information recorded in the knowledge DB 111B′. For example, a playlist of favorite songs of the user B can be created in the recommendation DB 112A on the basis of the information that “a favorite song of the user B is YY” recorded in knowledge DB 111B′.

By performing such an update, the playlist of the favorite songs of the user B is also recorded in the recommendation DB 112A, so that the generation unit 140A (recommendation information generation unit 142 thereof) refers to the recommendation DB 112A, refers to the playlist of favorite songs of the user B, selects a song with a high recommendation score, and generates output information for playing the song.

By replacing the knowledge DB 111 with the knowledge DB 111 of the user desired by the user in this manner, it is possible to provide a recommendation using the knowledge DB 111 after the replacement.

<Third Method of Diverting Database of Another User>

As a third method of diverting a database of another user, a case of using the recommendation DB 112 of oneself and the recommendation DB 112 of another user together will be described.

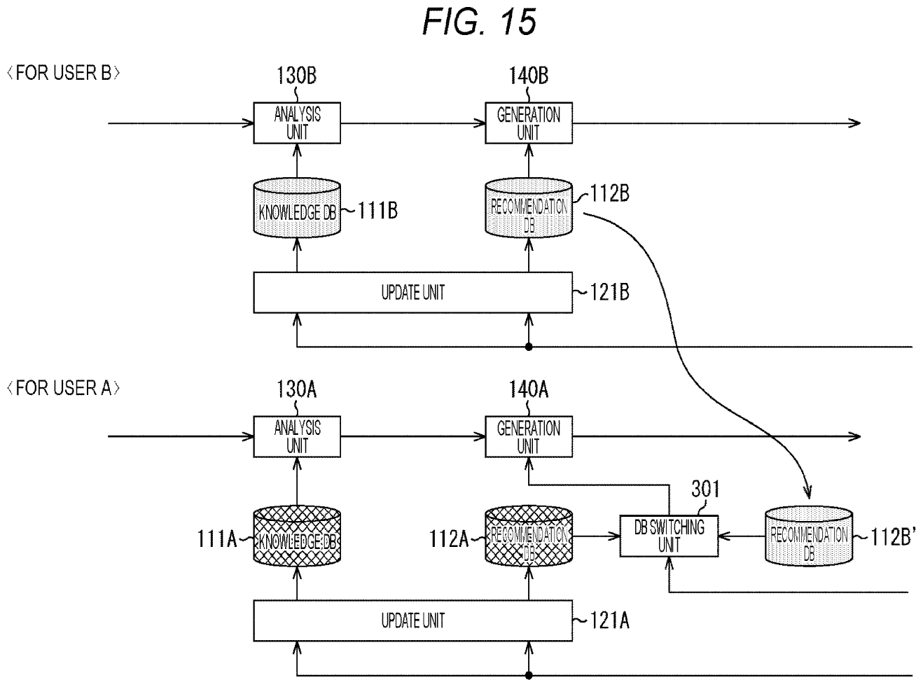

FIG. 15 is a diagram for describing the third diverting method. The recommendation DB 112B′ for the user B is added to the storage unit 110 (FIG. 4) of the information processing device 10 of the user A. By the addition, the storage unit 110 of the user A stores the recommendation DB 112A constructed for the user A and the recommendation DB 112B constructed for the user B. It is a configuration that a DB switching unit 301 is added so that either one database of the two recommendation DBs 112 can be referred to.

The DB switching unit 301 may be provided as a part of the function of the generation unit 140, or may be provided between the storage unit 110 and the generation unit 140 in the configuration of the information processing device 10 illustrated in FIG. 3.

The user A can receive a recommendation with reference to the recommendation DB 112B′ for the user B. A process in a case where the DB switching unit 301 switches the referred database to the recommendation DB 112B′ side is performed as described in the first diverting method described above. Thus, it is possible that information input by the user A by voice input or the like is analyzed by the analysis unit 130A by referring to the knowledge DB 111A constructed for the user A, and the recommendation DB 112B′ constructed for the user B is referred to by the generation unit 140A, to thereby generate information recommended to the user A.

Furthermore, as processing in a case where the DB switching unit 301 switches the referred database to the recommendation DB 112A side, the processing described with reference to the flowcharts of FIGS. 8 to 10 is performed. Thus, it is possible that the information input by the user A by voice input or the like is analyzed by the analysis unit 130A by referring to the knowledge DB 111A constructed for the user A, and the recommendation DB 112A constructed for the user A is referred to by the generation unit 140A, to thereby generate information recommended to the user A.

In this manner, the recommendation referring to the recommendation DB 112A constructed for the user A or the recommendation referring to the recommendation DB 112B′ constructed for the user B is made to the user A. Thus, a recommendation according to information of the tastes and lifestyle and the like of each of the user A and the user B is made to the user A.

The switching of the DB switching unit 301 can be made to be switched when the position of the user A changes significantly, for example, when going on a trip or when moving. For example, when the user A travels to a region B, it is switched to the recommendation DB 112B′ constructed for the user B living in the region B. Then, the recommended information is generated by referring to the recommendation DB 112B′. In this case, information closely related to the region B, such as a restaurant that the user B living in the region B uses on a daily basis and a play area that he or she often visits, can be recommended to the user A.

Furthermore, the switching of the DB switching unit 301 can be made to be switched, for example, depending on the time zone. For example, in a case where the user A is an examinee and the user B is an examination passer of a school that the user A wants to pass, for example, during night hours, the referred database is switched to the recommendation DB 112B′ constructed for the user B, so that it becomes possible to recommend what subject and how the user B has studied during night hours to the user A.

Furthermore, the switching of the DB switching unit 301 may be switched according to the analysis result of the analysis unit 130A, for example. For example, in a case where the user A says “play Gunma's song”, the analysis unit 130A refers to the knowledge DB 111A, analyzes that “Gunma” is a friend of the user A, and analyzes that it is an instruction to play a favorite song of a friend called “Gunma” of the user A. On the basis of this analysis result, the generation unit 140A (recommendation information generation unit 142 thereof) refers to the recommendation DB 112B′ and reads out the playlist of Gunma's favorite songs.

However, since the recommendation DB 112B′ is a database constructed for the user B, the playlist of Gunma's favorite songs, which is the information of the user A, is not stored therein. In such a case, the DB switching unit 301 switches the referred database to the recommendation DB 112A. By switching the referred database to the recommendation DB 112A, a song with a high recommendation score that is Gunma's favorite is selected, and output information for playing that song is generated.

Of course, the switching timing of the DB switching unit 301 may be a timing other than the above, and the above example is an example and is not a description indicating limitation.

<Fourth Method of Diverting Database of Another User>

As a fourth method of diverting a database of another user, a case of using the knowledge DB 111 of oneself and the knowledge DB 111 of another user together will be described.

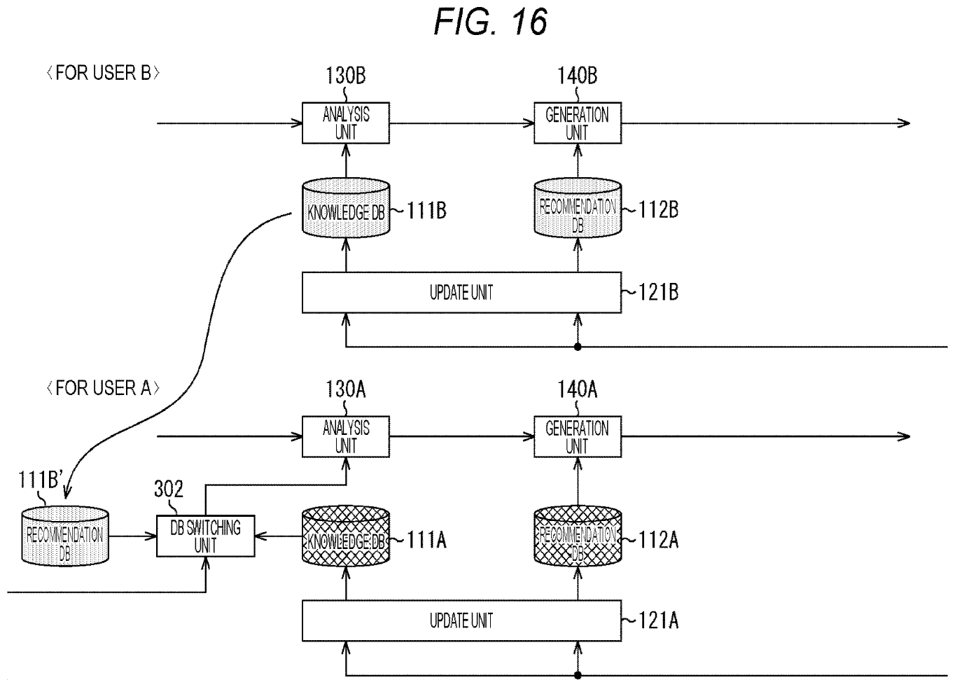

FIG. 16 is a diagram for describing the fourth diverting method. The knowledge DB 111B′ for the user B is added to the storage unit 110 (FIG. 4) of the information processing device 10 of the user A. By being added, the knowledge DB 111A constructed for the user A and the knowledge DB 111B constructed for the user B are stored in the storage unit 110 of the user A. It is a configuration that a DB switching unit 302 is added so that either one database of the two knowledge DBs 111 can be switched and referred to.

The DB switching unit 302 may be provided as a part of the function of the generation unit 140 or may be provided between the storage unit 110 and the generation unit 140 in the configuration of the information processing device 10 illustrated in FIG. 3.

The user A can receive a recommendation based on an analysis result with reference to the knowledge DB 111B′ for the user B. A process in a case where the DB switching unit 302 switches the referred database to the knowledge DB 111B′ side is performed as described in the second diverting method described above. Thus, the information input by the user A by voice input or the like is analyzed by the analysis unit 130A by referring to the knowledge DB 111B′ constructed for the user B, and the knowledge DB 111A constructed for the user A is referred to by the generation unit 140A, to thereby generate information recommended to the user A.

Furthermore, as processing in a case where the DB switching unit 302 switches the referred database to the knowledge DB 111A side, the processing described with reference to the flowcharts of FIGS. 8 to 10 is performed. Thus, the information input by the user A by voice input or the like is analyzed by the analysis unit 130A by referring to the knowledge DB 111A constructed for the user A, and the knowledge DB 111A constructed for the user A is referred to by the generation unit 140A, to thereby generate information recommended to the user A.

In this manner, a semantic analysis referring to the knowledge DB 111A constructed for the user A, or a semantic analysis referring to the knowledge DB 111B′ constructed for recommended user B is performed, and a recommendation using a result of the semantic analysis will be made to the user A. Thus, a recommendation according to information of the tastes and lifestyle and the like of each of the user A and the user B is made to the user A.

The switching of the DB switching unit 302 can be made to be switched when the position of the user A changes significantly, for example, when going on a trip or when moving. For example, when the user A travels to the region B, it is switched to the knowledge DB 111B′ constructed for the user B living in the region B. Then, a semantic analysis may be performed by referring to the knowledge DB 111B′, and recommended information may be generated on the basis of an analysis result thereof. In this case, since information such as a restaurant that the user B living in the region B uses on a daily basis and a play area that he or she often visits is recorded in the knowledge DB 111B′, it becomes possible to perform a semantic analysis also suitable for information closely related to the region B, and make a recommendation based on the semantic analysis to the user A.

Furthermore, the switching of the DB switching unit 302 can be made to be switched, for example, depending on the time zone. For example, in a case where the user A is an examinee and the user B is an examination passer of a school that the user A wants to pass, for example, during night hours, it is switched to the knowledge DB 111B′ constructed for the user B. Then, if information of a song that the user B has been listening to during night hours is accumulated in the knowledge DB 111B′, for example, when the user A wishes to listen to the song during a break time in studies, information of the song that the user B has been listening to can be read from the knowledge DB 111B′ and recommended to the user A.

Furthermore, the switching of the DB switching unit 302 may be made to be switched, for example, when there is a contradiction in the analysis of the analysis unit 130A. For example, in a case where the user A says “play Gunma's song”, since “Gunma” cannot be analyzed as a friend of the user A when the DB switching unit 302 is switched to refer to the knowledge DB 111B′, it is analyzed that there is a contradiction in the instruction to “play Gunma's song”. In a case where it is analyzed that there is such a contradiction, the DB switching unit 302 switches the referred database to refer to the knowledge DB 111A.

The analysis unit 130A can analyze that “Gunma” is a friend of the user A by referring to the knowledge DB 111A, and can analyze that the instruction “play Gunma's song” as an instruction to play a favorite song of the friend of the user A. On the basis of this analysis result, the generation unit 140A (recommendation information generation unit 142 thereof) refers to the knowledge DB 111A and reads out the playlist of Gunma's favorite songs.

Of course, the switching timing of the DB switching unit 302 may be a timing other than the above, and the example described above is an example and is not a description indicating limitation.

<Fifth Method of Diverting Database of Another User>

As a fifth method of diverting a database of another user, a case of integrating the recommendation DB 112 of oneself and the recommendation DB 112 of another user will be described.

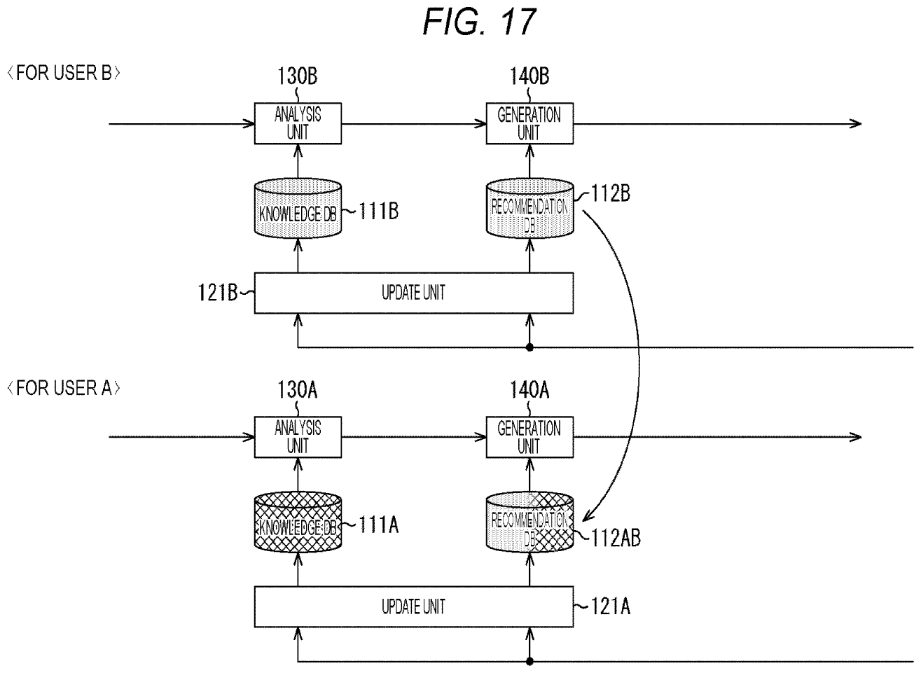

FIG. 17 is a diagram for describing the fifth diverting method. The recommendation DB 112A for the user A and the recommendation DB 112B for the user B are integrated to generate a recommendation DB 112AB for the user A.

By performing such integration, information input by the user A by voice input or the like is analyzed by the analysis unit 130A by referring to the knowledge DB 111A constructed for the user A, and the recommendation DB 112AB obtained by integrating the recommendation DB 112A constructed for the user A and the recommendation DB 112B constructed for the user B is referred to by the generation unit 140A, to thereby generate information recommended to the user A.

In this manner, a recommendation referring to the recommendation DB 112AB in which different databases are integrated is made to the user A. Thus, a recommendation according to the respective tastes and lifestyles of the user A and the user B is made to the user A.

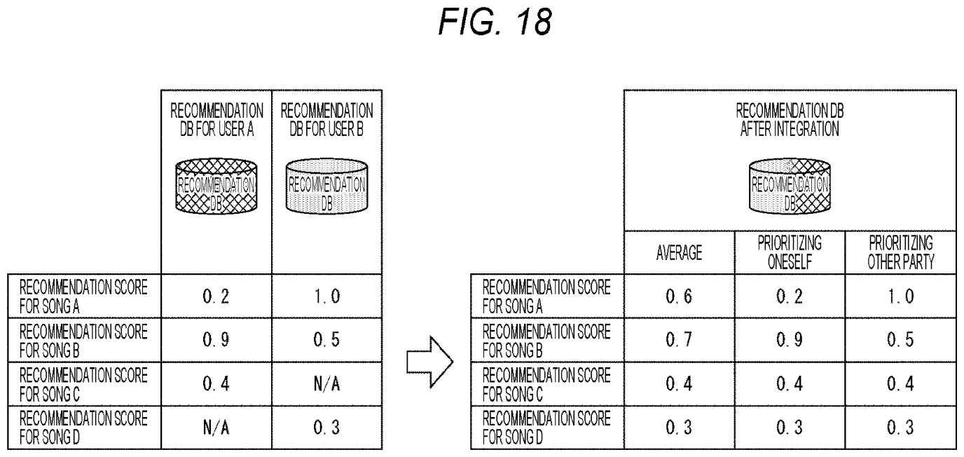

The integration of databases is performed, for example, by a method described with reference to FIG. 18. As described above, the recommendation DB 112 records, for example, the playlist of songs, and recommendation scores are described in the playlist. Here, the description will be continued by taking a case of integrating the recommendation scores as an example.

A diagram on the left of FIG. 18 illustrates an example of recommendation scores recorded respectively in the recommendation DB 112A and the recommendation DB 112B before integration. A diagram on the right of FIG. 18 illustrates an example of recommendation scores recorded in the recommendation DB 112AB after integration.

The recommendation score for a song A is “0.2”, the recommendation score for a song B is “0.9”, the recommendation score for a song C is “0.4”, and the recommendation score for a song D is “N/A (not applicable)” in the recommendation DB 112A of the user A before integration. The recommendation score for a song A is “1.0”, the recommendation score for a song B is “0.5”, the recommendation score for a song C is “N/A”, and the recommendation score for a song D is “0.3” in the recommendation DB 112B of the user B before integration.

In a case of integrating these recommendation scores, there is a method using average values of recommendation scores as a recommendation scores after integration. Reference will be made to values integrated by average values in the recommendation DB 112AB after integration illustrated in the right diagram of FIG. 18. First, the recommendation score for the song A is “0.6”, which is an average value of “0.2” and “1.0”. Similarly, the recommendation score for the song B is “0.7”, which is an average value of “0.9” and “0.5”.

The recommendation score for the song C is an average value of “0.4” and “N/A”, but it may be calculated with “N/A” as “0” and a value of “0.2” may be taken. Alternatively, in a case where there is “N/A”, the value on the side other than “N/A”, in this case “0.4”, may be reflected as it is. Here, the description will be continued by taking as an example a case where the value on a side other than “N/A” is reflected as it is.

The recommendation score for the song D is an average value of “N/A” and “0.3”, but “0.3” is used because “0.3”, which is the value on the side other than “N/A”, is reflected as it is.

In a case of using an average value as the score after integration in this manner, in a case where there are scores, an average value is calculated and this value is used as a score after integration, and in a case where there is no score on one side, the score on the other side is taken as it is as a score after integration.

The present technology can be applied in a case of integrating two recommendation DBs 112, but the present technology can also be applied in a case of integrating two or more recommendation DBs 112. In a case of integrating a plurality of recommendation DBs 112, an average value is calculated only for scores other than N/A among the scores associated with a predetermined song. Furthermore, in a case where there is only one score other than N/A among the scores associated with the predetermined song, this score is used as it is.

As another method of integrating recommendation scores, there is a method prioritizing scores of oneself. In this case, the user A is oneself and the user B is the other party. In a case where, regarding the predetermined song, the recommendation DB 112A constructed for oneself (user A) has a recommendation score and the recommendation DB 112B constructed for the other party (user B) has a recommendation score, the recommendation score written in the recommendation DB 112A constructed for oneself is used as a recommendation score after integration.

Furthermore, also in a case where, regarding the predetermined song, the recommendation DB 112A constructed for oneself (user A) has a recommendation score and the recommendation DB 112B constructed for the other party (user B) has no recommendation score, the recommendation score written in the recommendation DB 112A constructed for oneself is used as a recommendation score after integration. Furthermore, in a case where, regarding the predetermined song, the recommendation DB 112A constructed for oneself (user A) has no recommendation score and the recommendation DB 112B constructed for the other party (user B) has a recommendation score, the recommendation score written in the recommendation DB 112B constructed for the other party is used as a recommendation score after integration.

Reference will be made to values integrated by prioritizing oneself in the recommendation DB 112AB after integration illustrated in the right diagram of FIG. 18. First, regarding the song A, both the recommendation DB 112A of oneself and the recommendation DB 112B of the other party have scores, and thus the recommendation score “0.2” written in the recommendation DB 112A of oneself is taken as a recommendation score after integration. Similarly, the recommendation score for song B is “0.9”.

For the recommendation score for the song C, a score “0.4” is written in the recommendation DB 112A of oneself, and since there is no corresponding score in the recommendation DB 112B of the other party, the score of “0.4” is taken as a recommendation score after integration. For the recommendation score for the song D, there is no corresponding score in the recommendation DB 112A of oneself, and since a score “0.3” is written in the recommendation DB 112B of the other party, the score “0.3” is taken as a recommendation score after integration.

In this manner, the score described in the recommendation DB 112A of oneself may be preferentially used as a score after integration. In this case, the recommendation DB 112AB that is close to the tastes and lifestyle of oneself is constructed. Furthermore, the recommendation DB 112AB is constructed in which the tastes and lifestyle of the other party (user B), which are not in the tastes and lifestyle of oneself, are added.

The present technology can be applied in a case of integrating two recommendation DBs 112, but the present technology can also be applied in a case of integrating two or more recommendation DBs 112. In a case of integrating a plurality of recommendation DBs 112, in a case where a score is written in the recommendation DB 112 for oneself among the scores associated with the predetermined song, this score is taken as a recommendation score after integration, and in a case where no score is written in the recommendation DB 112 for oneself among the scores associated with the predetermined song, a score written in the recommendation DB 112 for the another user is taken as a recommendation score.

As still another method of integrating recommendation scores, there is a method prioritizing scores of the other party. In a case where, regarding the predetermined song, the recommendation DB 112A constructed for oneself (user A) has a recommendation score and the recommendation DB 112B constructed for the other party (user B) has a recommendation score, the recommendation score written in the recommendation DB 112B constructed for the other party is used as a recommendation score after integration.

Furthermore, in a case where, regarding the predetermined song, the recommendation DB 112A constructed for oneself (user A) has a recommendation score and the recommendation DB 112B constructed for the other party (user B) has no recommendation score, the recommendation score written in the recommendation DB 112A constructed for oneself is used as a recommendation score after integration. Furthermore, in a case where, regarding the predetermined song, the recommendation DB 112A constructed for oneself (user A) has no recommendation score and the recommendation DB 112B constructed for the other party (user B) has a recommendation score, the recommendation score written in the recommendation DB 112B constructed for the other party is used as a recommendation score after integration.

Reference will be made to values integrated by prioritizing the other party in the recommendation DB 112AB after integration illustrated in the right diagram of FIG. 18. First, regarding the song A, since both the recommendation DB 112A of oneself and the recommendation

DB 112B of the other party have scores, the recommendation score “1.0” written in the recommendation DB 112B of the other party is taken as a recommendation score after integration. Similarly, the recommendation score for song B is “0.5”.

For the recommendation score for the song C, a score “0.4” is written in the recommendation DB 112A of oneself, and since there is no corresponding score in the recommendation DB 112B of the other party, the score of “0.4” is taken as a recommendation score after integration. For the recommendation score for the song D, there is no corresponding score in the recommendation DB 112A of oneself, and since a score “0.3” is written in the recommendation DB 112B of the other party, the score “0.3” is taken as a recommendation score after integration.

In this manner, the score described in the recommendation DB 112A of the other party may be preferentially used as a score after integration. In this case, the recommendation DB 112AB that is close to the tastes and lifestyle of the other party is constructed. Furthermore, the recommendation DB 112AB is constructed in which the tastes and lifestyle of oneself, which are not in the tastes and lifestyle of the other party (user B), remain.

The present technology can be applied in a case of integrating two recommendation DBs 112, but the present technology can also be applied in a case of integrating two or more recommendation DBs 112. In a case of integrating a plurality of recommendation DBs 112, in a case where a score is written in the recommendation DB 112 for the other party among the scores associated with the predetermined song, this score is taken as a recommendation score after integration, and in a case where no score is written in the recommendation DB 112 for the other party among the scores associated with the predetermined song, a score written in the recommendation DB 112 for oneself is taken as a recommendation score after integration.

As still another method of integrating recommendation scores, which is not illustrated, a higher score may be selected. Furthermore, a lower score may be selected. Moreover, information that is not described in the recommendation DB 112 of oneself, for example, information in which “N/A” is described as a score in FIG. 18 may not be described in the recommendation DB 112 after integration.

Moreover, integration may be performed on the basis of another calculation method not exemplified here or other rules.

<Sixth Method of Diverting Database of Another User>

As a sixth method of diverting a database of another user, a case of integrating the knowledge DB 111 of oneself and the knowledge DB 111 of another user will be described.

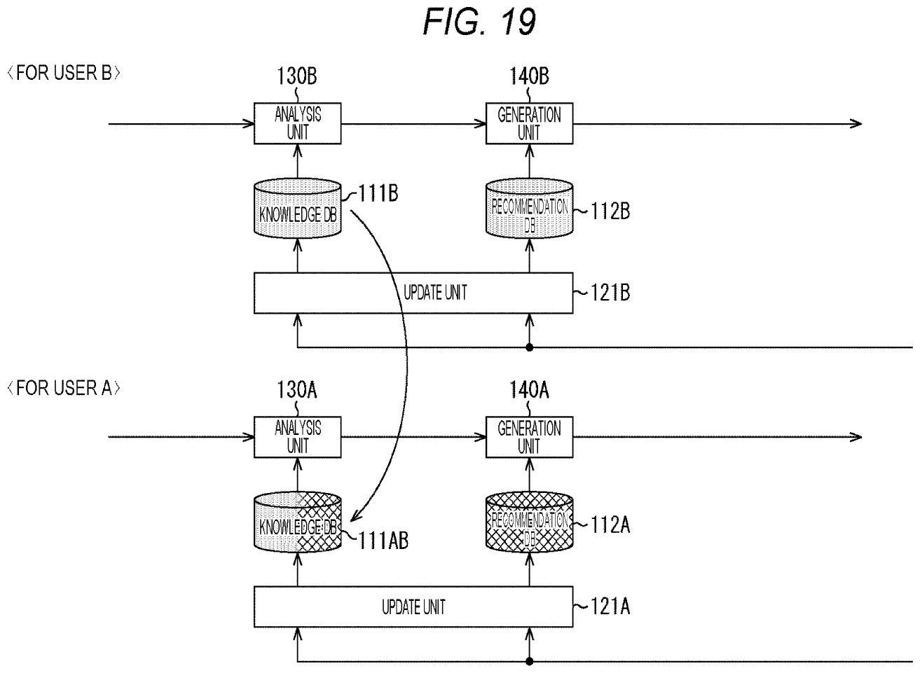

FIG. 19 is a diagram for describing the sixth diverting method. The knowledge DB 111A for the user A and the knowledge DB 111B for the user B are integrated to generate a knowledge DB 111AB for the user A.

By performing such integration, information input by the user A by voice input or the like is analyzed by the analysis unit 130A by referring to the knowledge DB 111AB obtained by integrating the knowledge DB 111A constructed for the user A and the knowledge DB 111B constructed for the user B, and the knowledge DB 111A constructed for the user A is referred to by the generation unit 140A, to thereby generate information recommended to the user A.

In this manner, a semantic analysis referring to the knowledge DB 111AB in which different databases are integrated is performed, and a recommendation based on an analysis result is made to the user A. Thus, a recommendation according to the respective tastes and lifestyles of the user A and the user B is made to the user A.

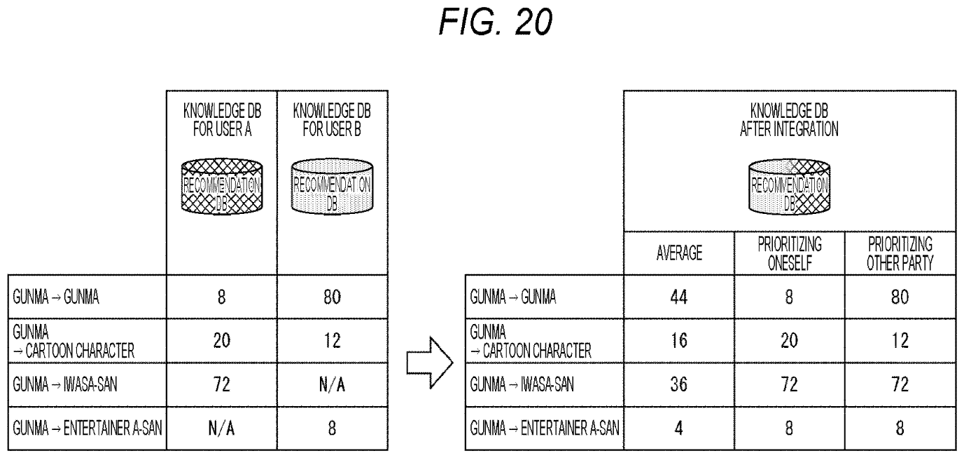

The integration of databases is performed, for example, by a method described with reference to FIG. 20. As described above, the knowledge DB 111 records, for example, appearance probability values of a predetermined word. Here, the description will be continued by taking a case of integrating the probability values as an example.

A diagram on the left of FIG. 20 illustrates an example of probability values recorded in the knowledge DB 111A and the knowledge DB 111B before integration. A diagram on the right of FIG. 20 illustrates an example of probability value recorded in the knowledge DB 111AB after integration.

A probability value of “Gunma→Gunma” is “8%”, a probability value of “Gunma→comic character” is “20%”, a probability value of “Gunma→Iwasa-san” is “72%”, and a probability value of “Gunma→entertainer A-san” is “N/A (not applicable)” in the knowledge DB 111A of the user A before integration. A probability value of “Gunma→Gunma” is “80%”, a probability value of “Gunma→comic character” is “12%”, a probability value of “Gunma→Iwasa-san” is “N/A”, and a probability value of “Gunma→entertainer A-san” is “8%” in the knowledge DB 111B of the user B before integration.

In a case of integrating these probability values, there is a method using an average value of probability values as probability values after integration. Reference will be made to values integrated by average values in the knowledge DB 111AB after integration illustrated in the right diagram of FIG. 20. First, the probability value of “Gunma→Gunma” is “44”, which is an average value of “8” and “80”. Similarly, the probability value of “Gunma→comic character” is “16”, which is an average value of “20” and “12”.

The probability value of “Gunma→Iwasa-san” is an average value of “72” and “N/A”, but “N/A” is calculated as “0” and “36” is taken. The probability value of “Gunma→entertainer A-san” is “4”, which is an average value of “N/A” and “8”.

In this manner, an average value of probability values is calculated, and this value is used as a probability value after integration.

The present technology can be applied in a case of integrating two knowledge DBs 111, but the present technology can also be applied in a case of integrating two or more knowledge DBs 111. In a case of integrating a plurality of knowledge DBs 111, the average value of the probability values associated with predetermined information is taken as a probability value after integration.

As another method of integrating probability values, there is a method prioritizing probability values of oneself. In this case, the user A is oneself and the user B is the other party. In a case where, for predetermined information, the knowledge DB 111A constructed for oneself (user A) has a probability value and the knowledge DB 111B constructed for the other party (user B) has a probability value, the probability value written in the knowledge DB 111A constructed for oneself is used as a probability value after integration.

Furthermore, also in a case where, regarding the predetermined information, the knowledge DB 111A constructed for oneself (user A) has a probability value and the knowledge DB 111B constructed for the other party (user B) has no probability value, the probability value written in the knowledge DB 111A constructed for oneself is used as a probability value after integration. Furthermore, in a case where, regarding the predetermined information, the knowledge DB 111A constructed for oneself (user A) has no probability value and the knowledge DB 111B constructed for the other party (user B) has a probability value, the probability value written in the knowledge DB 111B constructed for the other party is used as a probability value after integration.

Reference will be made to values integrated by prioritizing oneself in the knowledge DB 111AB after integration illustrated in the right diagram of FIG. 20. First, regarding “Gunma→Gunma”, since both the knowledge DB 111A of oneself and the knowledge DB 111B of the other party have probability values, a probability value “8” written in the knowledge DB 111A of oneself is taken as a probability value after integration. Similarly, the probability value of “Gunma→comic character” is “20”.

For the probability value of “Gunma→Iwasa-san”, a probability value of “72” is written in the knowledge DB 111A of oneself, but since there is no corresponding probability value in the knowledge DB 111B of the other party, the probability value of “72” is taken as a probability value after integration. For the probability value of “Gunma→entertainer A-san”, there is no corresponding probability value in the knowledge DB 111A of oneself and a probability value of “8” is written in the knowledge DB 111B of the other party, the probability value of “8” is taken as a probability value after integration.

In this manner, a probability value described in the knowledge DB 111A of oneself may be preferentially used as a probability value after integration. In this case, the knowledge DB 111AB close to the tastes and lifestyle of oneself is constructed. Furthermore, the knowledge DB 111AB is constructed in which the tastes and lifestyle of the other party (user B), which are not in the tastes and lifestyle of oneself, are added.

Note that in the example illustrated in FIG. 20, in a case where the probability values of “Gunma→Gunma”, “Gunma→comic character”, “Gunma→Iwasa-san”, and “Gunma→entertainer A-san” are added, “108” (=8+20+72+8). Each value may be adjusted so that the added probability value becomes 100(%).

The present technology can be applied in a case of integrating two knowledge DBs 111, but the present technology can also be applied in a case of integrating two or more knowledge DBs 111. In a case of integrating a plurality of knowledge DBs 111, in a case where a probability value is written in the knowledge DB 111 for oneself among the probability values associated with the predetermined information, this probability value is taken as a probability value after integration and in a case where no probability value is written in the knowledge DB 111 for oneself, a probability value written in the knowledge DB 111 for other user is taken as a probability value.

As still another method of integrating probability values, there is a method prioritizing probability values of the other party. In a case where, regarding the predetermined information the knowledge DB 111A constructed for oneself (user A) has a probability value and the knowledge DB 111B constructed for the other party (user B) has a probability value, the probability value written in the knowledge DB 111B constructed for the other party is used as a probability value after integration.

Furthermore, in a case where, regarding the predetermined information, the knowledge DB 111A constructed for oneself (user A) has a probability value and the knowledge DB 111B constructed for the other party (user B) has no probability value, the probability value written in the knowledge DB 111A constructed for oneself is used as a probability value after integration. Furthermore, in a case where, regarding the predetermined information, the knowledge DB 111A constructed for oneself (user A) has no probability value and the knowledge DB 111B constructed for the other party (user B) has a probability value, the probability value written in the knowledge DB 111B constructed for the other party is used as a probability value after integration.

Reference will be made to values integrated by prioritizing the other party in the knowledge DB 111AB after integration illustrated in the right diagram of FIG. 20. First, regarding “Gunma→Gunma”, since both the knowledge DB 111A of oneself and the knowledge DB 111B of the other party have probability values, a probability value “80” written in the knowledge DB 111B of the other party is taken as a probability value after integration. Similarly, the probability value of “Gunma→comic character” is “12”.

For the probability value of “Gunma→Iwasa-san”, a probability value of “72” is written in the knowledge DB 111A of oneself, but since there is no corresponding probability value in the knowledge DB 111B of the other party, the probability value of “72” is taken as a probability value after integration. For the probability value of “Gunma→entertainer A-san”, there is no corresponding probability value in the knowledge DB 111A of oneself and a probability value of “8” is written in the knowledge DB 111B of the other party, the probability value of “8” is taken as a probability value after integration.

In this manner, a probability value described in the knowledge DB 111A of the other party may be preferentially used as a probability value after integration. In this case, the knowledge DB 111AB that is close to the tastes and lifestyle of the other party is constructed. Furthermore, the knowledge DB 111AB is constructed in which the tastes and lifestyle of oneself, which are not in the tastes and lifestyle of the other party (user B), remain.

Note that in the example illustrated in FIG. 20, in a case where the probability values of “Gunma→Gunma”, “Gunma→comic character”, “Gunma→Iwasa-san”, and “Gunma—entertainer A-san” are added, “172” (=80+12+72+8). Each value may be adjusted so that the added probability value becomes 100(%).

The present technology can be applied in a case of integrating two knowledge DBs 111, but the present technology can also be applied in a case of integrating two or more knowledge DBs 111. In a case of integrating a plurality of knowledge DBs 111, in a case where a probability value is written in the knowledge DB 111 for the other party among the probability values associated with the predetermined information, this probability value is taken as a probability value after integration and in a case where no probability value is written in the knowledge DB 111 for the other party among the probability values associated with the predetermined information, a probability value written in the knowledge DB 111 for oneself is regarded as a probability value after integration.

As yet another method of integrating probability values, although not illustrated, a higher probability value may be selected. Furthermore, a lower probability value may be selected. Moreover, information not described in the knowledge DB 111 of oneself, for example, information in which “N/A” is described as a probability value in FIG. 20 may not be described in the integrated knowledge DB 111.

Moreover, integration may be performed on the basis of another calculation method not exemplified here or other rules.

### Configuration of Information Processing Device in Second Embodiment

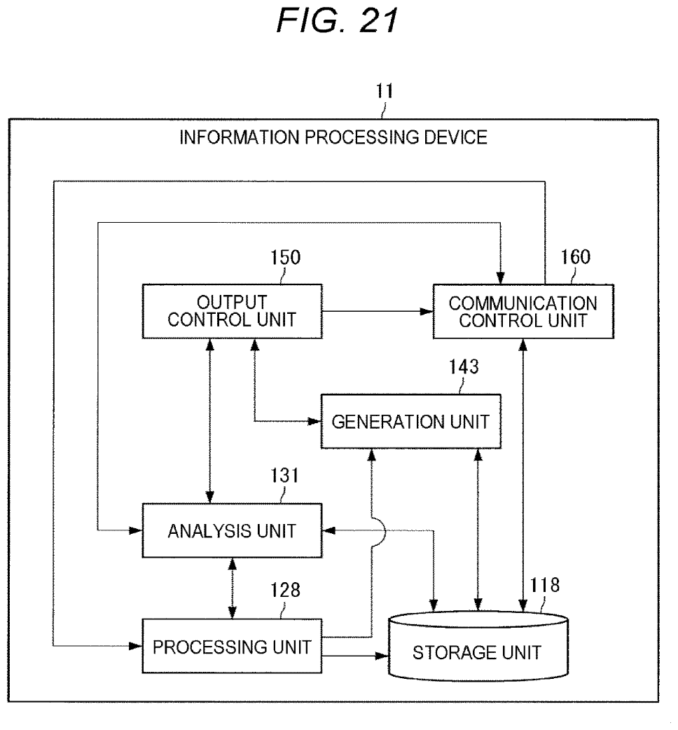

A configuration of the information processing device 11 according to the second embodiment will be described with reference to FIG. 21. FIG. 21 is a functional block diagram illustrating the configuration of the information processing device 11 according to the second embodiment. As illustrated in FIG. 21, the information processing device 11 includes a storage unit 118, a processing unit 128, an analysis unit 130, a generation unit 143, an output control unit 150, and a communication control unit 160. Hereinafter, the storage unit 118, the processing unit 128, and the generation unit 143, which are different from the functional units included in the information processing device 10 (FIG. 2) according to the first embodiment, will be described.

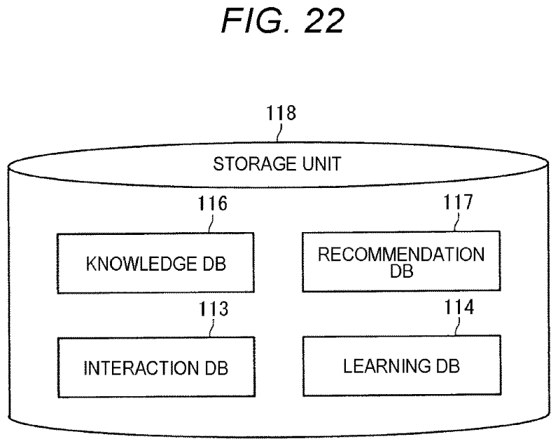

First, the storage unit 118 according to the second embodiment will be described with reference to FIG. 22. FIG. 22 is a functional block diagram illustrating a configuration of the storage unit 118 according to the second embodiment. The storage unit 118 according to the second embodiment includes a knowledge DB 116, a recommendation DB 117, an interaction DB 113, and a learning DB 114.

Furthermore, the knowledge DB 116 according to the second embodiment does not record data that stochastically represents the meanings and contents of words such as the knowledge DB 111 according to the first embodiment. Moreover, the recommendation DB 117 according to the second embodiment does not record the recommendation scores recorded in the recommendation DB 112 according to the first embodiment.

In the second embodiment, analysis of the meanings and contents of words or recommendation or the like to the user is performed on the basis of black box parameters (hereinafter, also simply referred to as “parameters”) possessed by an analysis unit 131 as described later and the generation unit 143. Thus, in the second embodiment, pieces of information recorded in the knowledge DB 116 and the recommendation DB 117 according to the second embodiment and the knowledge DB 111 and the recommendation DB 112 according to the first embodiment are different.

More specifically, the analysis unit 131 or the recommendation information generation unit 145 inputs an input value to a network in which an input layer including a plurality of inputs and an output layer including a plurality of outputs are connected by an intermediate layer including multiple layers, and outputs an output value related to an analysis result, recommendation information, or the like. Hereinafter, a parameter that defines a weight of a node in the network will be referred to as a “black box parameter”.

In the learning DB 114, the input value and the output value are recorded at an event in which learning data is recorded. The input value is, for example, various information necessary for obtaining an output value such as an instruction of the user, a user situation, and environmental information. The output value can be, for example, an index (for example, information such as a reaction of the user) for estimating how appropriate the analysis result or the like is. Recording of the learning data can be performed on the basis of an instruction by the user or automatically in the background by the information processing device 11.

In the present embodiment, each index of an event is recorded as data in the interaction DB 113. Moreover, the interaction DB 113 records label information (for example, information indicating an event occurrence time, content of input information or output information, and the like) for extracting learning data necessary for re-learning the algorithm recorded in the event. Thus, the learning data can be extracted from the learning DB 114 on the basis of the interaction DB 113.

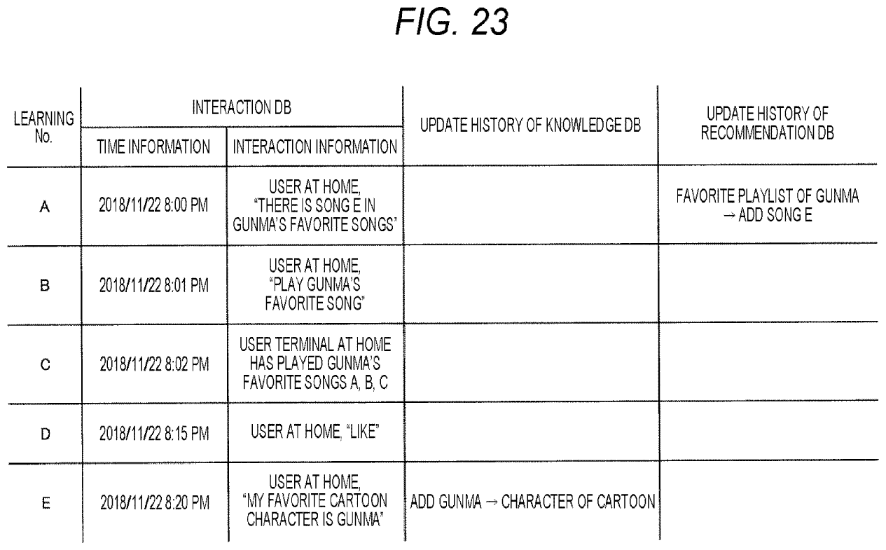

With reference to FIG. 23, the information stored in the storage unit 118 according to the second embodiment will be described focusing on differences from the information stored in the storage unit 110 according to the first embodiment. FIG. 23 is a diagram illustrating an example of information recorded in the interaction DB 113, the update history of the knowledge DB 116, and the update history of the recommendation DB 117 according to the second embodiment.

As illustrated in FIG. 23, the knowledge DB 116 and the recommendation DB 117 do not record information regarding the probability of meaning and content, information such as a recommendation score, and the like. Thus, as illustrated in FIG. 23, the update history of the meaning and content or the update history of the recommendation score as illustrated in FIG. 11, or the like is not stored in the storage unit 118 according to the second embodiment. Note that in the interaction DB 113 according to the second embodiment, information regarding the interaction is recorded as in the interaction DB 113 according to the first embodiment.

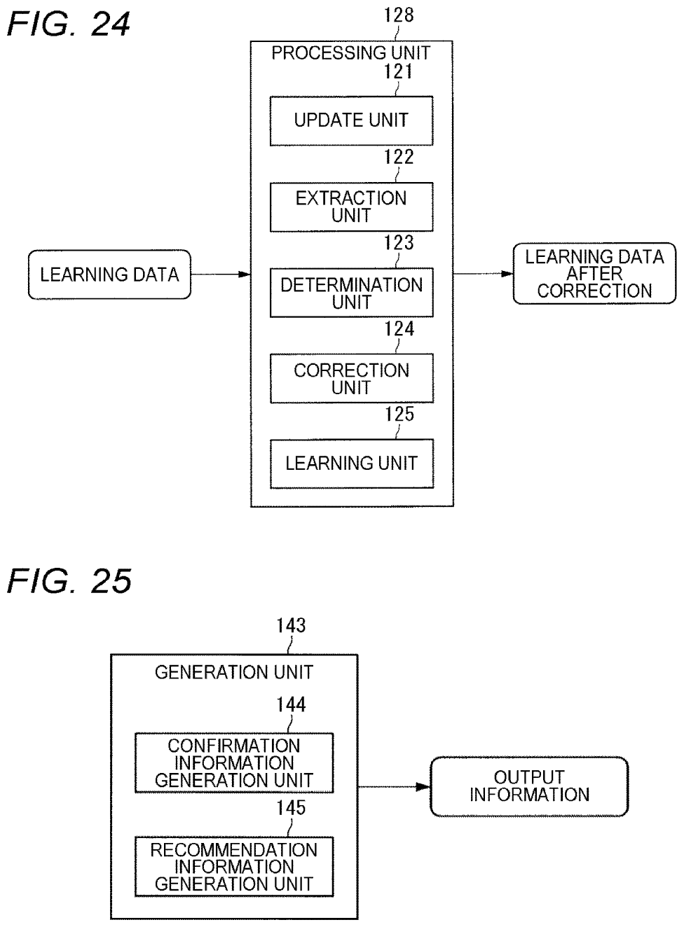

Next, the processing unit 128 according to the second embodiment will be described with reference to FIG. 24. FIG. 24 is a functional block diagram illustrating a configuration of the processing unit 128 according to the second embodiment. The processing unit 128 according to the second embodiment includes a learning unit 125 in addition to a functional unit included in the processing unit 120 according to the first embodiment.

The learning unit 125 has a function of performing learning (for example, reinforcement learning) of various parameters possessed by the analysis unit 131 or the generation unit 143. More specifically, the learning unit 125 learns parameters on the basis of interaction information recorded in the interaction DB 113, for example, on the basis of a technique such as reinforcement learning. Thus, the parameters are updated.

Here, the learning of parameters means optimizing a black box parameter according to accumulation of input values and output values (that is, learning data). Note that the learning unit 125 may learn the parameters when information regarding an interaction recorded in the interaction DB 113 is added, deleted, or corrected by the learning unit 125.

For learning, for example, various machine learning techniques using neural networks such as Recurrent Neural Network (RNN) and Convolutional Neural Network (CNN) may be used.

Upon acquiring the input information, the information processing device 11 according to the second embodiment generates output information on the basis of various parameters included in the analysis unit 131 or the generation unit 143. Thus, updating the parameters by the learning unit 125 corresponds to causing re-learning to be performed for the algorithm for generating the output information by the information processing device 11.

Next, the analysis unit 131 will be described. In the second embodiment, what correspondence between the input information and the output information is taken to result in obtaining a positive FB is learned as a black box parameter (semantic analysis parameter).

Unlike the analysis unit 130 according to the first embodiment, the analysis unit 131 according to the second embodiment uses the semantic analysis parameter instead of the form of probability for the correspondence between the input information and the meaning and content, to obtain an optimal response from the context or situation before and after. More specifically, in a case where voice information from the user is input, the analysis unit 131 outputs the meaning analysis result of the voice information on the basis of the semantic analysis parameter, for example, using the voice information as an input value.

Furthermore, the analysis unit 131 may output a semantic analysis result of the voice information by using various information (user status, characteristic information, environmental information, content of an instruction of a user, and the like) as an input value in addition to the voice. Here, the characteristic information of a user may be, for example, information regarding characteristics of the user, such as age, gender, or address. Furthermore, the environmental information may be information regarding a space in which the user exists, such as information regarding time, place, or person who is with the user.

For example, the analysis unit 131 may analyze that “Gunma” means a person named “Iwasa” when it has been talked about friendship until just before. Furthermore, in a case where the user is traveling to Gunma prefecture, it may be analyzed that “Gunma” means the prefecture name “Gunma”. In this manner, the content that has been talked about until just before may be reflected in the semantic analysis parameters. Furthermore, the contents of a location may be reflected in the semantic analysis parameters. In the present embodiment, the semantic analysis result output by the analysis unit 131 is used as an input value for the recommendation information generation unit 145, which will be described later, to generate the recommendation information.

Next, the generation unit 143 will be described with reference to FIG. 25. FIG. 25 is a functional block diagram illustrating a configuration of the generation unit 143 according to the second embodiment. The generation unit 143 illustrated in FIG. 25 includes a confirmation information generation unit 144 and a recommendation information generation unit 145, similarly to the generation unit 140 according to the first embodiment. As described above, the recommendation information generation unit 142 according to the first embodiment generates output information for recommending a song on the basis of, for example, a recommendation score for a song. On the other hand, in the second embodiment, it is learned as a black box parameter (recommendation parameter) which song recommended by recommendation information to be generated can result in obtaining a positive FB.

The recommendation information generation unit 145 generates optimal output information on the basis of the recommendation parameters, for example, on the basis of the context or situation before and after, and recommends music or the like to the user, for example. More specifically, the recommendation information generation unit 145 generates recommendation information as an output on the basis of the analysis result by the analysis unit 130, various information (user status, characteristic information, environmental information, content of an instruction of a user, and the like) and recommendation parameters.

In the present embodiment, as described above, the voice information and the above-described various information (user status, characteristic information, environmental information, content of an instruction of a user, and the like) are used for semantic analysis or generation of recommendation information. Thus, a machine learning technique capable of performing processing in consideration of a large number of conditions is suitable for processing that requires processing of recommendation or the like on the basis of various conditions as in the present embodiment.

For example, it may be preferable for the user to play a song similar to a song that has appeared in the conversation of the user until just before. At this time, for example, the recommendation parameter described above reflects the content of the song that has appeared in the conversation of the user until just before, and the recommendation information generation unit 145 can generate output information for playing a song similar to the song that the user has talked about until just before on the basis of the recommendation parameter.

Furthermore, in a case where a certain song has been played for the user before, it may be preferable for the user that the song is played again after, for example, one week or more has passed since the song has been played. At this time, for example, the recommendation parameter reflects information regarding a previously recommended song, and the recommendation information generation unit 145 can generate output information to recommend the song in a case where one week or more has passed since the previously recommended song has been played.

### Processing Example

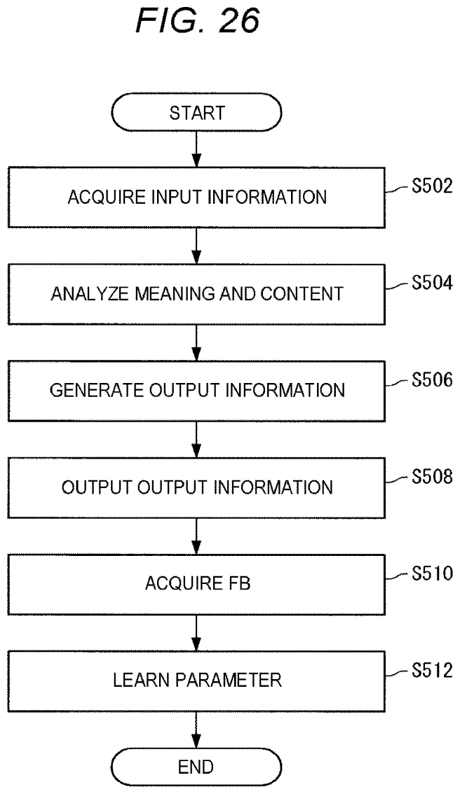

First, with reference to FIG. 26, parameter update processing, which is processing in which the information processing device 11 updates the black box parameters (semantic analysis parameters and recommendation parameters), will be described. FIG. 26 is a flowchart illustrating an example of the parameter update processing according to the second embodiment.

The information processing device 11 acquires the input information (step S502). The information processing device 11 receives, for example, the information input to the user terminal 20 via the network 30. The received input information is transmitted to the analysis unit 131 via the communication control unit 160.

The analysis unit 131 analyzes meaning and content of the input information (step S504). More specifically, the analysis unit 131 analyzes meaning and content of the input information on the basis of the semantic analysis parameters stored in the storage unit 118. An analysis result is transmitted to the generation unit 143.

The generation unit 143 generates output information (step S506). More specifically, the recommendation information generation unit 145 generates output information for making various recommendations to the user on the basis of the analysis result and the recommendation parameters stored in the storage unit 118. The output information is transmitted to the output control unit 150.

The output control unit 150 causes the output information to be output (step S508). More specifically, the output control unit 150 transmits the output information to the communication control unit 160. The output information is transmitted to, for example, the user terminal 20 connected to the network 30. Accordingly, the user terminal 20 outputs the output information. For example, the user terminal 20 outputs a voice that recommends a predetermined song to the user.

The information processing device 11 acquires a FB (feedback) (step S510). For example, the information processing device 11 acquires a response to the output result from the user as an FB. The acquired FB is transmitted to the processing unit 128.

Next, the processing unit 128 learns the semantic analysis parameter and the recommendation parameter (step S512). Specifically, the learning unit 125 learns the semantic analysis parameters and the recommendation parameters stored in the storage unit 118 on the basis of the FB from the user. Accordingly, the semantic analysis parameters and the recommendation parameters are updated. When these parameters are updated, the parameter update processing ends.

The parameter update processing has been described above with reference to FIG. 26. In this manner, various parameters for the information processing device 11 to generate output information are updated on the basis of, for example, the FB by the user or the like, so that the information processing device 11 can further generate the output information desired by the user.

As described above, the semantic analysis parameters and the recommendation parameters are learned (updated) on the basis of the FB from the user. Thus, the knowledge DB 116 and the recommendation DB 117 that accumulate the semantic analysis parameters and the recommendation parameters generated by interaction with the user become a database suitable for the user. The database suitable for the user is, for example, a database that reflects tastes and lifestyle of the user.

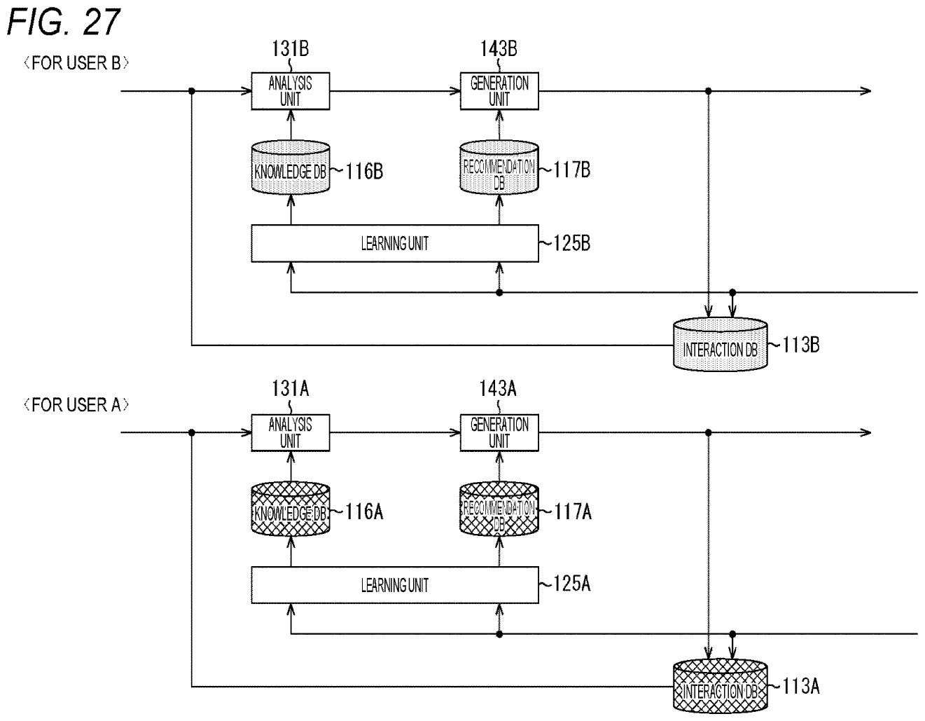

For example, a situation illustrated in FIG. 27 is assumed. By performing the processing as described above, the knowledge DB 116A and the recommendation DB 117A are constructed for the user A. Furthermore, by performing the processing as described above, the knowledge DB 116B and the recommendation DB 117B are constructed for the user B.

The knowledge DB 116A and the recommendation DB 117A of the user A are constructed by being updated by the learning unit 125A on the basis of a feedback from the user A. Furthermore, the feedback is a reaction of the user A to information that is generated by analyzing information input from the user A, for example, by voice input by the analysis unit 131A with reference to the knowledge DB 116A, and generating the information with reference to the recommendation DB 117A by the generation unit 143A.

The knowledge DB 116A and the recommendation DB 117A of the user A constructed in this manner are databases that reflect the tastes and lifestyle of the user A. Furthermore, information recommended by using such a database can be information suitable for the user A.

Similarly, the knowledge DB 116B and the recommendation DB 117B of the user B are constructed by being updated by the learning unit 125B on the basis of the feedback from the user B. Furthermore, the feedback is a reaction of the user B to information that is generated by analyzing information input from the user B, for example, by voice input by the analysis unit 131B with reference to the knowledge DB 116B, and generating the information by the generation unit 143B with reference to the recommendation DB 117B.

The knowledge DB 116B and recommendation DB 117B of the user B constructed in this manner are databases that reflect the tastes and lifestyle of the user B. Furthermore, information recommended by using such databases can be information suitable for the user B. Such point is similar to the case described with reference to FIG. 12 in the first embodiment.

As described with reference to FIG. 12, also in the second embodiment, in a case where the user B is a person longing for or a target person for the user A, the user A may wish to obtain various information such as what such a celebrity is interested in and when and what the celebrity does.

In such a case, it is assumed that it is desired to use the knowledge DB 116 or the recommendation DB 117 learned by another user. Accordingly, a description will be added below for a case where the knowledge DB 116 and the recommendation DB 117 learned by another user can be used as the knowledge DB 116 and the recommendation DB 117 of oneself.

In the following description, as described with reference to FIG. 27, a case where the knowledge DB 116A and the recommendation DB 117A are constructed as the database for the user A and the knowledge DB 116B and the recommendation DB 117B are constructed as the database for the user B, and the user A uses the database for the user B (the database for the user B is diverted as the database for the user A) will be described as an example.

<Seventh Method of Diverting Database of Another User>

As a seventh method of diverting a database of another user, a case of diverting a database of another user as a database of oneself by replacing the recommendation DB 117 of oneself with the recommendation DB 117 of another user will be described.

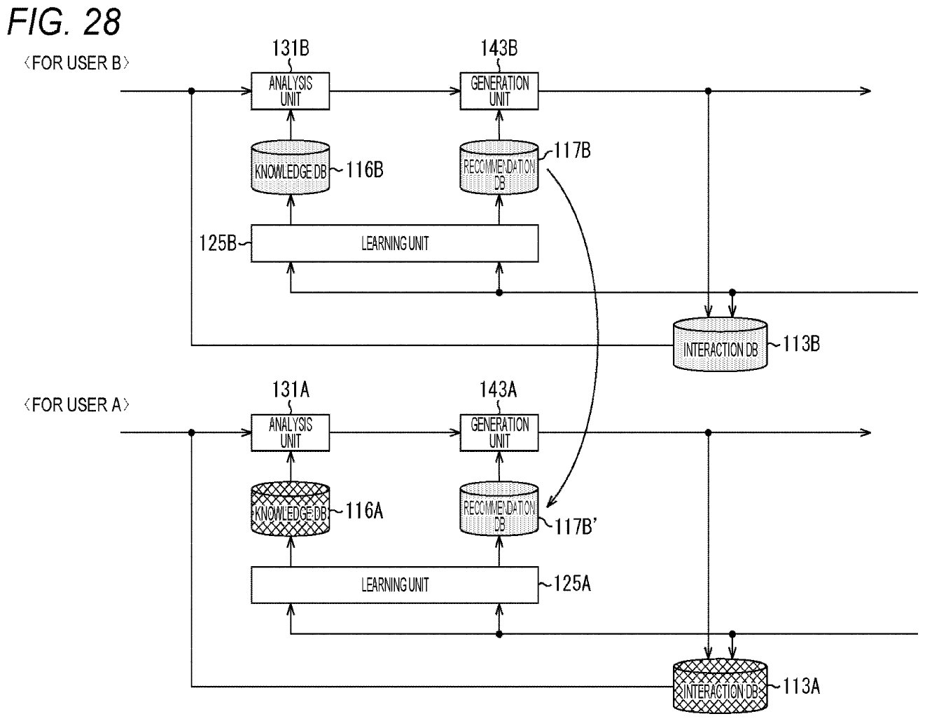

FIG. 28 is a diagram for describing the seventh diverting method. The recommendation DB 117A of the user A is replaced with the recommendation DB 117B for the user B. By the replacement, the user A can receive a recommendation referring to the recommendation DB 117B′ for the user B. Here, the replaced recommendation DB 117B is described with a prime to indicate that it has been replaced.

By performing such replacement, information input by the user A by voice input or the like is analyzed by the analysis unit 131A by referring to the knowledge DB 116A constructed for the user A, and the recommendation DB 117B′ constructed for the user B is referred to by the generation unit 143A, to thereby generate information recommended to the user A.

In this manner, the recommendation referring to the recommendation DB 117B′ constructed for the user B is made to the user A. Thus, a recommendation according to the tastes and lifestyle of the user B is made to the user A.

In this manner, after the recommendation DB 117A constructed for the user A is replaced with the recommendation DB 117B′ constructed for the user B, in a case where the user A says, for example, “play music”, the analysis unit 131A analyzes that an instruction to play music is given on the basis of the semantic analysis parameters accumulated in the knowledge DB 116A. The generation unit 143A (recommendation information generation unit 145 thereof) refers to the recommendation parameters accumulated in the recommendation DB 117B′, selects a song to be recommended to the user A based on the analysis result of the analysis unit 131A, and generates output information for playing the song.

In this case, since the recommendation parameter accumulated in the recommendation DB 117B′ is information generated on the basis of the tastes of the user B, a song that matches the tastes of the user B is presented to the user A.

Although no other example is given, as in the first diverting method, the recommendation DB 117A constructed for the user A is referred to, semantic analysis is performed, and the recommendation DB 117B′ constructed for the user B is referred to, to generate information to be recommended.

In a case where there is a feedback from the user A on the song recommended in this manner, the learning unit 125A learns (updates) the semantic analysis parameter and the recommendation parameter on the basis of the feedback.

Note that as described above, due to the processing of the learning unit 125A, there is a possibility that the recommendation DB 117B′ also becomes a database suitable for the tastes of the user A with passage of time (as the learning proceeds). In other words, there is a possibility that the recommendation DB 117B′ returns to a state close to the recommendation DB 117A before replacement. It may not be preferable for the user A to return to the recommendation DB 117A for the user A even though his or her recommendation DB 117A is replaced with the recommendation DB 117B′ of the user B by the intention of the user A.

Accordingly, in a case where such a database replacement is performed, some restrictions may be set on the learning (processing of updating the database) performed by the learning unit 125, so that the parameters accumulated in the database after replacement are not updated frequently. For example, there may be a restriction such that update is performed only when instructed (permitted) by the user, or update will not be performed for a predetermined period after replacement, for example, one week.

By replacing the recommendation DB 117 with the recommendation DB 117 of the user that is desired by the user in this manner, it becomes possible to receive a recommendation using the recommendation DB 117 after replacement.

<Eighth Method of Diverting Database of Another User>

As an eighth method of diverting a database of another user, a case where the knowledge DB 116 of oneself is replaced with the knowledge DB 116 of another user will be described.

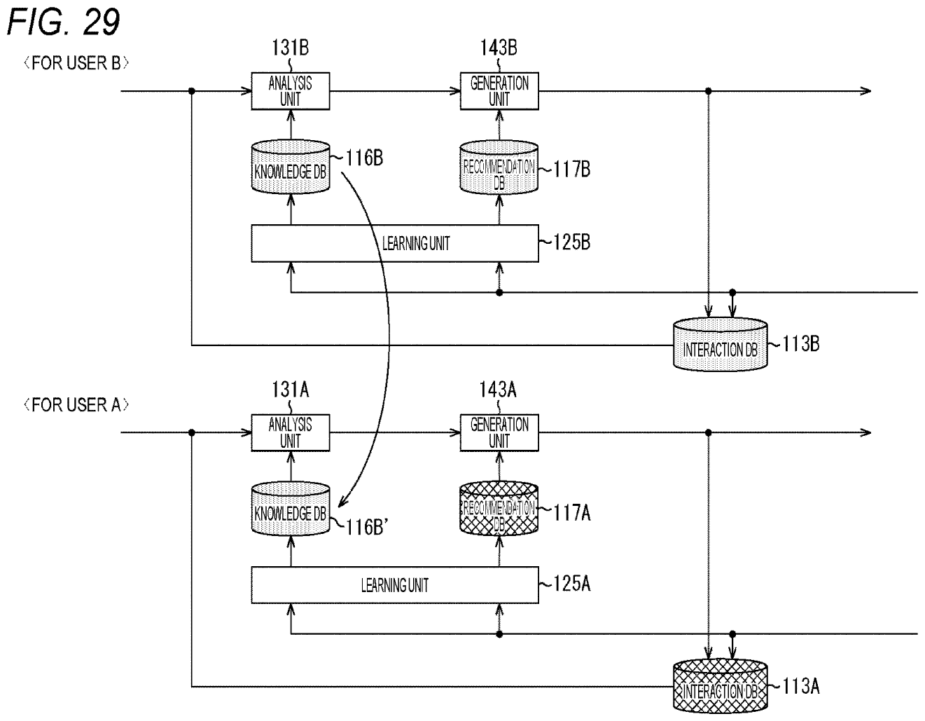

FIG. 29 is a diagram for describing the eighth diverting method. The knowledge DB 116A of the user A is replaced with the knowledge DB 116B for the user B. By the replacement, the user A can receive a recommendation using a result of semantic analysis by referring to the knowledge DB 116B′ for the user B. Here, the replaced knowledge DB 116B is described with a prime to indicate that it has been replaced.

By performing such replacement, information input by the user A by voice input or the like is analyzed by the analysis unit 131A by referring to the knowledge DB 116B′ constructed for the user B, and the recommendation DB 117A constructed for the user A is referred to by the generation unit 143A, to thereby generate information recommended to the user A.

In this manner, the semantic analysis with reference to the knowledge DB 116B′ constructed for the user B is performed for the user A. Thus, the semantic analysis is performed for the user A on the basis of the semantic analysis parameters obtained from the life and friendship of the user B, and the recommendation is made using a result of the semantic analysis.

For example, in a case where the user A says “play Gunma's song”, the analysis unit 131A performs a semantic analysis with reference to the knowledge DB 116B′. Since the knowledge DB 116A before replacement records a parameter that gives an output such as being a friend of the user A for the input “Gunma”, it is analyzed as an instruction to play a favorite song of a friend of the user A called “Gunma”, but since such a parameter is not recorded in the knowledge DB 116B′ after replacement, another analysis result is obtained. For example, a result that there is a contradiction in the instruction content, or an analysis result that the place name is Gunma and the instruction is to play the song of Gunma is given.

The generation unit 143A refers to the recommendation DB 117A and generates information regarding the song recommended to the user A on the basis of the analysis result and the recommendation parameter from the analysis unit 131A. For example, in response to a result that there is a contradiction in the instruction contents, a message such as “what is Gunma?” is generated, a song of Gunma is selected on the basis of an analysis result such as playing a Gunma's song, or “Gunma=Gunma” is assumed and Gunma's favorite song is selected.

Although no other example is given, as in the second diverting method, the knowledge DB 116B′ constructed for the user B is referred to, a semantic analysis is performed, and the recommendation DB 117A constructed for the user A is referred to, to generate Information to recommend.

In a case where there is a feedback from the user A on the song recommended in this manner, the learning unit 125A learns (updates) the semantic analysis parameter and the recommendation parameter on the basis of the feedback.

Note that as described above, due to the processing of the learning unit 125A, there is a possibility that the knowledge DB 116B′ also becomes a database suitable for the tastes of the user A with passage of time (as the learning proceeds). In other words, there is a possibility that the knowledge DB 116B′ returns to a state close to the knowledge DB 116A before the replacement. It may not be preferable for the user A to return to the knowledge DB 116A for the user A even though his or her knowledge DB 116A is replaced with the knowledge DB 116B′ of the user B by the intention of the user A.

Accordingly, in a case where such a database replacement is performed, some restrictions may be set on the learning (processing of updating the database) performed by the learning unit 125, so that the parameters accumulated in the database after replacement are not updated frequently. For example, there may be a restriction such that update is performed only when instructed (permitted) by the user, or update will not be performed for a predetermined period after replacement, for example, one week.

By replacing the knowledge DB 116 with the knowledge DB 116 of the user desired by the user in this manner, it is possible to provide a recommendation using the knowledge DB 116 after the replacement.

<Ninth Method of Diverting Database of Another User>

As a ninth method of diverting a database of another user, a case where the recommendation DB 117 of oneself and the recommendation DB 117 of another user are used together will be described.

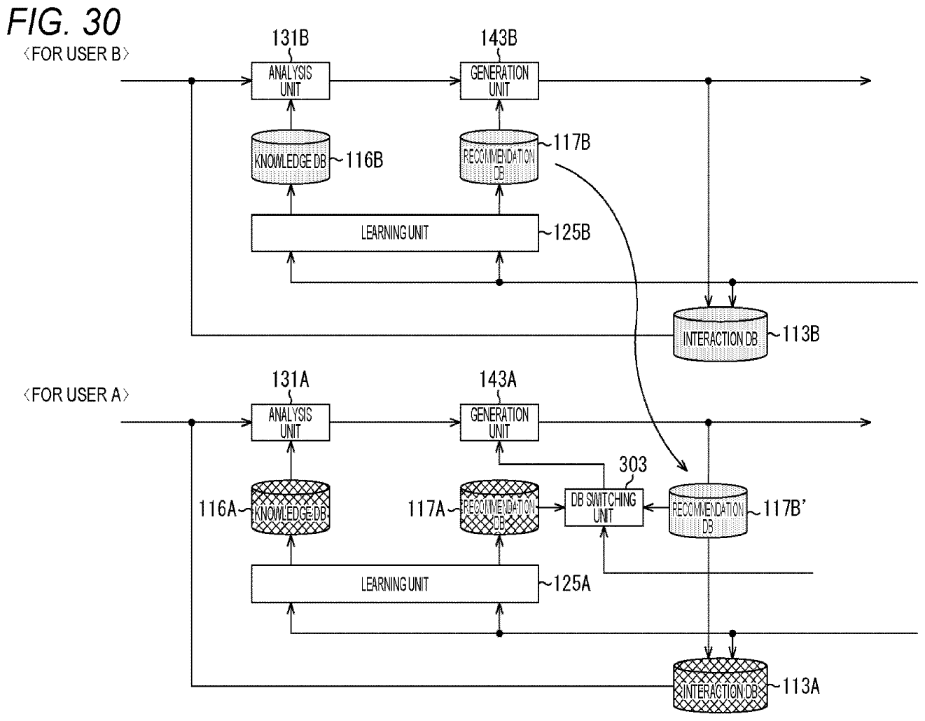

FIG. 30 is a diagram for describing the ninth diverting method. The recommendation DB 117B′ for the user B is added to the storage unit 118 (FIG. 22) of the information processing device 11 of the user A. By the addition, the storage unit 118 of the user A stores the recommendation DB 117A constructed for the user A and the recommendation DB 117B′ constructed for the user B. It is a configuration that a DB switching unit 303 is added so that either one database of the two recommendation DBs 117 can be referred to.

The DB switching unit 303 may be provided as a part of the function of the generation unit 143 or may be provided between the storage unit 118 and the generation unit 143 in the configuration of the information processing device 11 illustrated in FIG. 21.

The user A can receive a recommendation with reference to the recommendation DB 117B′ for the user B. A process in a case where the DB switching unit 303 switches the referred database to the recommendation DB 117B′ side is performed as described in the seventh diverting method described above. Thus, the information input by the user A by voice input or the like is analyzed by the analysis unit 131A by referring to the knowledge DB 116A constructed for the user A, and the recommendation DB 117B′ constructed for the user B is referred to by the generation unit 143A, to thereby generate information recommended to the user A.

Furthermore, as processing in a case where the DB switching unit 303 switches the referred database to the recommendation DB 117A side, the processing described with reference to the flowchart of FIG. 26 is performed. Thus, the information input by the user A by voice input or the like is analyzed by the analysis unit 131A by referring to the knowledge DB 116A constructed for the user A, and the recommendation DB 117A constructed for the user A is referred to by the generation unit 143A, to thereby generate information recommended to the user A.

In this manner, the recommendation referring to the recommendation DB 117A constructed for the user A or the recommendation referring to the recommendation DB 117B′ constructed for the user B is made to the user A. Thus, a recommendation according to the respective tastes and lifestyles of the user A and the user B is made to the user A.

The switching of the DB switching unit 303 can be made to be switched when the position of the user A changes significantly, for example, when going on a trip or when moving. For example, when the user A is traveling in the region B, it is switched to the recommendation DB 117B′ constructed for the user B living in the region B. Then, the recommended information is generated by referring to the recommendation DB 117B′. In this case, information closely related to the region B, such as a restaurant that the user B living in the region B uses on a daily basis and a play area that he or she often visits, can be recommended to the user A.

Although no other example is illustrated, the DB switching unit 303 may switch the database at the timing described in the third diverting method. Furthermore, the switching timing of the DB switching unit 303 may of course be a timing other than the above, and the example described above is an example and is not a description indicating limitation.

<Tenth Method of Diverting Database of Another User>

As a tenth method of diverting a database of another user, a case where the knowledge DB 116 of oneself and the knowledge DB 116 of another user are used together will be described.

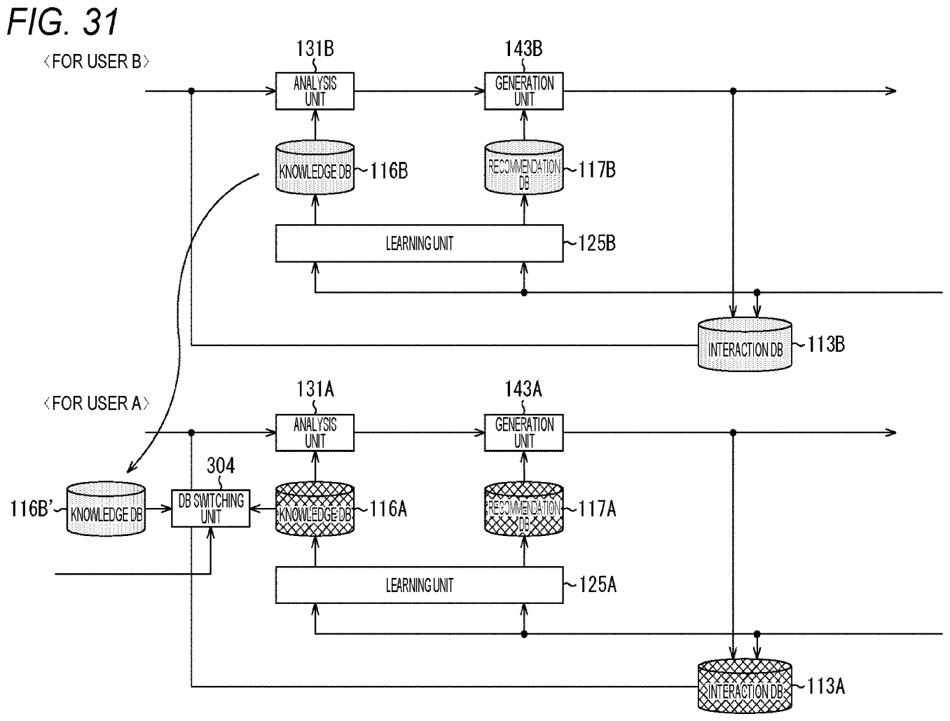

FIG. 31 is a diagram for describing the fourth diverting method. The knowledge DB 116B′ for the user B is added to the storage unit 118 (FIG. 22) of the information processing device 11 of the user A. By the addition, the knowledge DB 116A constructed for the user A and the knowledge DB 116B′ constructed for the user B are stored in the storage unit 118 of the user A. It is a configuration that a DB switching unit 304 is added so that either one database of the two knowledge DBs 116 can be switched and referred to.

The DB switching unit 304 may be provided as a part of the function of the generation unit 143 or may be provided between the storage unit 118 and the generation unit 143 in the configuration of the information processing device 11 illustrated in FIG. 21.

The user A can receive a recommendation based on an analysis result with reference to the knowledge DB 116B′ for the user B. A process in a case where the DB switching unit 304 switches the referred database to the knowledge DB 116B′ side is performed as described in the eighth diverting method described above. Thus, the information input by the user A by voice input or the like is analyzed by the analysis unit 131A by referring to the knowledge DB 116B′ constructed for the user B, and the recommendation DB 117A constructed for the user A is referred to by the generation unit 143A, to thereby generate information recommended to the user A.

Furthermore, as processing in a case where the DB switching unit 304 switches the referred database to the knowledge DB 116A side, the processing described with reference to the flowchart of FIG. 26 is performed. Thus, the information input by the user A by voice input or the like is analyzed by the analysis unit 131A by referring to the knowledge DB 116A constructed for the user A, and the recommendation DB 117A constructed for the user A is referred to by the generation unit 143A, to thereby generate information recommended to the user A.

In this manner, a semantic analysis referring to the knowledge DB 116A constructed for the user A or a semantic analysis referring to the knowledge DB 116B′ constructed for recommended user B is performed, and a recommendation using a result of the semantic analysis will be made to the user A. Thus, a recommendation according to the respective tastes and lifestyles of the user A and the user B is made to the user A.

The switching of the DB switching unit 304 can be made to be switched when the position of the user A changes significantly, for example, when going on a trip or when moving. For example, when the user A is traveling in the region B, it is switched to the knowledge DB 116B′ constructed for the user B living in the region B. Then, a semantic analysis may be performed by referring to the knowledge DB 116B′, and recommended information may be generated on the basis of an analysis result thereof.

In this case, since information such as a restaurant that the user B living in the region B uses on a daily basis and a play area that he or she often visits is recorded in the knowledge DB 116B′ (for example, because a parameter such as a store A when there is an input of meal is recorded), it becomes possible to perform a semantic analysis also suitable for information closely related to the region B, and make a recommendation based on the semantic analysis to the user A.

Although no other example is illustrated, the DB switching unit 304 may switch the database at the timing described in the fourth diverting method. Furthermore, the switching timing of the DB switching unit 304 may of course be a timing other than the above, and the example described above is an example and is not a description indicating limitation.

<Eleventh Method of Diverting Database of Another User>

As an eleventh method of diverting a database of another user, a case of integrating the recommendation DB 117 of oneself and the recommendation DB 117 of another user will be described.

A case of integrating the recommendation DB 117A constructed for the user A and the recommendation DB 117B constructed for the user B to build a recommendation DB 117AB will be considered. As described above, the recommendation DB 117 does not record the recommendation scores recorded in the recommendation DB 112 according to the first embodiment, but records the recommendation parameters.

For example, in a case of the recommendation score, as explained with reference to FIG. 18, a recommendation score after integration can be obtained by obtaining the average value of the recommendation scores. However, in each of the recommendation DB 117A and the recommendation DB 117B, recommendation parameters are recorded, and it is difficult to use the recorded recommendation parameters as they are, for example, to obtain an average value and use the average value as a parameter after integration. The parameters are learned (updated) by the learning unit 125 on the basis of the interaction information recorded in the interaction DB 113, for example, on the basis of a technique such as reinforcement learning.

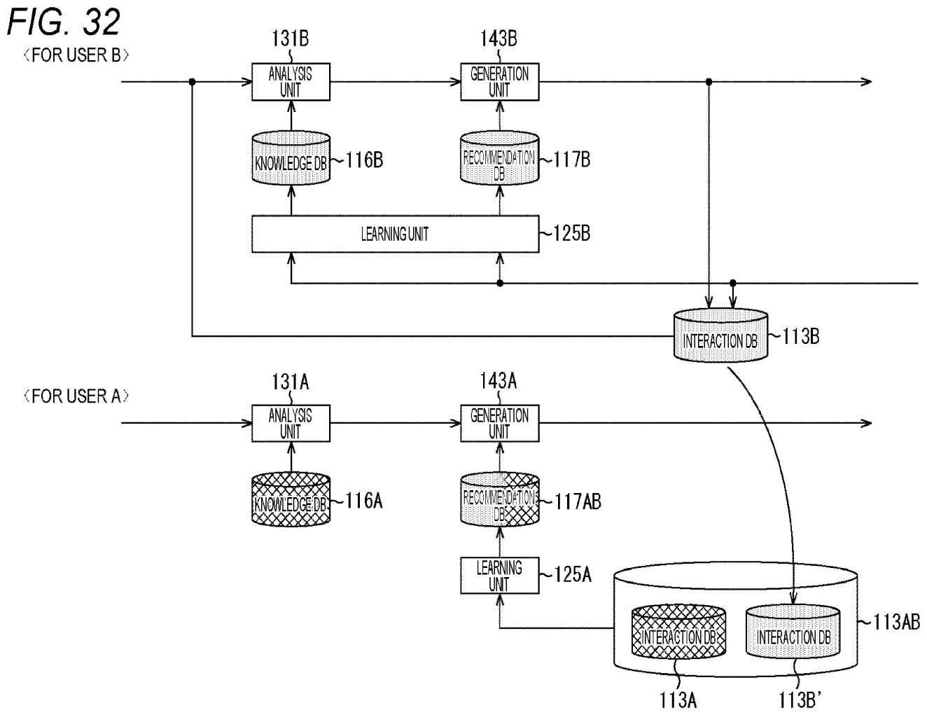

Accordingly, as illustrated in FIG. 32, in a case where the recommendation DB 117A constructed for the user A and the recommendation DB 117B constructed for the user B are integrated to construct the recommendation DB 117AB, first, the interaction DB 113A constructed for the user A, and the interaction DB 113B′ constructed for the user B are integrated. Then, the learning unit 125A performs re-learning on the basis of the interaction information recorded in the integrated interaction DB 113AB, so that the recommendation DB 117AB is constructed. The integration of the interaction DB 113 will be described later.

As described above, the interaction DB 113A accumulates input information from the user A and data regarding output information based on the algorithm for the input information. The recommendation DB 117A is constructed by learning by the learning unit 124A on the basis of the data accumulated in such an interaction DB 113A. This algorithm has been learned to be an algorithm suitable for the user A.

Furthermore, the interaction DB 113B accumulates data regarding input information from the user B and output information based on the algorithm for the input information. The recommendation DB 117B is constructed by learning by the learning unit 124B on the basis of the data accumulated in such an interaction DB 113B. This algorithm has been learned to be an algorithm suitable for the user B (an algorithm different from the algorithm suitable for the user A).

Such interaction DB 113A and interaction DB 113B are integrated, and re-learning is performed using the interaction DB 113AB after integration. In the example illustrated in FIG. 32, the learning unit 125A performs re-learning on the basis of the integrated interaction DB 113AB, and the recommendation DB 117AB is constructed. Consequently, the recommendation DB 117AB can be a database in which the recommendation DB 117A constructed for the user A and the recommendation DB 117B constructed for the user B are integrated.

In the descriptions above and below, it is assumed that the re-learning is performed by the learning unit 125, in other words, the re-learning is performed by the device on the user A side to continue the description, but the re-learning may be performed by a device other than the device on the user A side (information processing device 11). That is, the re-learning is performed by a device other than the information processing device 11, and a learning model after the re-learning can be supplied to the information processing device 11.

Furthermore, in a case where re-learning is performed by another information processing device, the interaction DB 113A and the interaction DB 113B are supplied (sent) to the other information processing device that performs the re-learning.

By integrating the interaction DB 113 and performing re-learning, information input by the user A by voice input or the like is analyzed by the analysis unit 131A by referring to the knowledge DB 116A constructed for the user A, and the recommendation DB 117AB obtained by integrating the recommendation DB 117A constructed for the user A and the recommendation DB 117B constructed for the user B is referred to by the generation unit 143A, to thereby generate the information recommended to the user A.

In this manner, a recommendation referring to the recommendation DB 117AB in which different databases are integrated is made to the user A. Thus, a recommendation according to the tastes and lifestyles of the user A and the user B is made to the user A.

The present technology can be applied in a case of integrating two recommendation DBs 117, but the present technology can also be applied in a case of integrating two or more recommendation DBs 117. In a case of integrating a plurality of recommendation DBs 117, the plurality of recommendation DBs 117 can be integrated by integrating a plurality of interaction DBs 113 by the integration method described later, and then performing re-learning by the learning unit 125.

<Twelfth Method of Diverting Database of Another User>

As a twelfth method of diverting a database of another user, a case of integrating the knowledge DB 116 of oneself and the knowledge DB 116 of another user will be described.

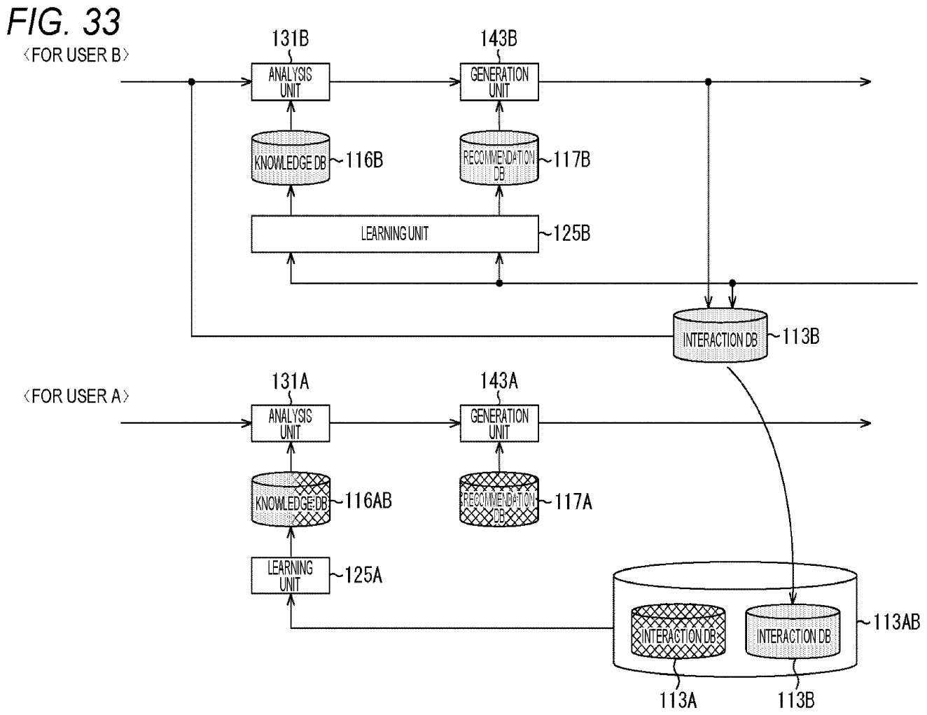

FIG. 33 is a diagram for describing a twelfth diverting method. A knowledge DB 116AB for the user A is constructed by integrating the knowledge DB 116A for the user A and the knowledge DB 116B for the user B. As in the eleventh diverting method described with reference to FIG. 32, first, the interaction DB 113A constructed for the user A and the interaction DB 113B′ constructed for the user B are integrated. Then, the knowledge DB 116AB is constructed by the learning unit 125A performing re-learning on the basis of the interaction information recorded in the integrated interaction DB 113AB. The integration of the interaction DB 113 will be described later.

By performing such integration, information input by the user A by voice input or the like is analyzed by the analysis unit 131A by referring to the knowledge DB 116AB obtained by integrating the knowledge DB 116A constructed for the user A and the knowledge DB 116B constructed for the user B, and the knowledge DB 116A constructed for the user A is referred to by the generation unit 143A, to thereby generate information recommended to the user A.

In this manner, a semantic analysis referring to the knowledge DB 116AB in which different databases are integrated is performed, and a recommendation based on an analysis result is made to the user A. Thus, a recommendation according to the tastes and lifestyles of the user A and the user B is made to the user A.

The present technology can be applied in a case of integrating two knowledge DBs 116, but the present technology can also be applied in a case of integrating two or more knowledge DBs 116. In a case of integrating a plurality of knowledge DBs 116, the plurality of knowledge DBs 116 can be integrated by integrating a plurality of interaction DBs 113 by the integration method described later, and then performing re-learning by the learning unit 125.

<Thirteenth Method of Diverting Database of Another User>

As a thirteenth method of diverting a database of another user, a case of integrating the knowledge DB 116 of oneself and the knowledge DB 116 of another user, and integrating the recommendation DB 117 of oneself and the recommendation DB 117 of another user will be described.

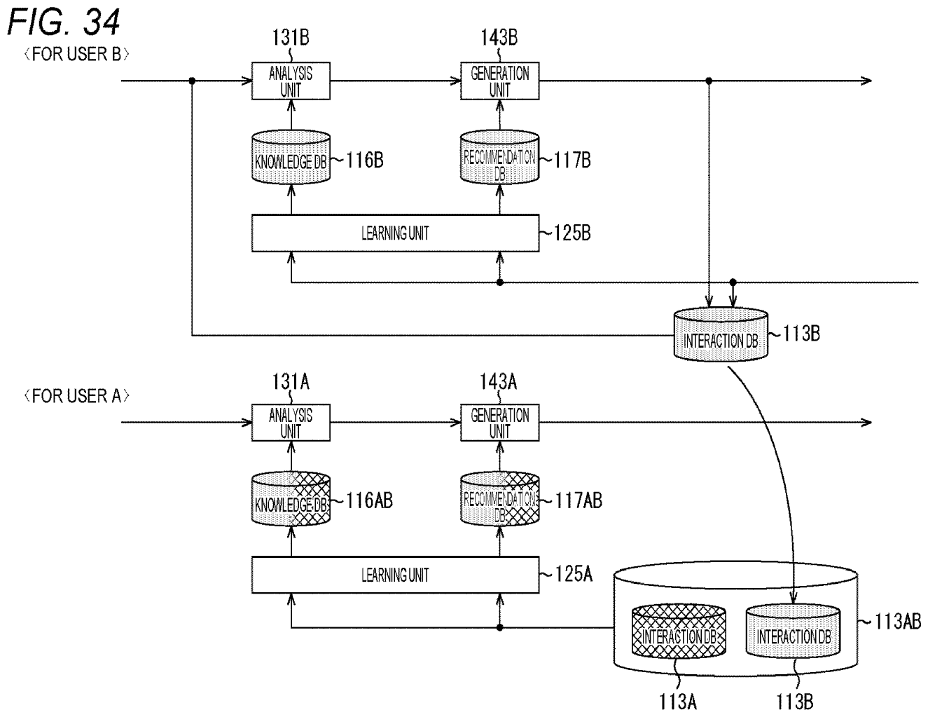

FIG. 34 is a diagram for describing the thirteenth diverting method. Similarly to the eleventh diverting method and the twelfth diverting method, first, the interaction DB 113A constructed for the user A and the interaction DB 113B′ constructed for the user B are integrated. The integration of the interaction DB 113 will be described later.

The knowledge DB 116AB is constructed by the learning unit 125A performing re-learning on the basis of the interaction information recorded in the integrated interaction DB 113AB. Furthermore, the recommendation DB 117AB is constructed by the learning unit 125A performing re-learning on the basis of the interaction information recorded in the integrated interaction DB 113AB.

By performing such integration, information input by the user A by voice input or the like is analyzed by the analysis unit 131A by referring to the knowledge DB 116AB obtained by integrating the knowledge DB 116A constructed for the user A and the knowledge DB 116B constructed for the user B, and the recommendation DB 117AB obtained by integrating the recommendation DB 117A constructed for the user A and the recommendation DB 117B constructed for the user B is referred to by the generation unit 143A, to thereby generate information recommended to the user A.

In this manner, a semantic analysis referring to the knowledge DB 116AB in which different databases are integrated is performed, and a recommendation based on an analysis results is made to the user A by referring to the recommendation DB 117AB in which different databases are integrated. Thus, a recommendation according to the tastes and lifestyles of the user A and the user B is made to the user A.

<Method of Integrating Interaction DBs>

In the eleventh to thirteenth diverting methods, when integrating the knowledge DB 116 and the recommendation DB 117, the interaction DB 113 is integrated. The integration of this interaction DB 113 will be described.

As described above, when the interaction DB 113A for the user A and the interaction DB 113B for the user B are integrated to construct the interaction DB 113AB, all the interaction information recorded in the interaction DB 113B for the user B may be used, or interaction information satisfying a predetermined condition may be extracted and the extracted interaction information may be used.

The predetermined condition for extracting the interaction information may be, for example, a condition such as a predetermined period or a condition such as a predetermined word. For example, in a case where the user B is a person who has passed the school where the user A takes the exam, and it is desired to extract information for passing from the interaction DB 113B for the user B, a period during which the user B has studied for the exam can be a predetermined period for which information is extracted.

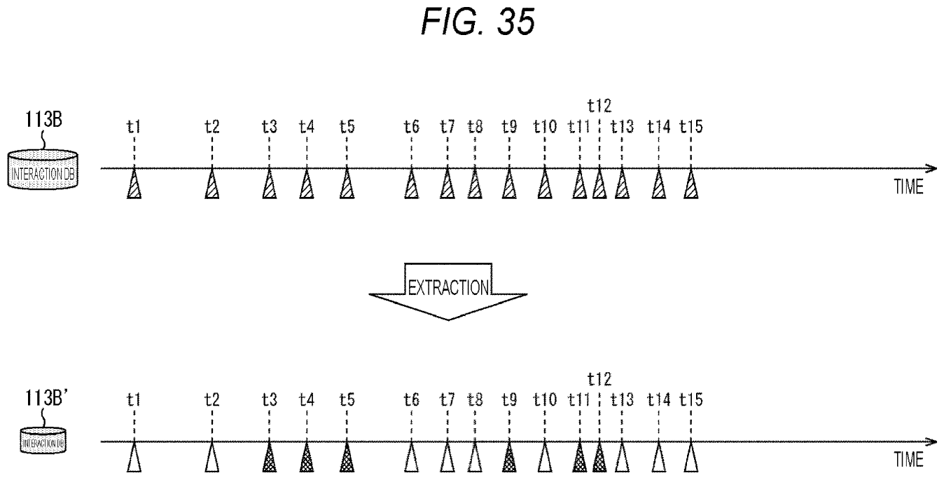

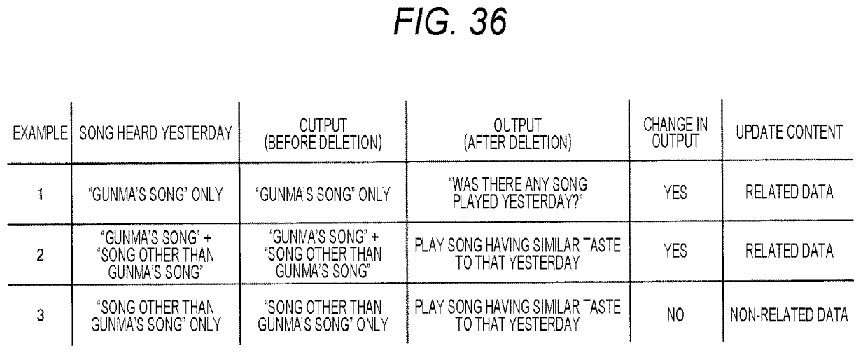

A case of extracting information meeting a predetermined condition from the interaction DB 113 will be described with reference to FIGS. 35 and 36. Here, a case of extracting information satisfying a predetermined condition from the interaction DB 113B for the user B and creating the interaction DB 113B′ will be described as an example.

An upper part of FIG. 35 illustrates a part of the interactions recorded in the interaction DB 113B, the horizontal axis is the time axis, and a history of the interaction between the user B and the information processing device 11 is illustrated. A lower part of FIG. 35 illustrates a part of the interactions extracted from the interaction DB 113B.

In the interaction DB 113B illustrated on the upper side of FIG. 35, times (t1 to t15) in which input information from the user B is input to the information processing device 11 and output information for the input information is output are lined up on the time axis in chronological order. Triangular markers with diagonal lines are illustrated at times when the input information and output information are input and output. The information processing device 11 causes learning to be performed for the algorithm on the basis of these interactions.

The record of the interaction recorded in the interaction DB 113B is extracted. For example, information regarding the interaction at times t3, t4, t5, t9, t11, and t12 corresponding to the triangular mark with the grid is extracted from the interaction DB 113B and recorded in the interaction DB 113B′.

The processing unit 120 searches for an interaction to be extracted on the basis of the interaction DB 113B, and extracts the interaction. More specifically, the extraction unit 122 searches the interactions (label information) recorded in the interaction DB 113B, for example, on the basis of the input from the user. For example, the extraction unit 122 can search the label information from the interaction DB 113B on the basis of a keyword such as “Gunma” described above, and extract learning data on the basis of the label information. The correction unit 124 extracts found learning data from the learning DB 114. Furthermore, the correction unit 124 may extract the searched label information and the like from the interaction DB 113.

Furthermore, the extraction unit 122 may extract learning data derivatively affected by the information regarding the interaction to be extracted from the learning DB 114. For example, in a case where the learning data is extracted on the basis of the keyword “Gunma”, the extraction unit 122 may extract the learning data corresponding to an event in which the output information changes before and after the extraction. The correction unit 124 may extract learning data related to the event.

The events extracted in this manner correspond to the interactions at the times t3, t4, t5, t9, t11, and t12 illustrated in FIG. 35.

A description regarding a case of extracting the learning data derivatively affected by the information regarding the interaction to be extracted from the learning DB 114 will be added.

The information processing device 11 extracts a keyword from the interaction DB 113, and extracts information included in the interaction DB 113 on the basis of the extraction result.

More specifically, the extraction unit 122 acquires a keyword for extraction and extracts the keyword from the interaction DB 113. Note that the keyword may be input to the user terminal 20 by an operation of the user, transmitted to the information processing device 11, and transmitted to the extraction unit 122, for example. Here, it is assumed that the word “Gunma” is transmitted to the extraction unit 122 as the keyword. The extraction unit 122 searches information including “Gunma” from the interaction DB 113, and extracts the learning data from the learning DB 114.

Next, the correction unit 124 extracts the learning data including “Gunma” recorded in the learning DB 114. The learning DB 114 extracts, for example, the learning data including “Gunma” such as “Gunma's favorite song is XX”, “Gunma is my friend Iwasa's nickname”, and “play Gunma's song” recorded in the correction unit 124.

In this manner, information regarding “Gunma” is extracted from the interaction DB 113. However, this alone may not be enough to extract all the information regarding “Gunma”.

For example, information that does not include the word “Gunma” cannot be found by the above extraction using the keyword “Gunma”. For example, it is assumed that the input information, “play a song having a similar taste to the song heard yesterday”, is input to the information processing device 11. In a case where the song heard yesterday is a Gunma's song, the recommendation parameters for a taste similar to that of the Gunma's song have been updated. In this case, the above input information that does not include the word “Gunma” directly affects the information in the recommendation DB 112.

Moreover, it is assumed that the input information, “play a song completely different from the song heard yesterday”, is input to the information processing device 11. In a case where the song heard yesterday is a Gunma's song, the recommendation parameter for a song having a completely different taste from that of the Gunma's song has been updated in the recommendation DB 117. That is, the input information that does not include the word “Gunma” indirectly affects the information of the recommendation DB 117. In this manner, an interaction that affects the information of the recommendation DB 117 is also extracted from the interaction DB 113.

As described above, it is conceivable that the user may want to extract the data related to the input information that does not include the information “Gunma” from the storage unit 118. Accordingly, as a method of extracting these related data, a method of storing information related to various data in advance in, for example, a storage unit 118 is conceivable. For example, a method of storing input information, “play a song having a similar taste to the song heard yesterday” and “play a song completely different from the song heard yesterday”, as information related to information, “play Gunma's song”, in the interaction DB 113 can be considered. Accordingly, in a case where the interaction DB 113 is searched with the keyword “Gunma”, the information, “play a song having a similar taste to the song heard yesterday” and “play a song completely different from the song heard yesterday” described above, are found from the interaction DB 113. The learning data can be extracted from the learning DB 114 on the basis of the found information.

Such a method may be used, but such a method requires that information indicating the relationships between various pieces of information stored in the interaction DB 113 are stored in the interaction DB 113, for example, so that there is a possibility that the information recorded in the interaction DB 113 becomes enormous.

<Another Extraction Method of Related Information>

Accordingly, in a case where inconsistency occurs in output information in a case where predetermined information is extracted, a method of determining the extracted information as related information will be described. More specifically, in a case where the predetermined information is extracted, a case where the predetermined information is temporarily deleted is assumed, and in a case where output information before deletion and output information after deletion are different, the extraction information is determined as information related to the keyword. According to such a method, it is not necessary to record information indicating the relationships between various pieces of information stored in the interaction DB 113.

With reference to FIG. 36, a method for determining, when information regarding an interaction including a keyword is extracted, whether or not the information regarding the interaction is related to the keyword on the basis of a change in output information that is output on the basis of the algorithm will be described.

FIG. 36 is a diagram illustrating output information generated before and after the deletion of information regarding the interaction, and processing contents based on changes in the output information before and after the deletion. FIG. 36 illustrates three examples. Hereinafter, three examples illustrated in FIG. 36 will be described. From the left side in order, a song that the user listened to yesterday, output (before and after deletion), change in output, and processing content are illustrated.

The output (before deletion) is content of output information for input information, “play a song having a similar taste to the song heard yesterday”, from the user. Furthermore, in the following three examples, the extraction unit 122 extracts information including the keyword “Gunma” from the storage unit 118. The content of output information for the input information described above after the extraction is performed is illustrated as the output (after deletion).

In the first example, as interaction information, it is recorded that the user heard only the “Gunma's song” yesterday. Thus, the output information for the input information is information for playing only the “Gunma's song”. On the other hand, if the information including “Gunma” is temporarily deleted, the algorithm can no longer understand the intention of the user because the history of playing the “Gunma's song” disappears, and thus the output information changes to information “was there any song played yesterday?” for example.

In this manner, in a case where it is determined that the output information changes due to the temporary deletion of the information including the keyword “Gunma”, the determination unit 123 determines that the input information is data related to the keyword “Gunma” (related data). In this manner, the information processing device 11 according to the present embodiment extracts information including the keyword, and if the extracted keyword is temporarily deleted, the information processing device 11 can determine the relationship between the input information and the keyword according to changes in the output information before and after the deletion. Thus, the information processing device 11 does not need to store what kind of keyword each piece of the input information is associated with.

Then, in the second example, the user has listened to the Gunma's song and a song other than the Gunma's song yesterday. That is, the output (before deletion) is an output to play the “Gunma's song” and the “song other than the Gunma's song”. On the other hand, the output (after deletion) after various information including “Gunma” is temporarily deleted is an output to play only the “song other than the Gunma's song”. Also in this case, there is a change between the output (before deletion) and the output (after deletion). Thus, the determination unit 123 determines that the input information is related data of the keyword “Gunma”.

Then, in the third example, the user has listened to only the “song other than the Gunma's song” yesterday. Thus, the output (before deletion) is an output in which only the “song other than the Gunma's song” is played. On the other hand, the output (before deletion) is an output that is not related to the keyword. Thus, the output (after deletion) does not change from the output (before deletion). At this time, the determination unit 123 determines that the input information is data that is not related to the keyword.

By determining a relevance between a keyword and input information in this manner, it is possible to extract input information related to the keyword on the basis of the keyword. In other words, it is not limited to the input information, “play Gunma's song”, and it is possible to extract input information (interaction), “play a song having a similar taste to the (Gunma's) song heard yesterday” or “play a song completely different from the (Gunma's) song heard yesterday”, related to the keyword “Gunma”.

Furthermore, according to this method, the relationship between the keyword and the input information is determined on the basis of a change in the output information. Thus, the information processing device 11 does not need to store the relationship between various keywords and input information, and can extract information regarding the interaction on the basis of less information.

<Still Another Extraction Method of Related Information>

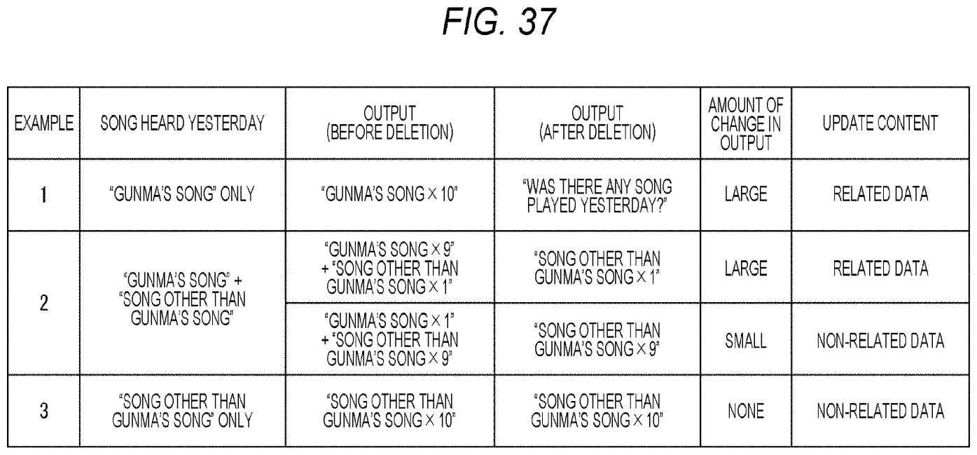

Still another extraction method of related data will be described with reference to FIG. 37. FIG. 37 illustrates four examples. The following are four examples in which the output is changed. Note that in each of the examples, the extraction unit 122 searches for the keyword “Gunma” from the interaction DB 113, and extracts learning data from the learning DB 114 on the basis of the search result.

In the first example, the user only listened to the “Gunma's song” yesterday. In this case, as in the case described with reference to FIG. 36, the amount of change in the output before and after deletion is large. Thus, in this case, the determination unit 123 determines that the change in the output is large, and determines that it is related data.

Then, in the second and third examples, the user listened to the “Gunma's song” and the “song other than the Gunma's song” yesterday. However, in the second example and the third example, the number of “Gunma's songs” and the number of “songs other than the Gunma's songs” heard by the user are different. Specifically, in the second example, the user terminal 20 plays nine “Gunma's songs” and one “song other than Gunma's songs”. On the other hand, in the third example, the user terminal 20 plays one “Gunma's song” and nine “songs other than the Gunma's song”.

In the second example, before and after the extraction of the learning data related to the keyword “Gunma”, the output information is changed from information to play nine “Gunma's songs” and one “song other than Gunma's songs” to information to play one “Gunma's song”. In this case, the determination unit 123 determines that the amount of change in the output before and after the deletion is large, and determines that it is related data.

On the other hand, in the third example, before and after the extraction of the learning data related to the keyword “Gunma”, the output information has been changed from information to play one “Gunma's song” and nine “songs other than Gunma's songs”, to nine “songs other than Gunma's songs”. In this case, the determination unit 123 determines that the amount of change in the output before and after the deletion is small, and determines that it is not related data.

Furthermore, in the fourth example, the user only listened to “Gunma's song” yesterday. In this case, as in the case described with reference to FIG. 36, the determination unit 123 determines that the amount of change in the output before and after the deletion is small, and determines that it is not related data.

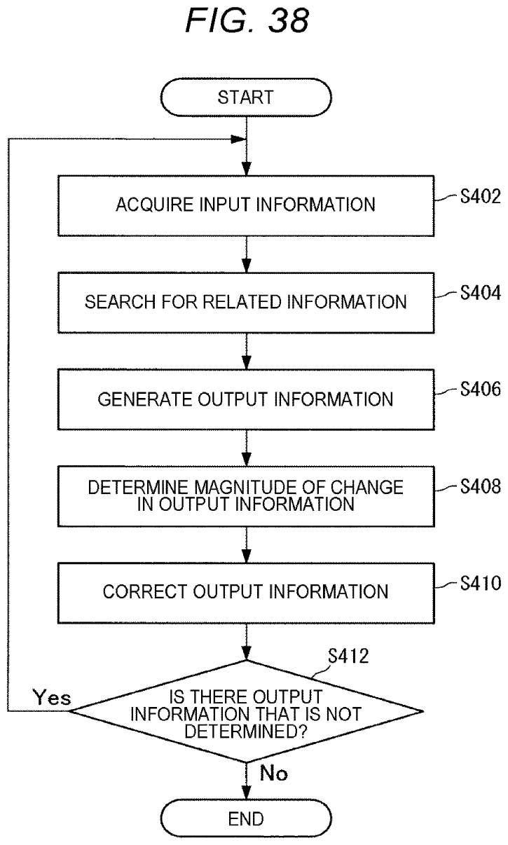

As described above, with reference to FIG. 37, the outline of information extraction processing examples by the information processing device 11 according to the present embodiment has been described. Next, with reference to FIG. 38, extraction processing of the interaction DB 113 by the information processing device 11 according to the present embodiment will be described.

First, the information processing device 11 acquires input information (step S402). More specifically, the information processing device 11 receives, for example, a keyword input from the user to the user terminal 20 and information requesting extraction of learning data related to the keyword (hereinafter, also simply referred to as “request information”) as input information via the network 30. Here, it is assumed that the keyword described above is, for example, the word “Gunma”. The information processing device 11 receives the keyword described above and the request information as input information, and transmits the received input information to the extraction unit 122 included in the processing unit 120 via the communication control unit 160.

Next, the extraction unit 122 extracts related information on the basis of the transmitted input information (step S404). Specifically, the extraction unit 122 extracts information related to the keyword “Gunma”. More specifically, the extraction unit 122 extracts information stored in the knowledge DB 111, the recommendation DB 112, or the interaction DB 113 related to the word “Gunma” of the keyword. Note that the extraction unit 122 does not extract the output information recorded in the interaction DB 113.

Next, the generation unit 140 generates output information (step S406). Note that at this time, the generation unit 140 generates output information assuming that the related information extracted in step S404 (excluding the input information used in step S406) has been extracted. That is, the generation unit 140 generates the output information assuming that there is no interaction or the like related to the keyword “Gunma”. At this time, the output information generated by the generation unit 140 may differ from the output information recorded in the interaction DB 113.

Next, the determination unit 123 determines the magnitude of a change in the output information (step S408). More specifically, the determination unit 123 determines the magnitude of a difference between the output information generated in step S406 and the output information recorded in the learning DB 114 and corresponding to the input information used to generate the output information as the magnitude of a change in the output information.

Next, the correction unit 124 extracts the output information recorded in the learning DB 114 according to a determination result by the determination unit 123 in step S408 (step S410). For example, in a case where it is determined in step S408 that the change in the output information is large, the correction unit 124 extracts the output information that is recorded in the learning DB 114 and is the target of determination in step S408, and input information corresponding thereto.

Furthermore, in a case where it is determined in step S408 that there is no change in the output information, the correction unit 124 maintains the output information that is recorded in the interaction DB 113 and is the target of determination in step S408.

Next, in a case where the extraction unit 122 determines that there is output information that is not determined on the basis of the interaction DB 113 (step S412: Yes), the processing returns to step S402. On the other hand, in a case where it is determined that there is no output information that is not determined on the basis of the interaction DB 113 (step S412: No), the extraction process illustrated in FIG. 38 ends.

As described above, the information processing device 11 according to the present embodiment extracts the interaction information recorded in the interaction DB 113.

Reference will be made to the extraction example illustrated in FIG. 35 again. For example, interactions at times t3, t4, and t5 are extracted as interactions in a predetermined period. The interactions at times t9, t11, and t12 are extracted as related data related to the interactions at times t3, t4, and t5. In this case, if only the interactions within a predetermined period are extracted, only the interactions at times t3, t4, and t5 will be extracted, but by extracting related data, the interactions at times t9, t11, and t12 are also extracted.

For example, in a case where the user B is an entertainer and interactions within a recording period of a predetermined program are extracted from the interaction DB 113B, the interactions within the recording period are first extracted. For example, interactions at times t3, t4, and t5 are extracted as interactions within the recording period. The user B may perform an interaction on a topic related to recorded contents with the information processing system 1 even in a case where the recording is not performed.

Interactions such as conversations at times other than recording are also extracted as interactions related to the interactions within the recording period. For example, interactions at times t9, t11, and t12 are extracted as related data.

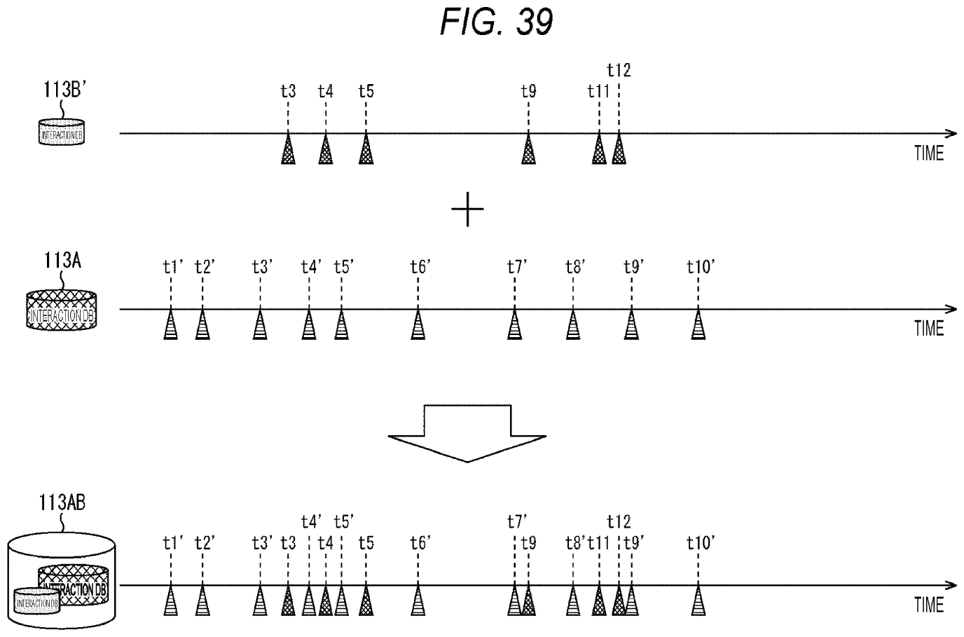

In this manner, the predetermined information is extracted from the interaction DB 113B constructed for the user B, and the interaction DB 113B′ is constructed. The interaction DB 113B′ is provided to the user A side and integrated with the interaction DB 113A constructed for the user A, to thereby construct the interaction DB 113AB. This integration will be described with reference to FIG. 39.

An upper part of FIG. 39 illustrates an interaction history of the interaction DB 113B′, a middle part of FIG. 39 illustrates an interaction history of the interaction DB 113A, and a lower part of FIG. 39 illustrates an interaction history of the interaction DB 113AB.

With reference to the interaction history of the interaction DB 113B′ illustrated in the upper part of FIG. 39, interactions at the times t3, t4, t5, t9, t11, and t12 are extracted from the interaction DB 113B for the user B by the processing described above, and recorded in the interaction DB 113B′. With reference to the interaction history of the interaction DB 113A illustrated in the middle part of FIG. 39, the interaction DB 113A records the interactions at times t1′ to t10′. An interaction with a prime indicates that it is an interaction of the interaction DB 113A.

In a case where the interaction DB 113B′ and the interaction DB 113A are integrated, the interactions recorded in each database are integrated by arranging them in chronological order. In the example illustrated in FIG. 39, the interactions are sorted in the order of time t1′, time t2′, time t3′, time t3, time t4′, time t4, time t5′, time t5, time t6′, time t7′, time t9, time t8′, time t11, time t12, time t9′, and time t10′.

In this manner, the integrated knowledge DB 116AB or/and the recommendation DB 117AB are constructed by performing re-learning using the interaction DB 113AB recording interaction information sorted in chronological order.

Incidentally, as described with reference to FIG. 39, in a case where the interaction DB 113B′ and the interaction DB 113A are integrated by arranging the interaction information in chronological order, there is a possibility that the content of the interaction change drastically.

For example, interactions at time t3, time t4, and time t5 are interactions of the user B, and interactions at time t3′, time t4′, and time t5′ are interactions of the user A. After the integration, the interactions are sorted in the order of time t3′, time t3, time t4′, time t4, time t5′, and time t5.

It is assumed that the user B performs interactions at a place B at time t3, time t4, and time t5, and the user A interacts at a place A at time t3′, time t4′, and time t5′. After the integration, the interactions are sorted in order of time t3′, time t3, time t4′, time t4, time t5′, and time t5, and thus the interaction at the place A and the interaction at the place B are mixed. In this manner, if the place of interaction suddenly changes, inconsistency will occur in the interaction, and if re-learning is performed using such inconsistent data, it is possible that re-learning is not be performed correctly.

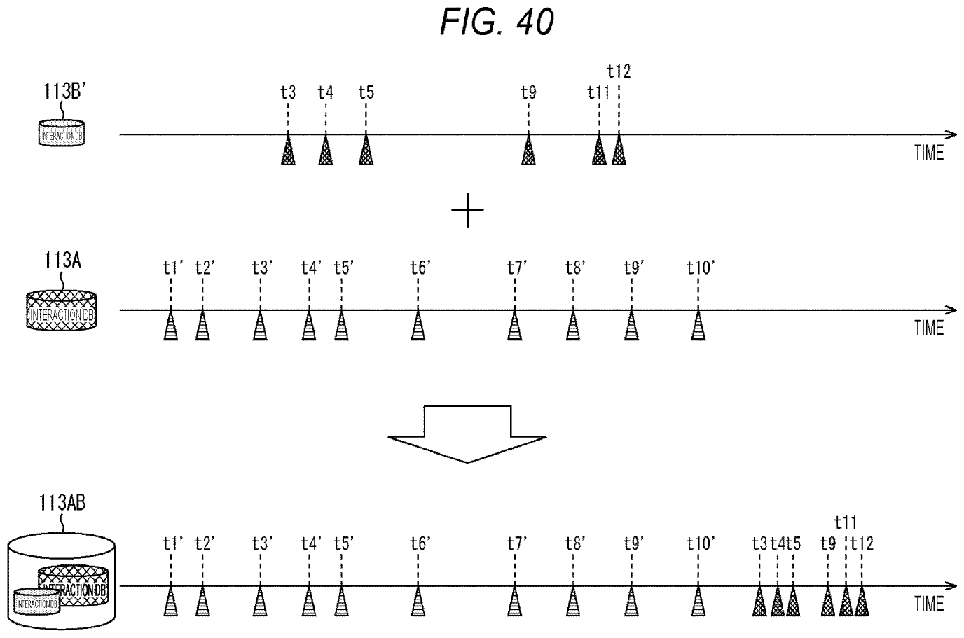

Accordingly, the integration as illustrated in FIG. 40 may be performed. Charts illustrated in the upper and middle parts of FIG. 40 are the same as the charts illustrated in the upper and middle parts of FIG. 39, and illustrate an interaction history of the interaction DB 113B′ and an interaction history of the interaction DB 113A, respectively.

The lower part of FIG. 40 illustrates an interaction history of the interaction DB 113AB. In the interaction DB 113AB illustrated in the lower part of FIG. 40, the interactions at times t3, t4, t5, t9, t11, and t12 are arranged after the interactions at times t1′ to t10′. The data of the integrated database, in this case, the interaction DB 113B′, is arranged by shifting to a time when inconsistency does not occur.

As in the above example, for example, the user A performs interactions at times t1′ to t10′ at a place A, and the user B performs interactions at times t3, t4, t5, t9, t11, and t12 at a place B. In this case, in the interaction DB 113AB illustrated in the lower part of FIG. 40, interactions of times t3, t4, t5, t9, t11, and t12 performed by the user B at the place B are arranged after interactions of times t1′ to t10′ performed by the user A at the place A, and thus it is conceivable that the place where the interactions have been performed does not change suddenly and the contents of the interactions do not change suddenly.

Thus, it is possible to prevent integrations that cause sudden changes in the interaction contents and cause inconsistencies. Furthermore, correct re-learning can be performed by referring to the interaction DB 113AB that has been integrated to prevent inconsistencies from occurring.

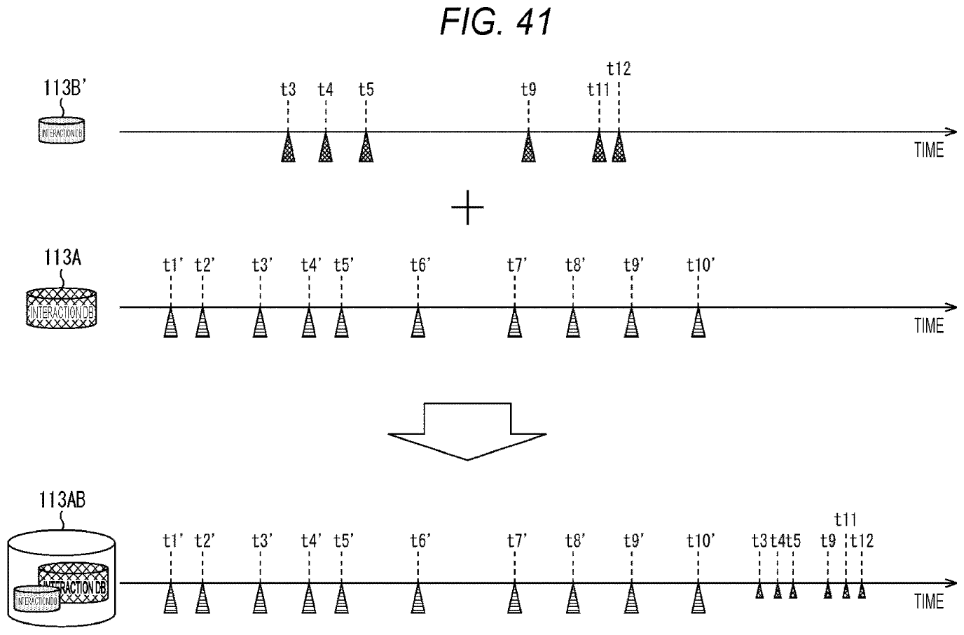

Furthermore, as illustrated in FIG. 41, among the interaction information recorded in the interaction DB 113AB, intensity of the interaction information recorded in the interaction DB 113B′ may be set to be decreased. The interaction DB 113B′ records the interaction information extracted from the interaction DB 113B for the user B, and by decreasing the intensity of the interaction information, it is possible to perform re-learning in which personality of the user B is weakened.

By weakening, for example, the FB of the interaction DB to be integrated, it is possible to act in a direction of maintaining the personality before integration. Here, the case of acting in a direction of maintaining personality of the user A by weakening the information of FB included in the interaction DB of the user B has been described as an example, but it is possible to act in the direction of maintaining personality of the user B (the personality of the user B is strongly reflected) by weakening the FB of the interaction DB of the user A.

Here, the case where the two interaction DBs 113 are integrated has been described as an example, but the number of databases to be integrated may be any number.

By the way, there is a possibility that highly confidential information such as personal information is recorded in the interaction DB 113. When extracting the interaction information from the interaction DB 113 described with reference to FIGS. 35 to 38, the information determined to be highly confidential, such as personal information, may not be extracted.

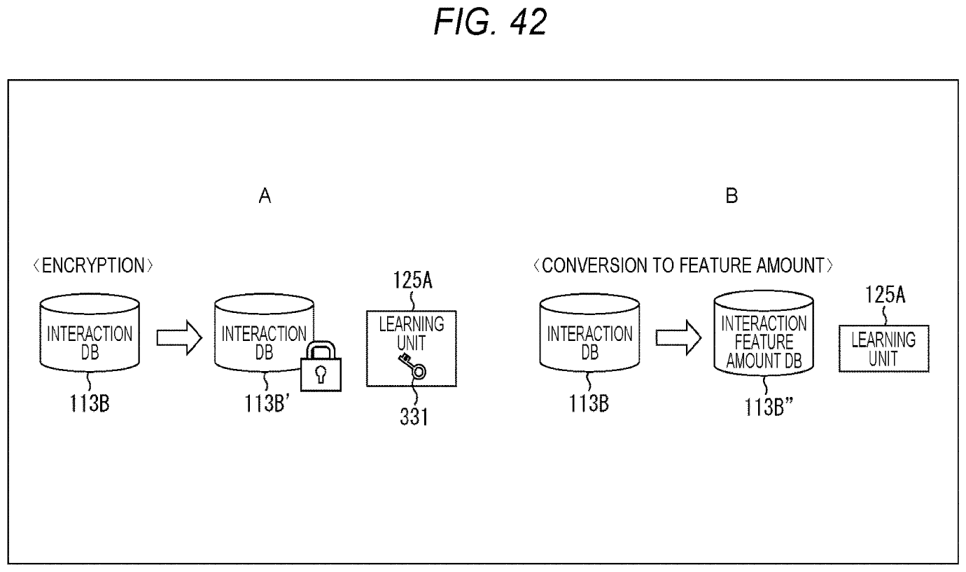

Furthermore, as illustrated in A of FIG. 42, the extracted interaction information may be encrypted and provided to another user. Interaction information that meets a predetermined condition is extracted from the interaction DB 113B by the method as described above. The extracted interaction information is encrypted using a predetermined encryption method. Then, the database recording the encrypted interaction information is provided to the user A side as the interaction DB 113B′.

The learning unit 125A included in the information processing device 11 on the user A side holds a key 331 for decoding. When the interaction information recorded in the interaction DB 113B′ is used, the learning unit 125A decodes the interaction information using the held key 331, and performs re-learning using interaction information after decryption.

By providing the encrypted interaction information to another user (in this case, the user A) in this manner, it is possible to prevent the interaction information itself from being leaked to another user, and it is possible to prevent leakage of highly confidential information such as personal information.

Alternatively, as illustrated in B of FIG. 42, the extracted interaction information may be converted into a feature amount so that the feature amount is provided to another user side. Interaction information that meets a predetermined condition is extracted from the interaction DB 113B by the method as described above. Feature amounts are extracted from this extracted interaction information. Then, an interaction feature amount DB 113B″ recording the extracted feature amounts as the interaction information is generated and provided to the user A side.

When the learning unit 125A included in the information processing device 11 on the user A side uses the interaction information recorded in the interaction DB 113B′, the learning unit 125A performs re-learning using the feature amounts.

As described above, the learning unit 125 learns the parameters on the basis of the interaction information recorded in the interaction DB 113, for example, on the basis of a technique such as reinforcement learning. It has been described that the learning of parameters is to optimize the black box parameters according to the accumulation of learning data.

Furthermore, the analysis unit 131 or the recommendation information generation unit 145 inputs an input value to a network in which an input layer including a plurality of inputs and an output layer including a plurality of outputs are connected by an intermediate layer including multiple layers, and outputs an output value related to an analysis result or recommendation information. A parameter that defines the weight of a node in this network is a black box parameter.

Thus, the feature amount can be, for example, an output of the intermediate layer. Even if the feature amount is leaked, it is difficult for the user to understand the meaning. In this manner, by providing the interaction information as a feature amount to another user (in this case, the user A), it is possible to prevent leakage of the interaction information itself to another user, and it is possible to prevent leakage of highly confidential information such as personal information.

In the above-described embodiment, for example, referring to FIG. 34 again, predetermined interaction information is extracted from the interaction DB 113B on the user B side and the interaction DB 113B′ recording the extracted interaction information is provided to the user A side, and the interaction DB 113AB is constructed.

In this manner, instead of providing the interaction DB 113B′ to the user A side, the interaction DB 113A of the user A may be provided to the user B side, and the interaction DB 113AB may be constructed on the user B side. Then, the interaction DB 113AB constructed on the user B side may be provided (returned) to the user A side.

By making the integration processing performed on the user B side in this manner, the interaction information recorded in the interaction DB 113B of the user B is not provided to the user A side as it is, so that it is possible to prevent leakage of highly confidential information such as the personal information of the user B.

By the way, the interaction DB 113 records a history of interaction with the user. Furthermore, the interaction with the user is performed via the user terminal 20 (FIG. 1). The user terminal 20 may be a terminal that interactions only by voice, and there is also a terminal that perform interactions by using voice and video.

For example, in a case where the user terminal 20 is a device in which interaction with the user is mainly performed by voice and reaction of the user is determined by imaging the user and analyzing a video thereof, voice and video are input to the user terminal 20, and the audio and video are recorded in the interaction DB 113.

In a case where the user terminal 20 does not have a function of imaging the user, voice is input to the user terminal 20, and the voice is recorded in the interaction DB 113.

In this manner, the type (format) of the data recorded in the interaction DB 113 may be different. For example, it is assumed that audio data is recorded in the interaction DB 113A of the user A, and audio data and video data are recorded in the interaction DB 113B of the user B. In such a case, the interaction information extracted from the interaction DB 113B of the user B becomes audio data and video data, and the audio data and the video data are integrated with the audio data of the interaction DB 113A of the user A.

In this manner, in a case where data to be handled is different, the difference can be ignored, and re-learning can be performed. The video data is used, for example, to determine a reaction of the user, and data that serves as such determination material, in other words, the re-learning can be performed assuming that there is no biometric information of the user. By performing the re-learning assuming that there is no biometric information, there is a possibility that a learning result becomes erroneous. Accordingly, the feature amount may be used.

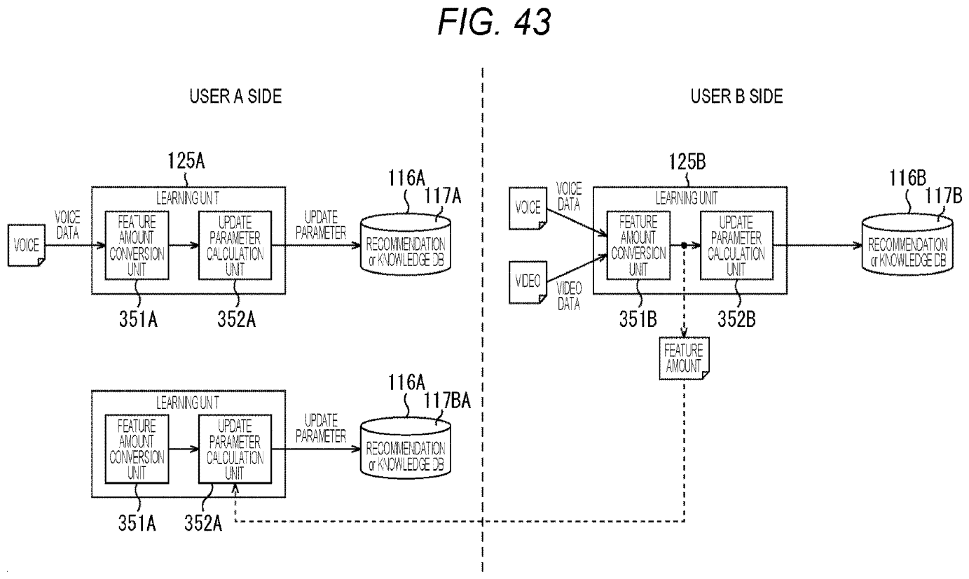

FIG. 43 is a diagram for describing a case where integration is performed using feature amounts. The learning unit 125A on the user A side includes a feature amount conversion unit 351A and an update parameter calculation unit 352A. The feature amount conversion unit 351A converts input voice data into a feature amount and outputs the feature amount to the update parameter calculation unit 352A. The update parameter calculation unit 352A calculates knowledge parameters to be recorded in the knowledge DB 116A or/and the recommendation parameters to be recorded in the recommendation database 117A, and records them in the corresponding database.

Similarly, the learning unit 125B on the user B side includes a feature amount conversion unit 351B and an update parameter calculation unit 352B. The feature amount conversion unit 351B converts input audio data and video data into feature amounts and outputs the feature amounts to the update parameter calculation unit 352B. The update parameter calculation unit 352B calculates the knowledge parameters to be recorded in the knowledge DB 116B or/and the recommendation parameters to be recorded in the recommendation database 117B, and records them in the corresponding database.

In FIG. 43, audio data and video data have been described as examples as input data, but even in a case where various other data such as position data and temperature data are input, the present technology can be applied, for example.

As the feature amounts, the feature amounts described with reference to FIG. 42, that is, the black box parameter can be used. The interaction information is extracted from the interaction DB 113B as in the case described with reference to FIG. 42. This extracted interaction information becomes a feature amount in a case where the technique described with reference to FIG. 43 is used. The interaction DB 113B′ recording this feature amount is provided to the user A side and integrated with the interaction DB 113A of the user A.

At the time of re-learning, as illustrated in the lower left side of FIG. 43, the re-learning is performed by supplying the feature amounts to the update parameter calculation unit 352A. By performing learning using such feature amounts, it is possible to absorb differences in database formats and integrate databases. Furthermore, by using the feature amount, it is possible to prevent leakage of information at the time of integration.

### APPLICATION EXAMPLE

Hereinafter, application examples of the information processing system 1 according to the present embodiment will be described.

### First Application Example

The information processing system 1 of the present disclosure can also be applied to technology such as autonomous driving or driving navigation. For example, a case where the information processing system 1 is applied to autonomous driving that assists the driving of the user will be described. Note that autonomous driving means that the vehicle travels autonomously to a destination set on the vehicle side by using information from various sensors provided in the vehicle without the user performing a driving operation. However, here, it is assumed that a case of assisting a part of the driving operation in a case where the user drives is also included.

In a case where the information processing system 1 is applied to the autonomous driving, data regarding past driving is recorded in the interaction DB 113. From this past travel history, favorite travel data of the user (assumed as a driver A) is extracted. For example, travel data for which a positive FB is obtained is extracted. The database recording the extracted travel data is described as the extraction running DB.

A car called a share car such that one vehicle is shared and used by multiple users, and a database (described as a local DB) included in the information processing system 1 installed in a taxi or the like will be considered. The local DB is optimized for the region where the car is used. By integrating such a local DB and the extraction running DB described above, it is possible to construct a database that reflects the favorite driving of the driver A.

By performing the re-learning using the database that reflects the favorite driving of the driver A, it becomes possible to perform autonomous driving that reflects preferences of the driver A. For example, it is possible to enable autonomous driving in which driving course selection, acceleration, steering, and the like that the driver A prefers are achieved.

Furthermore, the local DB and the extraction running DB may be switched and used. Also in this case, the travel optimized for the region and the travel preferred by the driver A can be achieved by switching between the local DB and the extraction running DB.

### Second Application Example

Another application example in a case where the information processing system 1 is applied to autonomous driving will be described.

Travel data is acquired from a vehicle traveling in a specific area (referred to as a region A), and a travel DB of the region A is created. Travel data from which a positive FB is obtained is extracted from the travel DB. The extracted travel data is, for example, data when the driver or the passenger feels comfortable in driving.

When the driver A drives in the region A, travel data in the travel DB of the region A is reflected in a database recording the travel data of the driver A. The database recording the travel data of the driver A is optimized for the driver A, and the travel DB of the region A is optimized for traveling of the region A. By integrating such databases, it is possible to construct a database in which optimal driving for the region A is reflected in the preferred driving of the driver A.

By performing the re-learning using the database reflecting the optimum driving in the region A, the autonomous driving in which preferences of the driver A and the optimum driving in the region A are reflected can be performed. For example, it is possible to perform the autonomous driving in which driving course selection, acceleration, steering, and the like preferred by the driver A and optimal for traveling in the region A are achieved.

Furthermore, the database recording the travel data of the driver A and the travel data in the travel DB of the region A may be switched and used. Also in this case, traveling optimized for the region and the traveling preferred by the driver A can be achieved by switching the database recording the travel data of the driver A and the travel data in the travel DB of the region A.

### Third Application Example

An application example in a case where the information processing system 1 is applied to an AI agent will be described.

An interaction DB 113 for characters of an animation, a comic, or the like, AI characters, and the like that do not exist in the real world is generated, for example. In this case, since the interaction DB 113 is of a user who does not exist in the real world, the interaction DB 113 is created on the assumption of virtual interaction on the basis of the setting conditions set by the creator, such as tastes and behaviors of the character (referred to as character A), instead of the history of performing actual interactions.

Alternatively, the interaction DB 113 may be created from an interaction of the character A in the animation. In this case, since the voice data and the video data are obtained, it is possible to extract the interaction of the character A and create the interaction DB 113 for the character A. Furthermore, in a case of a comic, text data and image data are obtained, and thus interaction of the character A may be extracted from these data, and the interaction DB 113 (hereinafter, it is referred to as a character DB) for the character A may be created.

Such a character DB is reflected in a DB (referred to as an interaction DB 113A) in the information processing system 1 of the user A. By integrating such databases, it is possible to construct a database reflecting tastes or the like of a favorite character of the user A.

By performing the re-learning using the database reflecting the character DB, the AI (information processing system 1) of the user A makes a response that is similar to the character A. For example, the voice or the recommendation content becomes like a character A. Thus, the user A can feel pseudo interaction with the favorite character A.

Furthermore, the character DB and the database of the user A may be switched and used. By switching to the character DB, a pseudo conversation with the character A or a recommendation from the character A can be received.

### Fourth Application Example

Another application example in a case where the information processing system 1 is applied to an AI agent will be described.

For example, a database of an AI agent (information processing system 1) used by a person targeted by the user A such as an entertainer or an idol, or a longing person (referred to as a user B) is reflected in the database of the user A (oneself).

By performing the re-learning using the database reflecting the database of the user B, the AI (information processing system 1) of the user A can receive the recommendation reflecting the liking and tastes of the user B.

Furthermore, the database of the user A and the database of the user B may be switched and used. For example, the database may be limited to a predetermined scene such as traveling, and the database may be made to be switched to the database of the user B. In this case, the user A can receive a recommendation reflecting the liking and tastes of the user B during travel, and can enjoy feeling as if traveling with the user B.

### Fifth Application Example

Another application example in a case where the information processing system 1 is applied to an AI agent will be described.

When the user A behaves as an avatar in a virtual space, an avatar interaction DB 113 is generated. For example, when the user A performs an activity in the virtual space, the user A desires to perform an activity with a different personality, sets a hobby, taste, behavior, or the like of an avatar of the different personality, and the interaction information based on the set condition is recorded in the interaction DB 113. The avatar interaction DB 113 (described as an avatar DB) may be created by another user instead of being created by the user A.

Such an avatar DB is reflected in the DB in the information processing system 1 of the user A. By integrating such databases, it is possible to construct a database reflecting favorite avatar tastes of the user A, and the like.

By performing the re-learning using the database reflecting the avatar DB, an avatar-like activity set by the user A can be performed. For example, while maintaining the behavior of the avatar before the avatar DB is reflected, processing of issuing a warning when an assumed avatar behaves unnaturally, recommending a behavior determined to be appropriate as the behavior of the avatar, or the like can be performed.

The user A becomes just an assumed (desired) avatar and becomes able to act in the virtual space.

### Sixth Application Example

An application example in a case where the information processing system 1 is applied to a chatbot will be described.

The chatbot is an automatic conversation program utilizing artificial intelligence, and a computer incorporating artificial intelligence interacts on behalf of a human. The information processing system 1 can be applied to a computer side of a chatbot.

A conversation history in a predetermined cultural area (described as a cultural area B) is acquired, and a database (described as a cultural area BDB) regarding interaction of the cultural area B is created. For example, there may be a database of a plurality of cultural areas, and the interaction of the cultural area B may be extracted from the database to create the cultural area BDB. The user A lives in a cultural area A different from the cultural area B, and a database (described as a cultural area ADB) regarding appropriate interaction is created in the cultural area A.

It is assumed a case where the user A moves from the cultural area A to the cultural area B or goes out for a trip. In such a case, the cultural area BDB of the cultural area B is reflected in the cultural area ADB of the user A. By reflecting such a database, a database reflecting the culture of the cultural area B can be constructed.

By performing the re-learning using the database reflecting the culture of the cultural area B, the AI (information processing system 1) of the chat pod already raised for the user A (for personal use) can be set as the chat pod reflecting the culture of the cultural area B. With such a chat pod, for example, behavior peculiar to the cultural area B is added, and it is possible to provide the interaction peculiar to the cultural area B to the user A.

### Seventh Application Example

An application example in a case where the information processing system 1 is applied to robot control will be described.

A database (described as a worker ADB) is constructed for a worker A who performs work using a robot. The worker ADB is AI optimized for the worker A.

On the other hand, in the workplace B located at a place different from the place where the worker A is working, a database (described as a workplace BDB) optimized for the workplace B is constructed. The workplace BDB is AI optimized for the workplace B obtained from the work history of the worker working in the workplace B. For example, in a case where the workplace B is a narrow factory, information optimized for work in such a narrow place is recorded in the workplace BDB.

For example, in a case where the worker A moves to the workplace B and performs work using a robot at the destination, the worker ADB and the workplace BDB are integrated. In other words, the AI optimized for the workplace B is reflected in the AI optimized for the worker A. A database in which the worker ADB and the workplace BDB are integrated is constructed, and re-learning is performed using such a database.

The robot to which the AI after re-learning is applied operates suitably for the environment of the workplace B at a transfer destination even though it is the same behaving as usual from the user A. Thus, the user A can perform the work at the transfer destination by the same familiar operation as before the transfer.

### Eighth Application Example

Another application example in a case where the information processing system 1 is applied to robot control will be described.

A database (described as a specific work DB) optimized for a specific work is constructed. The specific work is, for example, control corresponding to a new process. Furthermore, a database (described as a worker ADB) is constructed for a worker A who performs work using a robot. The worker ADB is AI optimized for the worker A.

For example, in a case where the worker A controls the robot in a new process, the worker ADB and the specific work DB are integrated. In other words, the specific work DB is reflected in the AI optimized for the worker A. A database in which such a worker ADB and the specific work DB are integrated is constructed, and re-learning is performed using such a database.

The robot to which the database (AI) after re-learning is applied is an operation suitable for a new process even though it is the same behavior as usual from the user A. Thus, the user A can perform the work with a familiar operation without feeling uncomfortable even in a new process.

### Ninth Application Example

Still another application example in a case where the information processing system 1 is applied to robot control will be described.

A database (described as a user DB) optimized for a specific user is constructed. The specific user is, for example, a female user, and the user DB is a database optimized when the female uses the database. Furthermore, a database (described as a worker ADB) is constructed for a worker A who performs work using a robot. The worker ADB is AI optimized for the worker A.

For example, the worker A is a male, and the worker ADB is a database suitable for when the male operates a robot. When a woman uses such a robot, the worker ADB and the user DB are integrated. In other words, the user DB is reflected in the AI optimized for the worker A. A database in which the worker ADB and the user DB are integrated is constructed, and re-learning is performed using such a database.

Even in a case where the robot before re-learning is optimized for men and is difficult for women to use, the robot after re-learning becomes a robot that is easy for women to use. Thus, even in a case where the user of the robot is changed, it is possible to optimize the user after change so as to be easy to use.

The seventh to ninth application examples are cases where the information processing system 1 is applied to robot control, but this robot may be an industrial robot or a personal robot. For example, the information processing system 1 can be applied to a general-purpose help robot for individuals, and the seventh to ninth application examples can also be applied. Furthermore, the seventh to ninth application examples can also be applied to vehicle control as in the first and second application examples.

### Tenth Application Example

An application example in a case where the information processing system 1 is applied to information management will be described.

For example, a case where the information processing system 1 is applied to AI that predicts stock prices will be described as an example. For example, when a company A acquires a business X of a company B, data related to the business X is extracted from the database of AI that predicts the own company stock of the company B. The extracted data related to the business X is reflected in the DB of the AI (information processing system 1) that predicts the stock price.

By reflecting the data related to the business X, it is possible to more accurately predict the prediction of the stock price after the company A acquires the business X of the company B.

Here, the information management has been described as an example of managing information regarding the economy, but the information processing system can also be applied to a case where information regarding a factory is managed, prediction for improving work efficiency is made, a work plan is made, or the number of products to be shipped is predicted. Furthermore, the information processing system can also be applied to a case where information regarding agriculture is managed, a timing of application of a pesticide, an amount of application, and the like are predicted, and a harvest amount is predicted.

### Eleventh Application Example

An application example in a case where the information processing system 1 is applied to a behavior recognition, authentication, monitoring system, security related system, and the like will be described.

For example, a case where the information processing system 1 is applied to a system that performs an authentication process on a specific person as an authentication target will be described as an example. For example, a case where a person A is set as an authentication target, and the person A suffers a fracture will be considered. In such a case, since the behavior of the person A is different between before and after the fracture, in the processing using the database optimized for authenticating the person A before the fracture, there is a possibility that a case where the person A after the fracture cannot be authenticated occurs.

A database (described as a general behavior DB) is constructed in order to authenticate a general behavior. The behavior pattern of the person with the fracture is also recorded in the general behavior DB. In a case where it is determined that the person A has suffered a fracture, data of the behavior pattern of the person with the fracture is extracted from the general action DB, and the extracted data is reflected in the database of the information processing system 1.

By reflecting the database of the behavior pattern of the person with the fracture in the AI optimized for authentication of a specific person (in this case, the person A), even in a case where the person A to be authenticated suffers a fracture and the behavior pattern is suddenly changed, authentication can be performed in light of a general pattern of a person with a fracture. Thus, even if there is a change in the authentication target person, authentication can be performed without any problem.

<Information Processing System Including Plurality of Devices>

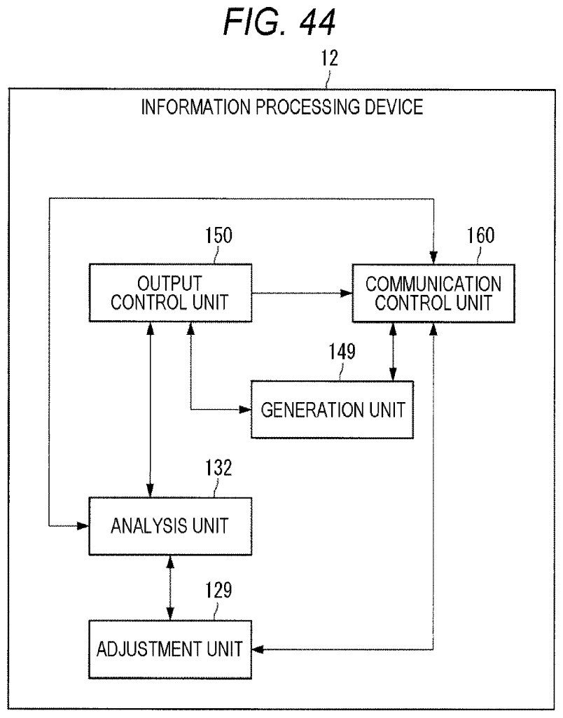

In the first and second embodiments described above, the information processing device 10 or the information processing device 11 constitutes an information processing system. The present invention is not limited thereto, and the information processing system may include a plurality of devices. FIG. 44 is a diagram illustrating an example of the information processing system 2 including a plurality of devices. As illustrated in FIG. 44, the information processing system 2 includes an information processing device 12 and a data server 15. Furthermore, the information processing device 12 and the data server 15 are connected via a network 30.

A configuration of the information processing device 12 will be described with reference to FIG. 44. FIG. 44 is a functional block diagram illustrating the configuration of the information processing device 12. Unlike the information processing devices 10 and 11 according to the first and second embodiments, the information processing device 12 illustrated in FIG. 44 does not include a database corresponding to a knowledge DB, a recommendation DB, an interaction DB, a learning DB, or the like. These databases are recorded in the data server 15. In this case, the information processing device 12 can acquire information from a data server connected to the network as necessary, and perform re-learning or the like for the algorithm. Note that, although not illustrated in FIG. 44, the information processing device 12 includes a storage unit that stores information necessary for various types of processing.

<Hardware Configuration>

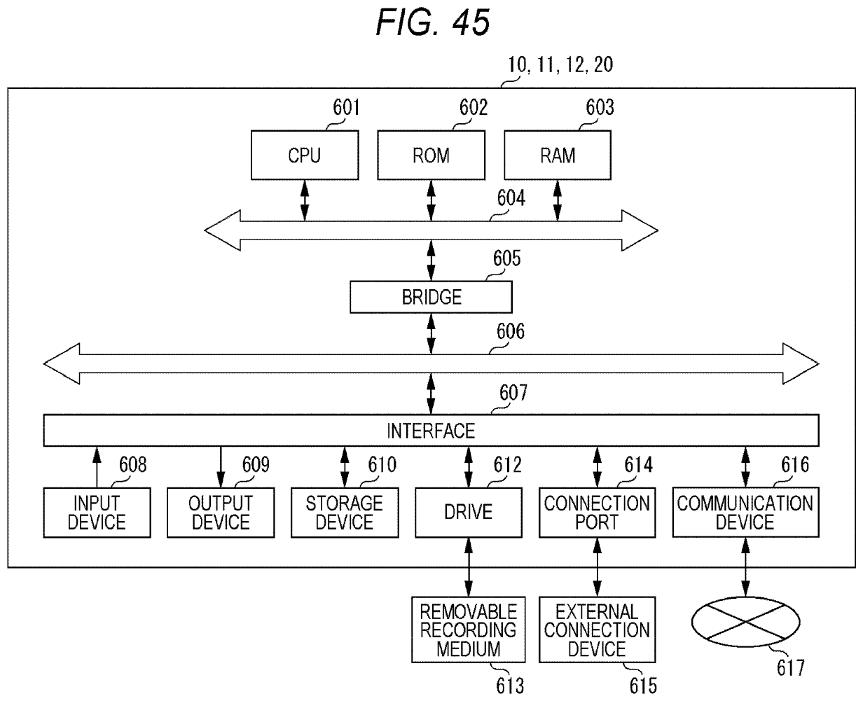

Next, an example of a hardware configuration of the information processing devices 10, 11, and 12 or the user terminal 20 constituting the information processing system 1 according to an embodiment of the present disclosure will be described in detail with reference to FIG. 45. FIG. 45 is a functional block diagram illustrating a configuration example of a hardware configuration of the information processing devices 10, 11, and 12 constituting the user terminal 20 or the information processing system 1 according to an embodiment of the present disclosure.

The information processing device 10 constituting the information processing system 1 according to the present embodiment mainly includes a CPU 601, a ROM 602, and a RAM 603. Furthermore, the information processing device 10 includes a host bus 604, a bridge 605, an external bus 606, an interface 607, an input device 608, an output device 609, a storage device 610, a drive 612, a connection port 614, and a communication device 616.

The CPU 601 functions as an arithmetic processing device and a control device, and controls all or a part of the operation in the information processing device 10 in accordance with various programs recorded in the ROM 602, RAM 603, storage device 610, or a removable recording medium 613. The ROM 602 stores programs and calculation parameters and the like used by the CPU 601. The RAM 603 temporarily stores a program used by the CPU 601, parameters that change as appropriate during the execution of the program, and the like. These are interconnected by a host bus 604 formed by an internal bus such as a CPU bus. For example, the processing unit 120, the analysis unit 130, the generation unit 140, the output control unit 150, and the communication control unit 160 illustrated in FIG. 3 can be configured by the CPU 601.

The host bus 604 is connected to the external bus 606 such as a peripheral component interconnect/interface (PCI) bus via the bridge 605. Furthermore, the input device 608, the output device 609, the storage device 610, the drive 612, the connection port 614, and the communication device 616 are connected to the external bus 606 via the interface 607.

The input device 608 is, for example, an operating means operated by the user, such as a mouse, a keyboard, a touch panel, buttons, switches, levers, and pedals. Furthermore, the input device 608 may be, for example, a remote control means (what is called a remote controller) using infrared rays or other radio waves, or may be an externally connected device 615 such as a mobile phone or PDA corresponding to the operation of the information processing device 10. Moreover, the input device 608 includes, for example, an input control circuit or the like that generates an input signal on the basis of information input by the user using the operating means described above and outputs the input signal to the CPU 601. By operating the input device 608, the user of the information processing device 10, 11, or 12 or the user terminal 20 can input various data or give an instruction on processing operation to the information processing device 10, 11, or 12 or the user terminal 20.

The output device 609 includes a device capable of visually or audibly notifying the user of acquired information. Such a device includes a display device such as a CRT display device, a liquid crystal display device, a plasma display device, an EL display device, and a lamp, an audio output device such as a speaker and headphones, or a printer device, or the like. The output device 609 outputs, for example, results obtained by various processes performed by the information processing device 10, 11, or 12 or the user terminal 20. Specifically, the display device displays results obtained by various processes performed by the information processing device 10, 11, or 12 or the user terminal 20 as a text or an image. On the other hand, the audio output device converts an audio signal including reproduced voice data, sound data, or the like into an analog signal and outputs the analog signal.

The storage device 610 is a device for storing data, which is configured as an example of a storage unit of the information processing device 10. The storage device 610 includes, for example, a magnetic storage unit device such as a hard disk drive (HDD), a semiconductor storage device, an optical storage device, a magneto-optical storage device, or the like. The storage device 610 stores programs executed by the CPU 601 and various data, and the like. For example, the storage unit 110 illustrated in FIG. 3 can be configured by the storage device 610.

The drive 612 is a reader-writer for a recording medium, and is built in or externally attached to the information processing device 10. The drive 612 reads information recorded on the removable recording medium 613 such as a mounted magnetic disk, optical disk, magneto-optical disk, or semiconductor memory, and outputs the information to the RAM 603. Furthermore, the drive 612 can also write a record to the removable recording medium 613, such as a mounted magnetic disk, optical disk, magneto-optical disk, or semiconductor memory. The removable recording medium 613 is, for example, a DVD medium, an HD-DVD medium, a Blu-ray (registered trademark) medium, or the like. Furthermore, the removable recording medium 613 may be a compact flash (registered trademark) (CF), a flash memory, a secure digital memory card (SD memory card), or the like. Furthermore, the removable recording medium 613 may be, for example, an integrated circuit (IC) card or an electronic device on which a non-contact type IC chip is mounted, or the like.

The connection port 614 is a port for directly connecting to the information processing device 10, 11, or 12 or the user terminal 20. Examples of the connection port 614 include a universal serial bus (USB) port, an IEEE 1394 port, and a small computer system interface (SCSI) port, and the like. Other examples of the connection port 614 include an RS-232C port, an optical audio terminal, and a High-Definition Multimedia Interface (registered trademark) (HDMI) port, and the like. By connecting the externally connected device 615 to the connection port 614, the information processing device 10 acquires various data directly from the externally connected device 615 or provides various data to the externally connected device 615.

The communication device 616 is, for example, a communication interface including a communication device for connecting to a communication network (network) 917, and the like. The communication device 616 is, for example, a communication card for a wired or wireless local area network (LAN), Bluetooth (registered trademark), or wireless USB (WUSB), or the like. Furthermore, the communication device 616 may be a router for optical communication, a router for asymmetric digital subscriber line (ADSL), a modem for various communication, or the like. The communication device 616 can transmit and receive, for example, signals and the like to and from the Internet and other communication devices in accordance with, for example, a predetermined protocol such as TCP/IP. Furthermore, the communication network 617 connected to the communication device 616 includes a network or the like connected by wire or wirelessly, and may be, for example, the Internet, a home LAN, infrared communication, radio wave communication, or satellite communication, or the like.

An example of the hardware configuration capable of achieving the functions of the information processing devices 10, 11, and 12 constituting the user terminal 20 or the information processing system 1 according to the embodiment of the present disclosure has been described above. Each of the above components may be formed using a general-purpose member, or may be formed by hardware specialized for the function of each component. Therefore, it is possible to appropriately change the hardware configuration to be used according to the technical level at each time when the present embodiment is implemented. Note that although not illustrated in FIG. 21, various configurations corresponding to the information processing devices 10, 11, and 12 constituting the user terminal 20 or the information processing system 1 are naturally included.

Note that a computer program for implementing each function of the information processing devices 10, 11, and 12 constituting the information processing system 1 according to the present embodiment as described above can be created and mounted on a personal computer or the like. Furthermore, a computer-readable recording medium in which such a computer program is stored can be provided. The recording medium is, for example, a magnetic disk, an optical disk, a magneto-optical disk, a flash memory, or the like. In addition, the above computer program may be distributed via a network, for example, without using a recording medium. Furthermore, the number of computers that execute the computer program is not particularly limited. For example, a plurality of computers (for example, a plurality of servers or the like) may execute the computer program in cooperation with each other.

Note that the program executed by the computer may be a program for processing in time series in the order described in the present description, or a program for processing in parallel or at a necessary timing such as when a call is made.

Furthermore, in the present description, the system represents the entire device including a plurality of devices.

Note that the effects described herein are merely examples and are not limited, and other effects may be provided.

Note that the embodiments of the present technology are not limited to the above-described embodiments, and various modifications are possible without departing from the gist of the present technology.

Note that the present technology can have configurations as follows.

(1)

An information processing device including:

causing, for an algorithm that changes on the basis of accumulation of first learning data,

re-learning to be performed on the basis of the first learning data and specific learning data out of second learning data forming another algorithm that changes on the basis of accumulation of learning data.

(2)

The information processing device according to (1) above, in which

the first learning data includes data regarding output information from the algorithm based on input information to the algorithm.

(3)

The information processing device according to (1) or (2) above, in which

the first learning data is based on data accumulated under an environment in which the algorithm is used.

(4)

The information processing device according to any one of (1) to (3) above, in which

the specific learning data is learning data obtained by extracting a specific learning history that meets a predetermined condition from a learning history of the algorithm on the basis of a database that records data regarding input information to the other algorithm.

(5)

The information processing device according to any one of (1) to (4) above, in which

the first learning data is learning data based on input information under a first environment using the algorithm, and

the second learning data is learning data based on input information under a second environment using the other algorithm.

(6)

The information processing device according to any one of (1) to (5) above, in which

a part of the first learning data is replaced with at least a part of the specific learning data, and the re-learning is performed.

(7)

The information processing device according to any one of (1) to (6) above, in which

the specific learning data is converted into a predetermined data format, and then the re-learning is performed.

(8)

The information processing device according to any one of (1) to (7) above, in which

a degree of influence is adjusted between the first learning data and the specific learning data, and the re-learning is performed.

(9)

The information processing device according to any one of (1) to (8) above, in which

the first learning data and the second learning data are learning data in which predetermined recommendation information is output information with respect to input information.

(10)

The information processing device according to any one of (1) to (9) above, in which

the specific learning data is encrypted data.

(11)

The information processing device according to any one of (1) to (10) above, in which

the specific learning data is data converted into a predetermined feature amount.

(12)

The information processing device according to any one of (1) to (11) above, in which

the specific learning data is data received from another information processing device.

(13)

The information processing device according to any one of (1) to (12) above, in which

the re-learning is caused to be performed by another information processing device.

(14)

The information processing device according to (13) above, in which

the first learning data is transmitted to the another information processing device, and

the re-learning is caused to be performed by the another information processing device.

(15)

An information processing method including:

by an information processing device,

causing, for an algorithm that changes on the basis of accumulation of first learning data,

re-learning to be performed on the basis of the first learning data and specific learning data out of second learning data forming another algorithm that changes on the basis of accumulation of learning data.

### REFERENCE SIGNS LIST

1, 2 Information processing system
10, 11, 12 Information processing device
15 Data server
20 User terminal
30 Network
40 Learning history data
110 Storage unit
117 Recommendation database
118 Storage unit
120 Processing unit
121 Update unit
122 Extraction unit
123 Determination unit
124 Correction unit
125 Learning unit
128 Processing unit
130 Analysis unit
131 Analysis unit
140 Generation unit
141 Confirmation information generation unit
142 Recommendation information generation unit
143 Generation unit
144 Confirmation information generation unit
145 Recommendation information generation unit
150 Output control unit
160 Communication control unit
210 Communication control unit
220 Output control unit
301 to 304 DB switching unit
331 Key
351 Feature amount conversion unit
352 Update parameter calculation unit

1. An information processing device comprising:
causing, for an algorithm that changes on a basis of accumulation of first learning data,
re-learning to be performed on a basis of the first learning data and specific learning data out of second learning data forming another algorithm that changes on a basis of accumulation of learning data.

2. The information processing device according to claim 1, wherein
the first learning data includes data regarding output information from the algorithm based on input information to the algorithm.

3. The information processing device according to claim 1, wherein
the first learning data is based on data accumulated under an environment in which the algorithm is used.

4. The information processing device according to claim 1, wherein
the specific learning data is learning data obtained by extracting a specific learning history that meets a predetermined condition from a learning history of the algorithm on a basis of a database that records data regarding input information to the other algorithm.

5. The information processing device according to claim 1, wherein
the first learning data is learning data based on input information under a first environment using the algorithm, and
the second learning data is learning data based on input information under a second environment using the other algorithm.

6. The information processing device according to claim 1, wherein
a part of the first learning data is replaced with at least a part of the specific learning data, and the re-learning is performed.

7. The information processing device according to claim 1, wherein
the specific learning data is converted into a predetermined data format, and then the re-learning is performed.

8. The information processing device according to claim 1, wherein
a degree of influence is adjusted between the first learning data and the specific learning data, and the re-learning is performed.

9. The information processing device according to claim 1, wherein
the first learning data and the second learning data are learning data in which predetermined recommendation information is output information with respect to input information.

10. The information processing device according to claim 1, wherein
the specific learning data is encrypted data.

11. The information processing device according to claim 1, wherein
the specific learning data is data converted into a predetermined feature amount.

12. The information processing device according to claim 1, wherein
the specific learning data is data received from another information processing device.

13. The information processing device according to claim 1, wherein
the re-learning is caused to be performed by another information processing device.

14. The information processing device according to claim 13, wherein
the first learning data is transmitted to the another information processing device, and
the re-learning is caused to be performed by the another information processing device.

15. An information processing method comprising:
by an information processing device,
causing, for an algorithm that changes on a basis of accumulation of first learning data,
re-learning to be performed on a basis of the first learning data and specific learning data out of second learning data forming another algorithm that changes on a basis of accumulation of learning data.
